(19) United States
(12) Patent Application Publication
(10) Pub. No.: US 2016/0292391 A1
(43) Pub. Date: Oct. 6, 2016

(54) SYSTEM AND METHOD FOR IMPROVED NUTRIENT INTAKE

(71) Applicants: Michael J. Fink, Phoenix, AZ (US); Cheryl Colbert, Phoenix, AZ (US)

(72) Inventors: Michael J. Fink, Phoenix, AZ (US); Cheryl Colbert, Phoenix, AZ (US)

(21) Appl. No.: 15/092,094

(22) Filed: Apr. 6, 2016

Related U.S. Application Data
(60) Provisional application No. 62/143,501, filed on Apr. 6, 2015.

(51) Int. Cl. G06F 19/00

(52) U.S. Cl. CPC G06F 19/3475

(57) ABSTRACT

The present invention provides for a system and method of partitioning of macronutrients (carbohydrates, vegetables, dairy, proteins and fats) of each food type into its macro-components (fruit, vegetables, dairy, carbohydrates, proteins and fats) with their own distinct nutrient profile to consistently achieve predefined calories and associated macronutrient ratios. The present invention includes a set of unique processes and methods for establishing food pattern modeling in which selection of foods is based on calculated nutrient values.

### CROSS REFERENCE TO RELATED APPLICATION[S]

This application claims priority to U.S. Provisional patent application entitled “SYSTEM AND METHOD FOR IMPROVED NUTRIENT INTAKE,” Ser. No. 62/143,501, filed Apr. 6, 2015, the disclosure of which is hereby incorporated entirely herein by reference.

### BACKGROUND OF THE INVENTION

1. Technical Field

The present invention relates generally to systems and methods for monitoring and controlling the consumption of foods to achieve various dietary and/or health-related goals. More specifically, the present invention relates to more precisely monitoring, identifying, and controlling dietary intake of foods utilizing both macronutrient and micronutrient characteristics.

2. State of the Art

Dietary monitoring and control systems that determine targeted caloric intake levels and monitor caloric consumption of food by individuals exist. Such systems may be used by individuals to address health problems or diseases, and or to improve an individual's health. These systems may include limits and/or targeted consumption levels for various foods. However, these systems methods lack the ability to precisely and predictably control the level of calories and precise micro and/or macro nutrient levels consumed.

### SUMMARY OF THE INVENTION

The present invention comprises the partitioning of macronutrients (carbohydrates, vegetables, dairy, proteins and fats) of each food type into its macro-components (fruit, vegetables, dairy, carbohydrates, proteins and fats) with their own distinct nutrient profile to consistently achieve predefined calories and associated macronutrient ratios. The present invention comprises a set of unique processes and methods for establishing food pattern modeling in which selection of foods is based on calculated nutrient values.

The present invention recognizes that each specific food may contain more than one nutrient profile, and that one component equivalent is different for each specific food type. This recognition is utilized in the methods and systems of the present invention such that each specific food type is broken down into its macronutrient components in accordance with unique formulae developed for each food group and food subgroup. The current invention further recognizes that each specific macronutrient component has different nutritional properties and associated energy requirements. The system and method utilizes this to develop a different nutrient profile for each macronutrient component. For example, the carbohydrate component has nutritional properties and energy requirements similar to the Whole Grain group, the protein component has nutritional properties and energy requirements similar to the Meat and Meat Substitutes food group, and the fat component has nutritional properties and energy requirements similar to the Oils food group. For example, rather than assuming that every food type in the Whole Grain group has the same nutrient profile and associated energy requirement, the current invention assumes that each specific food type in the Whole Grain group has one or more distinctive nutrient profiles, each with its own macronutrient properties, and associated energy requirements. The present invention further utilizes energy requirements that vary slightly and are uniquely calculated with weighted averages for each food group, subgroup and each macronutrient component to determine the total energy level.

The present invention utilizes the entire Agricultural Research Service, United States Department of Agriculture, National Nutrient Database for Standard Reference, Release 27, 2014, in order to assess a composite nutrient profile (nutrients per cup or ounce equivalent, i.e., the “USDA Nutrient Profile”) for each food group and subgroup listed, in order to further define discrete nutrient patterns. These nutrient profiles are then used to calculate specific calorie and nutrient contents provided by each food in development of specific models (“nutrient models”).

In an embodiment, the invention provides detailed formulations reducing selected food nutrient data sets into specific nutrient components according to the USDA Nutrient Profile, which is further utilized for developing and maintaining specific dietary intake patterns within the an individualized nutrient model. A unique database and software system allows the individual online subscriber flexibility for selecting foods based on “usual” consumption of preferred food categories, specific foods and/or specific brands of foods and still maintain a specific food pattern utilizing the nutrient model.

The nutritional and dietary recommendations provided by the system and method may incorporate information based on a review of summary findings of currently available peer reviewed scientific literature. Utilizing this research, original and unique processes and formulae for each dietary recommendation have been developed as part of the present invention. In an embodiment, subscribers utilize the system and method online, and are advised to discuss individual assessment findings and nutritional recommendations with their attending physician, dietician and/or nutritionist to maximize results.

In an embodiment, a website may be utilized to provide individuals with vital information necessary to increase personal nutrition, and decrease their exposure to dietary ailments due to eating inappropriate foods compromising general health and/or medical conditions.

The present invention relates to a system for accurately and effectively determining what nutrients individuals are presently receiving and/or need in order to balance their nutritional, dietary intake. The system is crucial for allowing an online subscriber to personally, and fully customize a dietary plan in order to accomplish medical and/or health driven goals for improving overall health and longevity of life. More particularly, the system allows an individual to customize food and nutrient intake patterns consistent with medically recommended dietary guidance in order to meet specific nutritional goals, while controlling discrete nutrient intake levels to address specific dietary restrictions and/or deficiencies in order to improve overall health. Moreover, the system will provide guidance to clinicians in selecting an optimal nutrient intake (diet) for each individual based upon an existing medical baseline determination, followed by recurrent examination of an individual's health risk factors to confirm efficacy.

In an embodiment, the present invention addresses the nutrient content of foods proven to contribute to known health risk factors which include, but are not limited to: an elevated concentration of low-density lipoprotein (LDL) cholesterol and a low concentration of high-density lipoprotein (HDL) cholesterol, both causally associated with coronary heart disease (CHD); elevated triglycerides and elevated blood pressure causally associated with several forms of cardiovascular disease (CVD); dyslipidemias causally associated with abnormalities in the types and/or amount of cholesterol and triglycerides in the blood, elevated glucose levels causally associated with Type II diabetes; osteoporosis; atherosclerosis, blood clots, hemorrhoids, varicose veins, and obesity.

In an embodiment, the present invention provides for a comprehensive assessment of additional factors including the subscriber's age, gender, height, and weight. The addition of an accurate medical determination of an individual's health risk factors can be documented in the assessment under HIPPA regulations and will form a primary nutritional recommendation, which can then further guide the development of a personalized dietary intake plan.

In an embodiment, the present invention allows an individual online subscriber the ability to monitor his or her progress in establishing balanced nutrition relative to the individual diet plan developed. In addition, the system offers individuals the ability to personalize such an optimal diet to maintain health, manage an individual's health risk factors, or simply lose, gain, or maintain a desired weight.

In an embodiment, the present invention includes discrete nutritional modeling processes and methods associated with the system which is described in the section entitled “Dietary Approach to Maintain Health,” specifically designed for individuals not suffering from any specific nutritional disorder and/or for individuals that simply desire to maintain their existing weight. In and embodiment, the dietary program designed for overall health maintenance through balanced nutrition may be different from the one designed to overcome a specific nutritional disorder.

In an embodiment, the present invention includes systems and methods designed for individuals who have already been medically diagnosed as at risk for cardiovascular disease (CVD) described in the section entitled, “Dietary Approach to Heart Disease.”

In an embodiment, the present invention includes systems and methods designed for individuals who have already been medically diagnosed as at risk for type II diabetes described in the section entitled, “Dietary Approach to Diabetes.”

In an embodiment, the present invention includes systems and methods designed for individuals who have already been medically diagnosed as at risk for obesity, or for individuals that desire to lose weight, as described in the section entitled, “Dietary Approach to Weight Loss.”

In an embodiment, the present invention comprises an online program containing an advanced, proprietary database and integral software system capable of emulating the cognitive ability of a nutritionist and/or dietician that relationally integrates peer-reviewed nutritional science and clinical research findings with a personal dietary assessment and individual health condition. The system and methods allow for individual food preferences while forming an individualized dietary profile for health management solutions such as weight loss and diabetes management.

In an embodiment, the unique database and software system provides peer-reviewed, science-based nutrition findings in an original format directly to individual online subscribers. This unique computerized, nutritional science database and operating system promotes health, and reduces risk for major chronic diseases through a nutrient based diet, which supports increased physical activity.

In an embodiment, the database and software system comprises a nutritional science information system, designed for an online subscriber to: a) select an optimal diet and/or to select nutritional metrics for increasing overall health; b) help prevent the onset of targeted diseases (i.e., primary prevention); c) to improve health of individuals who have already developed health risk factors, and; d) to provide enhanced nutrition for individuals with an established disease, e.g., obesity and diabetes.

Nutritional science has repeatedly proven that the personal diet should obtain all the nutrients needed for good health. Everyone needs the four basic macronutrients—carbohydrates, proteins, fats, and water as well as the basic micronutrients—vitamins, minerals, and other micronutrients. Nutritional science has determined that at least 34 nutrients are needed for growth and normal body functioning. Nutrients function in many ways to build, maintain, and protect body structures and systems and to promote health. For example, some nutrients provide structure for various body tissues while others serve as antioxidants, counteracting oxidative damage to biomolecules. Other nutrients are necessary for the production and functioning of compounds necessary for health such as hormones, enzymes, or coenzymes and for homeostasis of physiological systems. Some nutrients can be used as an energy source and others are necessary in various stages of energy production.

Numerous clinical studies have provided evidence that nutrient needs should be met primarily through consuming whole foods. Nutrients are most beneficial to health when they are consumed in a natural form and in combination with each other, which occurs when a person consumes nutrient-dense foods selected from each basic food group—fruits, vegetables, whole grain cereals, meat, beans and meat products, milk and yogurt, and oils, seeds and nuts, as opposed to refined, processed foods such as soft drinks, desserts, candy, white bread, and sugar.

Refined foods offer few, if any, of the vitamins and minerals that are important to human health. In addition, if eaten in excess, especially over a period of many years, the large amounts of simple carbohydrates found in refined foods can lead to a number of health disorders, including diabetes and hypoglycemia.

Nutrient-dense foods are those that provide substantial amounts of vitamins and minerals and relatively fewer calories. In contrast, energy-dense, nutrient-poor foods that are low in nutrient density are foods that supply calories but relatively small amounts of vitamins and minerals (sometimes none at all). A number of epidemiological studies using data obtained from national surveys suggest that energy-dense, nutrient-poor foods may displace nutrient-dense foods, potentially reducing the consumption of foods from the five basic foods groups to lower levels than recommended by nutritional science, thereby limiting one's ability to achieve recommended nutrient intakes.

By understanding the principles of nutrition, knowing what nutrients are needed, and eating the healthiest forms of each of these nutrients in the proper balance and proper quantity, individuals can improve their health, prevent disease, and metabolically function at an optimal level.

Nutritional science has determined that a healthy dietary pattern, one that provides recommended intakes of nutrients, reduces the risk of some common chronic diseases, including cardiovascular disease (CVD), hypertension, dyslipidemia, type II diabetes, overweight and obesity, osteoporosis, constipation, diverticular disease, iron deficiency anemia, oral disease, and malnutrition. Reductions in risk were particularly strong for CVD.

Peer reviewed nutritional science research, along with medical science and clinical findings, have clearly established the importance of a well-balanced diet for the good health and longevity of an individual, including proper calorie control. However, delimiting caloric intake for targeted goals such as weight loss and weight management require that an individual obtain a discrete, proportional consumption of select macronutrients and micronutrients in order to maintain overall health when consuming carbohydrates, proteins and fats through a structured daily meal plan. Such daily nutritional balance is particularly important for certain groups of individuals such as diabetics who need to maintain a strict daily calorie, carbohydrate, protein and fat dietary intake.

Extensive amounts of nutritional science research findings and peer reviewed literature have been put forth in recent years by a multitude of different authors and experts with regard to food nutrition, dietary requirements and, in general, aspects of proper well-balanced nutrition, daily intake recommendations, and meal planning considerations. The present invention provides a unique, online expert system which has mathematically modeled the entire USDA National Nutrient Database for Standard Reference (Release 27, 2014). The present invention allows for an individual to develop a preferred daily meal plan by performing an accurate selection of a complete, nutritionally balanced diet. The present invention comprises an online expert system allowing a subscribing person to select individual food items which can then be correlated with personal, nutritional goals together in an easy-to-read display, while still allowing for the individual to select from a wide variety of foods. The present invention provides an individual subscriber with a plurality of displayed complete meals, each of which can be organized under a variety of entrees of select foods coordinated for breakfast, lunch and dinner. Through the use of an online database and software system, an online subscriber is able to research discrete macronutrients and micronutrients which can be selected from a broad list of particular exchangeable individual foods with similar nutrient content. Select foods may then be combined to form individual, nutritionally balanced meals on a daily basis.

In an embodiment, the present invention allows an online subscriber to access the system that provides correlation of nutritional intake and health benefits, for example:

A process to calculate individual's body mass index (BMI) to determine caloric need, based on the measurement of factors, including the individual's age, gender, height, and weight; and

A process for selecting an “optimal diet,”’ based on the measurement of risk factors, including, but not limited to individuals with CVD or at risk of developing CVD, individuals with Type II diabetes or at risk of developing Type II diabetes, individuals who desire to “jump start” weight loss, and/or healthy individuals who desire to maintain their weight or maintain their health; and

A process for menu planning with specific nutrient component patterns relative to documented health benefits, in consideration of an individual's “optimal diet” and specific nutritional and/or dietary needs.

The formulation methodology of the present invention is flexible and readily adaptable to accommodate individual food preferences. Individuals receive suggestions for optionally modifying their selections based upon nutritional benefits and other criteria. Alternatively, the customer may elect to ignore these suggestions for modifying a selection.

The unique database and software system of the present invention is designed as a living paradigm to be based upon refinement of new peer reviewed scientific research, in direct correlation to individual personal profiles and/or medical conditions. In an embodiment, the database and software system will continuously reference scientific discoveries related to nutrition and consequently improved health, so that when new scientific information is available, formulae are be updated accordingly. As a result, findings and nutritional recommendations are statistically verifiable as supporting research is consistently driven by current, best available science.

In an embodiment, the invention relates to a database and software system developed for accurately and effectively determining what nutrients individuals need to receive in their diets. The databases of the present invention are crucial for allowing the subscriber/member to personally and fully customize a dietary plan to accomplish medical and/or health driven goals for both improving and maintaining overall health, and their longevity of life. Furthermore, the database and software system allows individuals to customize food and nutrient intake patterns consistent with recommended dietary guidance to meet specific nutritional goals, while controlling other nutrient intake levels to address specific dietary deficiencies and improve overall health. Moreover, the database and software system may provide additional guidance to clinicians in selecting an optimal diet for a patient in conjunction with a medical baseline determination of a patient's overall health risk factors.

Such health risk factors include, but are not limited to: an elevated concentration of low-density lipoprotein (LDL) cholesterol and a low concentration of high-density lipoprotein (HDL) cholesterol both causally associated with coronary heart disease (CHD); elevated triglycerides and elevated blood pressure causally associated with several forms of cardiovascular disease (CVD); dyslipidemias causally associated with abnormalities in the types and/or amount of cholesterol and triglycerides in the blood, elevated glucose levels causally associated with Type II diabetes; osteoporosis; atherosclerosis, blood clots, hemorrhoids, varicose veins, and obesity.

Additional factors may include the patient's age, gender, height, and weight. The accurate medical determination of an individual's health risk factors should guide the development of a personalized diet plan and will be a primary recommendation.

The system offers the individual the ability to monitor his or her progress relative to the individual diet plan developed. In addition, the system offers individuals the ability to personalize an optimal diet to improve and maintain health, manage an individual's health risk factors, or simply lose, gain, or maintain weight.

In an embodiment, methods associated with the invention as described in the section, entitled “Dietary Approach to Maintain Health” are designed for adults not suffering from any specific disorder and/or for individuals that want to maintain their weight.” The program designed for health maintenance is different from the one designed to overcome a specific disorder.

In an embodiment, methods associated with the invention that are designed for adults at risk for cardiovascular disease (CVD) are described in the section, entitled “Dietary Approach to Heart Disease.” In an embodiment, methods associated with the invention that are designed for adults at risk for type II diabetes are described in the section, entitled “Dietary Approach to Diabetes.” In an embodiment, methods associated with the invention that are designed for adults at risk for obesity, or for patients that want to lose weight are described in the section entitled “Dietary Approach to Weight Loss.”

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description when considered in connection with the Figures (not necessarily drawn to scale), wherein like reference numbers refer to similar items throughout the Figures, and:

FIG. 1A generally illustrates a flow diagram related to macronutrient and components calculation utilized in the system and method, according to an embodiment of the present invention;

FIG. 1B generally illustrates a flow diagram of the nutrient model system and method, according to an embodiment of the present invention;

FIG. 2 generally illustrates a flow diagram of the system and method, according to an embodiment of the present invention;

FIG. 3 generally illustrates an example of the system and method, according to an embodiment of the present invention;

FIG. 4 generally illustrates a listing of database fields utilized in the system and method, according to an embodiment of the present invention;

FIG. 5A generally illustrates a listing of nutrient goals and intake patterns utilized in the system and method, according to an embodiment of the present invention;

FIG. 5B generally illustrates a listing of nutrient goals and intake patterns utilized in the system and method, according to an embodiment of the present invention;

FIG. 5C generally illustrates a listing of nutrient goals and intake patterns utilized in the system and method, according to an embodiment of the present invention;

FIG. 6 generally illustrates a flow diagram of the system and method, according to an embodiment of the present invention;

FIG. 7A generally illustrate portions of a table including data associated with various models used in the system and method, according to an embodiment of the present invention;

FIG. 7B generally illustrate portions of a table including data associated with various models used in the system and method, according to an embodiment of the present invention;

FIG. 8 generally illustrates a listing of database fields related to macronutrient calculation utilized in the system and method, according to an embodiment of the present invention;

FIG. 9 generally illustrates a listing of database fields related to recommended daily components utilized in the system and method, according to an embodiment of the present invention;

FIG. 10 generally illustrates a flow diagram of the system and method, according to an embodiment of the present invention;

FIG. 11A generally illustrates a table including data associated with discretionary calories, according to an embodiment of the present invention;

FIG. 11B generally illustrates a table including data associated with discretionary calories, according to an embodiment of the present invention;

FIG. 11C generally illustrates a table including data associated with discretionary calories, according to an embodiment of the present invention;

FIG. 12 generally illustrates a wire diagram of health condition and pre-selection aspects of the system and method related to health conditions, according to an embodiment of the present invention;

FIG. 13A generally illustrates a portions of a table including data associated with patients used in the system and method, according to an embodiment of the present invention;

FIG. 13B generally illustrates a portion of a table including data associated with patients used in the system and method, according to an embodiment of the present invention;

FIG. 13C generally illustrates a portion of a table including data associated with patients used in the system and method, according to an embodiment of the present invention;

FIG. 13D generally illustrates a portion of a table including data associated with patients used in the system and method, according to an embodiment of the present invention;

FIG. 13E generally illustrates a portion of a table including data associated with patients used in the system and method, according to an embodiment of the present invention;

FIG. 13F generally illustrates a portion of a table including data associated with patients used in the system and method, according to an embodiment of the present invention;

FIG. 13G generally illustrates a portion of a table including data associated with patients used in the system and method, according to an embodiment of the present invention;

FIG. 13H generally illustrates a portion of a table including data associated with patients used in the system and method, according to an embodiment of the present invention;

FIG. 13I generally illustrates a portion of a table including data associated with patients used in the system and method, according to an embodiment of the present invention;

FIG. 13J generally illustrates a portion of a table including data associated with patients used in the system and method, according to an embodiment of the present invention;

FIG. 13K generally illustrates a portion of a table including data associated with patients used in the system and method, according to an embodiment of the present invention;

FIG. 13L generally illustrates a portion of a table including data associated with patients used in the system and method, according to an embodiment of the present invention;

FIG. 13M generally illustrates a portion of a table including data associated with patients used in the system and method, according to an embodiment of the present invention;

FIG. 13N generally illustrates a portion of a table including data associated with patients used in the system and method, according to an embodiment of the present invention;

FIG. 13O generally illustrates a portion of a table including data associated with patients used in the system and method, according to an embodiment of the present invention;

FIG. 13P generally illustrates a portion of a table including data associated with patients used in the system and method, according to an embodiment of the present invention;

FIG. 13Q generally illustrates a portion of a table including data associated with patients used in the system and method, according to an embodiment of the present invention;

FIG. 13R generally illustrates a portion of a table including data associated with patients used in the system and method, according to an embodiment of the present invention;

FIG. 13S generally illustrates a portion of a table including data associated with patients used in the system and method, according to an embodiment of the present invention;

FIG. 13T generally illustrates a portion of a table including data associated with patients used in the system and method, according to an embodiment of the present invention;

FIG. 13U generally illustrates a portion of a table including data associated with patients used in the system and method, according to an embodiment of the present invention;

FIG. 13V generally illustrates a portion of a table including data associated with patients used in the system and method, according to an embodiment of the present invention;

FIG. 13W generally illustrates a portion of a table including data associated with patients used in the system and method, according to an embodiment of the present invention;

FIG. 13X generally illustrates a portion of a table including data associated with patients used in the system and method, according to an embodiment of the present invention;

FIG. 13Y generally illustrates a portion of a table including data associated with patients used in the system and method, according to an embodiment of the present invention;

FIG. 13Z generally illustrates a portion of a table including data associated with patients used in the system and method, according to an embodiment of the present invention;

FIG. 13AA generally illustrates a portion of a table including data associated with patients used in the system and method, according to an embodiment of the present invention;

FIG. 13AB generally illustrates a portion of a table including data associated with patients used in the system and method, according to an embodiment of the present invention;

FIG. 13AC generally illustrates a portion of a table including data associated with patients used in the system and method, according to an embodiment of the present invention;

FIG. 13AD generally illustrates a portion of a table including data associated with patients used in the system and method, according to an embodiment of the present invention;

FIG. 13AE generally illustrates a portion of a table including data associated with patients used in the system and method, according to an embodiment of the present invention;

FIG. 13AF generally illustrates a portion of a table including data associated with patients used in the system and method, according to an embodiment of the present invention;

FIG. 13AG generally illustrates a portion of a table including data associated with patients used in the system and method, according to an embodiment of the present invention;

FIG. 13AH generally illustrates a portion of a table including data associated with patients used in the system and method, according to an embodiment of the present invention;

FIG. 13AI generally illustrates a portion of a table including data associated with patients used in the system and method, according to an embodiment of the present invention;

FIG. 13AJ generally illustrates a portion of a table including data associated with patients used in the system and method, according to an embodiment of the present invention;

FIG. 13AK generally illustrates a portion of a table including data associated with patients used in the system and method, according to an embodiment of the present invention;

FIG. 13AL generally illustrates a portion of a table including data associated with patients used in the system and method, according to an embodiment of the present invention;

FIG. 13AM generally illustrates a portion of a table including data associated with patients used in the system and method, according to an embodiment of the present invention;

FIG. 13AN generally illustrates a portion of a table including data associated with patients used in the system and method, according to an embodiment of the present invention;

FIG. 13AO generally illustrates a portion of a table including data associated with patients used in the system and method, according to an embodiment of the present invention;

FIG. 13AP generally illustrates a portion of a table including data associated with patients used in the system and method, according to an embodiment of the present invention;

FIG. 13AQ generally illustrates a portion of a table including data associated with patients used in the system and method, according to an embodiment of the present invention;

FIG. 13AR generally illustrates a portion of a table including data associated with patients used in the system and method, according to an embodiment of the present invention;

FIG. 13AS generally illustrates a portion of a table including data associated with patients used in the system and method, according to an embodiment of the present invention;

FIG. 13AT generally illustrates a portion of a table including data associated with patients used in the system and method, according to an embodiment of the present invention;

FIG. 13AU generally illustrates a portion of a table including data associated with patients used in the system and method, according to an embodiment of the present invention;

FIG. 13AV generally illustrates a portion of a table including data associated with patients used in the system and method, according to an embodiment of the present invention;

FIG. 13AW generally illustrates a portion of a table including data associated with patients used in the system and method, according to an embodiment of the present invention;

FIG. 13AX generally illustrates a portion of a table including data associated with patients used in the system and method, according to an embodiment of the present invention;

FIG. 13AY generally illustrates a portion of a table including data associated with patients used in the system and method, according to an embodiment of the present invention;

FIG. 13AZ generally illustrates a portion of a table including data associated with patients used in the system and method, according to an embodiment of the present invention;

FIG. 13AAA generally illustrates a portion of a table including data associated with patients used in the system and method, according to an embodiment of the present invention;

FIG. 13AAB generally illustrates a portion of a table including data associated with patients used in the system and method, according to an embodiment of the present invention;

FIG. 13AAC generally illustrates a portion of a table including data associated with patients used in the system and method, according to an embodiment of the present invention;

FIG. 13AAD generally illustrates a portion of a table including data associated with patients used in the system and method, according to an embodiment of the present invention;

FIG. 13AAE generally illustrates a portion of a table including data associated with patients used in the system and method, according to an embodiment of the present invention;

FIG. 13AAF generally illustrates a portion of a table including data associated with patients used in the system and method, according to an embodiment of the present invention;

FIG. 13AAG generally illustrates a portion of a table including data associated with patients used in the system and method, according to an embodiment of the present invention;

FIG. 13AAH generally illustrates a portion of a table including data associated with patients used in the system and method, according to an embodiment of the present invention;

FIG. 13AAI generally illustrates a portion of a table including data associated with patients used in the system and method, according to an embodiment of the present invention;

FIG. 13AAJ generally illustrates a portion of a table including data associated with patients used in the system and method, according to an embodiment of the present invention;

FIG. 13AAK generally illustrates a portion of a table including data associated with patients used in the system and method, according to an embodiment of the present invention;

FIG. 13AAL generally illustrates a portion of a table including data associated with patients used in the system and method, according to an embodiment of the present invention;

FIG. 13AAM generally illustrates a portion of a table including data associated with patients used in the system and method, according to an embodiment of the present invention;

FIG. 14A generally illustrates a table including medical data associated with patients used in the system and method, according to an embodiment of the present invention;

FIG. 14B generally illustrates a table including medical data associated with patients used in the system and method, according to an embodiment of the present invention;

FIG. 14C generally illustrates a table including medical data associated with patients used in the system and method, according to an embodiment of the present invention;

FIG. 14D generally illustrates a table including medical data associated with patients used in the system and method, according to an embodiment of the present invention;

FIG. 14E generally illustrates a table including medical data associated with patients used in the system and method, according to an embodiment of the present invention;

FIG. 14F generally illustrates a table including medical data associated with patients used in the system and method, according to an embodiment of the present invention;

FIG. 14G generally illustrates a table including medical data associated with patients used in the system and method, according to an embodiment of the present invention;

FIG. 14H generally illustrates a table including medical data associated with patients used in the system and method, according to an embodiment of the present invention;

FIG. 14I generally illustrates a table including medical data associated with patients used in the system and method, according to an embodiment of the present invention;

FIG. 14J generally illustrates a table including medical data associated with patients used in the system and method, according to an embodiment of the present invention;

FIG. 14K generally illustrates a table including medical data associated with patients used in the system and method, according to an embodiment of the present invention;

FIG. 14L generally illustrates a table including medical data associated with patients used in the system and method, according to an embodiment of the present invention;

FIG. 14M generally illustrates a table including medical data associated with patients used in the system and method, according to an embodiment of the present invention;

FIG. 14N generally illustrates a table including medical data associated with patients used in the system and method, according to an embodiment of the present invention;

FIG. 14O generally illustrates a table including medical data associated with patients used in the system and method, according to an embodiment of the present invention;

FIG. 14P generally illustrates a table including medical data associated with patients used in the system and method, according to an embodiment of the present invention;

FIG. 14Q generally illustrates a table including medical data associated with patients used in the system and method, according to an embodiment of the present invention;

FIG. 14R generally illustrates a table including medical data associated with patients used in the system and method, according to an embodiment of the present invention;

FIG. 14S generally illustrates a table including medical data associated with patients used in the system and method, according to an embodiment of the present invention;

FIG. 14T generally illustrates a table including medical data associated with patients used in the system and method, according to an embodiment of the present invention;

FIG. 14U generally illustrates a table including medical data associated with patients used in the system and method, according to an embodiment of the present invention;

FIG. 14V generally illustrates a table including medical data associated with patients used in the system and method, according to an embodiment of the present invention;

FIG. 14W generally illustrates a table including medical data associated with patients used in the system and method, according to an embodiment of the present invention;

FIG. 14X generally illustrates a table including medical data associated with patients used in the system and method, according to an embodiment of the present invention;

FIG. 14Y generally illustrates a table including medical data associated with patients used in the system and method, according to an embodiment of the present invention;

FIG. 14Z generally illustrates a table including medical data associated with patients used in the system and method, according to an embodiment of the present invention;

FIG. 14AA generally illustrates a table including medical data associated with patients used in the system and method, according to an embodiment of the present invention;

FIG. 14AB generally illustrates a table including medical data associated with patients used in the system and method, according to an embodiment of the present invention;

FIG. 14AC generally illustrates a table including medical data associated with patients used in the system and method, according to an embodiment of the present invention;

FIG. 14AD generally illustrates a table including medical data associated with patients used in the system and method, according to an embodiment of the present invention;

FIG. 14AE generally illustrates a table including medical data associated with patients used in the system and method, according to an embodiment of the present invention;

FIG. 14AF generally illustrates a table including medical data associated with patients used in the system and method, according to an embodiment of the present invention;

FIG. 14AG generally illustrates a table including medical data associated with patients used in the system and method, according to an embodiment of the present invention;

FIG. 14AH generally illustrates a table including medical data associated with patients used in the system and method, according to an embodiment of the present invention;

FIG. 14AI generally illustrates a table including medical data associated with patients used in the system and method, according to an embodiment of the present invention;

FIG. 14AJ generally illustrates a table including medical data associated with patients used in the system and method, according to an embodiment of the present invention;

FIG. 14AK generally illustrates a table including medical data associated with patients used in the system and method, according to an embodiment of the present invention;

FIG. 14AL generally illustrates a table including medical data associated with patients used in the system and method, according to an embodiment of the present invention;

FIG. 14AM generally illustrates a table including medical data associated with patients used in the system and method, according to an embodiment of the present invention;

FIG. 14AN generally illustrates a table including medical data associated with patients used in the system and method, according to an embodiment of the present invention;

FIG. 14AO generally illustrates a table including medical data associated with patients used in the system and method, according to an embodiment of the present invention;

FIG. 14AP generally illustrates a table including medical data associated with patients used in the system and method, according to an embodiment of the present invention;

### DETAILED DESCRIPTION OF EMBODIMENTS OF THE INVENTION

An embodiment may include a system for improved nutrient intake, the system comprising: a computer server having a database containing data defining a nutrient reference information; a user computing device remote from the computer server, which computer server is coupled to the user computing device and programmed to: receive from a network interface of the user computing device a signal indicating information of nutritional goals of a user; automatically identify user nutrients associated with the user nutritional goals; in response to identification of the user nutrients, automatically retrieve the stored data corresponding to the user nutrients; using the data retrieved, automatically generate and transmit to the network interface on the user computing device a screen that displays individual food items that correlate with user nutrients, and selection fields corresponding to the individual food items, wherein the selection fields allow the user to select the individual food items to develop a meal plan; receiving from the network interface of the user computing device a signal indicating selected individual food items; automatically identify a user selected meal plan with the selected individual food items; and in response to identification of the user selected meal plan, automatically generate and transmit to the network interface on the user computing device a screen that displays the user selected meal plan.

The computer server may be programmed to automatically identify the user selected meal plan with the selected individual food items further comprises automatically identify a user selected daily meal plan with the selected individual food items; and automatically identify the user selected meal plan with the selected individual food items further comprises automatically identify a user selected weekly meal plan with the selected individual food items. The nutrient reference information comprises a USDA Nutritional Database. The user nutrients comprise a discrete nutrient profile that contains a predefined amount of each macronutrient identified by the computer server, wherein the macronutrients include a protein component, a fat component, a carbohydrate component, and calories. Additionally, the computer server may be programmed to automatically determine if the predefined amount of each macronutrient is met in response to receiving from the network interface of the user computing device the signal indicating selected individual food items; and automatically generate and transmit for display on the network interface of the user computing device a screen recommending individual food items to ensure the predefined amount of each macronutrient is met in response.

Another embodiment includes a system for improved nutrient intake, the system comprising: a computer server having a database containing data defining a nutrient reference information; a user computing device remote from the computer server, which computer server is coupled to the user computing device and programmed to: receive from a network interface of the user computing device a signal indicating information of nutritional goals of a user; automatically identify user nutrients associated with the user nutritional goals; in response to identification of the user nutrients, automatically retrieve the stored data corresponding to the user nutrients; using the data retrieved, automatically generate and transmit to the network interface on the user computing device a screen that displays a plurality of complete meals that correlate with user nutrients, and selection fields corresponding to entrees of select foods coordinated for breakfast, lunch, dinner and snacks, wherein the selection fields allow the user to select the individual entrees to develop a meal plan; receiving from the network interface of the user computing device a signal indicating selected entrees; automatically identifying a user selected meal plan with the selected entrees; and in response to identification of the user selected meal plan, automatically generate and transmit to the network interface on the user computing device a screen that displays the user selected meal plan.

The computer server may be programmed to automatically identify the user selected meal plan with the selected individual food items further comprises automatically identify a user selected daily meal plan with the selected entrees; and automatically identify the user selected meal plan with the selected individual food items further comprises automatically identify a user selected weekly meal plan with the selected entrees. The nutrient reference information comprises a USDA Nutritional Database. The user nutrients comprises a discrete nutrient profile that contains a predefined amount of each macronutrient identified by the computer server, wherein the macronutrients include a protein component, a fat component, a carbohydrate component, and calories. Additionally, the computer server may be programmed to automatically determine if the predefined amount of each macronutrient is met in response to receiving from the network interface of the user computing device the signal indicating selected entrees; and automatically generate and transmit for display on the network interface of the user computing device a screen recommending individual food items to ensure the predefined amount of each macronutrient is met in response.

Another embodiment includes a system for improved nutrient intake, the system comprising: a computer server having a database containing data defining a nutrient reference information; a user computing device remote from the computer server, which computer server is coupled to the user computing device and programmed to: receive from a network interface of the user computing device a signal indicating information of nutritional goals of a user; automatically identify user nutrients associated with the user nutritional goals; in response to identification of the user nutrients, automatically retrieve the stored data corresponding to the user nutrients; using the data retrieved, automatically generate and transmit to the network interface on the user computing device a screen that displays individual food items that correlate with user nutrients, and selection fields corresponding to the individual food items, wherein the selection fields allow the user to select the individual food items to develop a meal plan; receiving from the network interface of the user computing device a signal indicating selected individual food items; automatically identifying a user discrete macronutrients and micronutrients and automatically identifying exchangeable individual foods that correlate with the selected individual food items; and in response to identification of the user discrete macronutrients and micronutrients and the exchangeable individual foods, automatically generate and transmit to the network interface on the user computing device a screen that displays the exchangeable individual foods.

The nutrient reference information comprises a USDA Nutritional Database. The user nutrients comprises a discrete nutrient profile that contains a predefined amount of each macronutrient identified by the computer server, wherein the macronutrients include a protein component, a fat component, a carbohydrate component, and calories. Additionally, the computer server is programmed to automatically determine if the predefined amount of each macronutrient is met in response to receiving from the network interface of the user computing device the signal indicating selected individual food items; and automatically generate and transmit for display on the network interface of the user computing device a screen recommending individual food items to ensure the predefined amount of each macronutrient is met in response. The recommended individual food items include exchangeable individual foods.

### Overview of Database and Software System

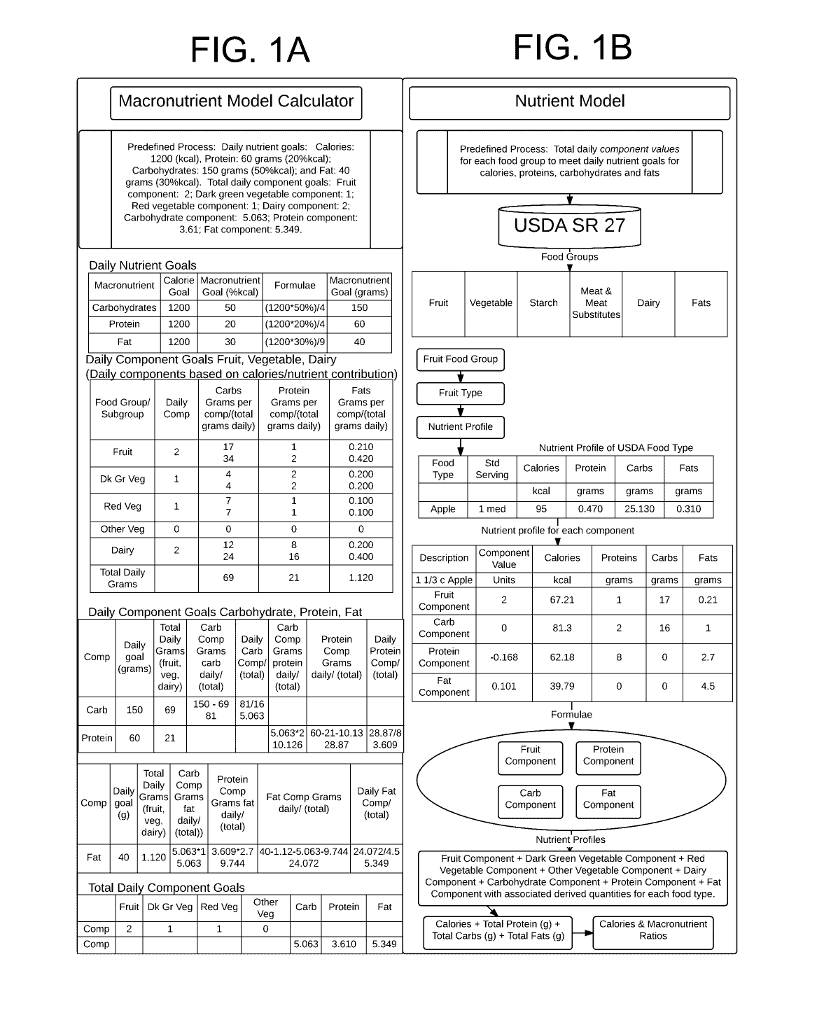

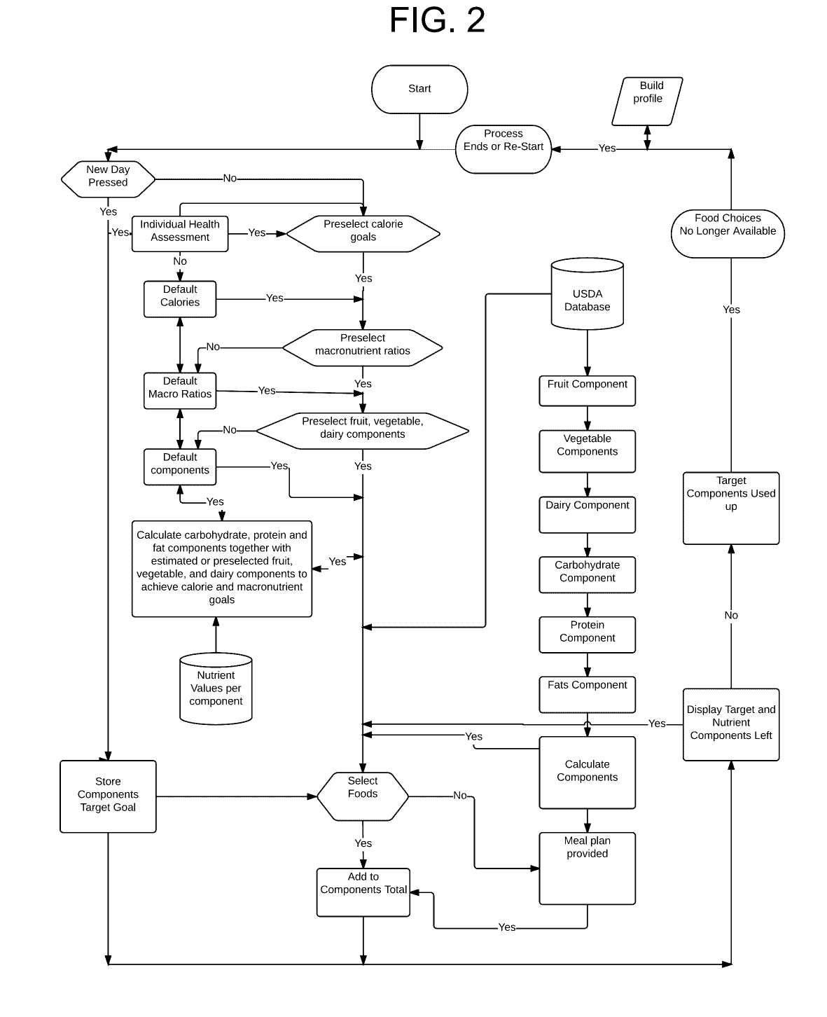

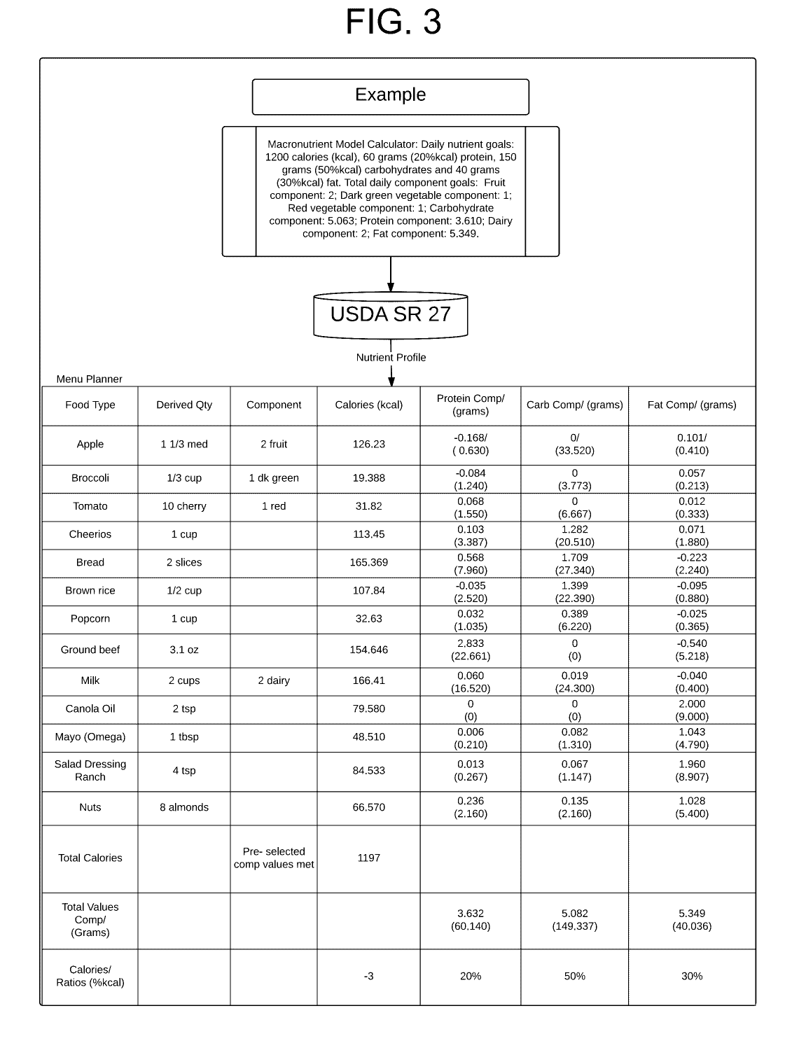

Reference is first made to FIG. 1A, FIG. 1B, FIG. 2, and FIG. 3 which shows in flow charts processes according to an embodiment of the present invention.

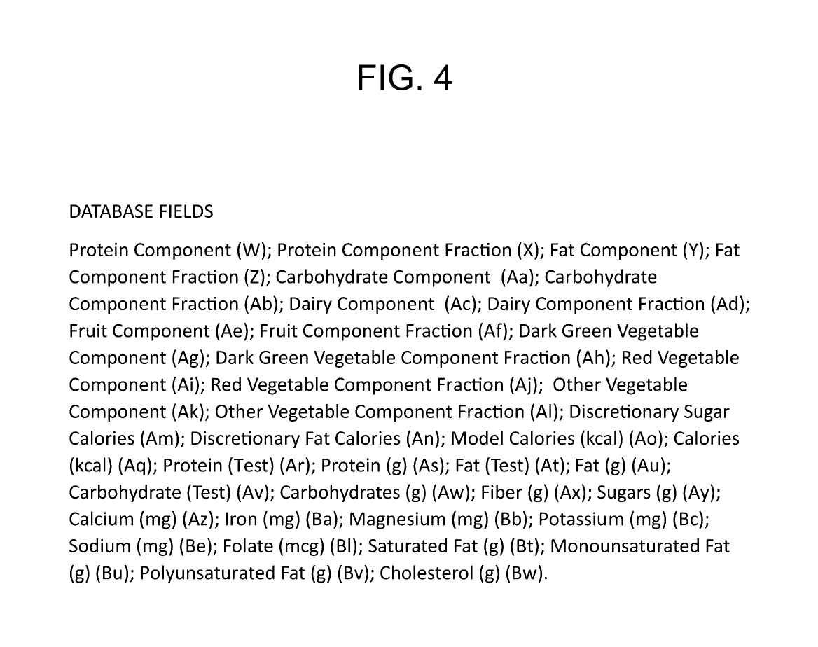

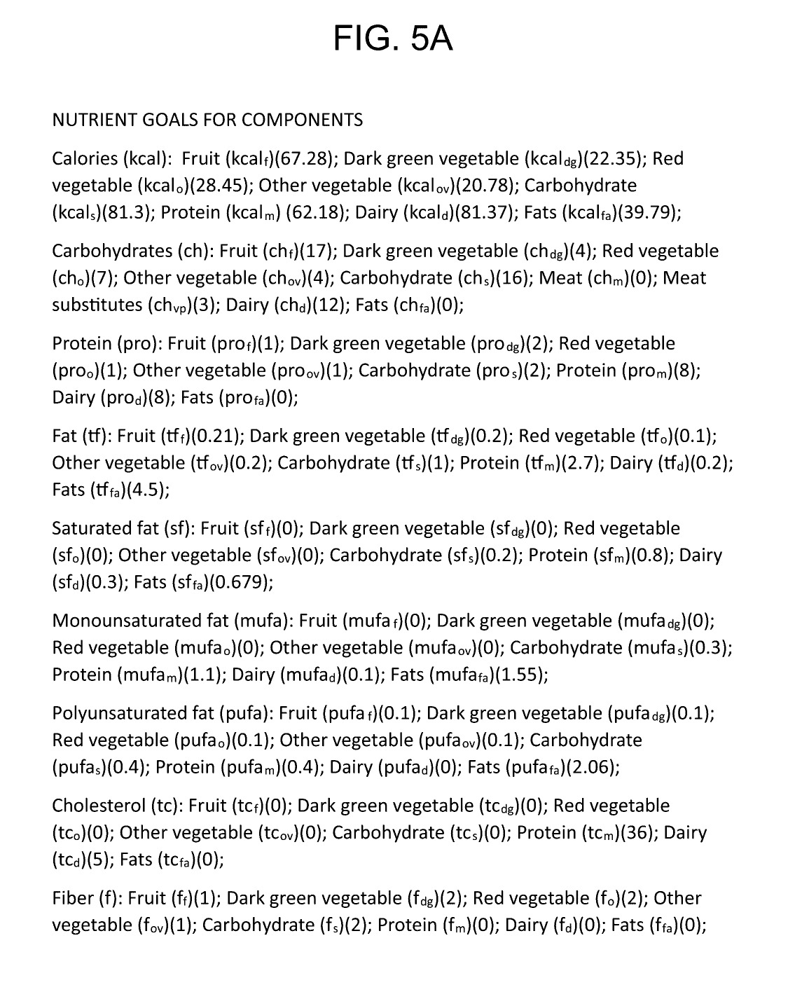

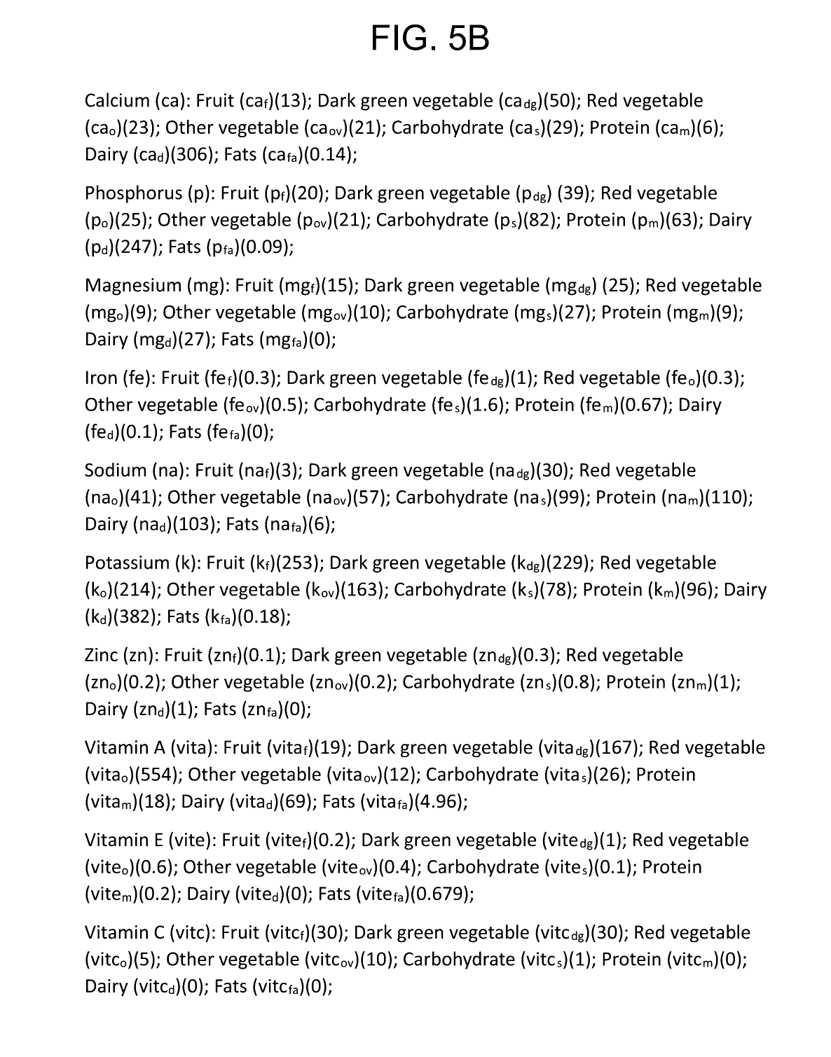

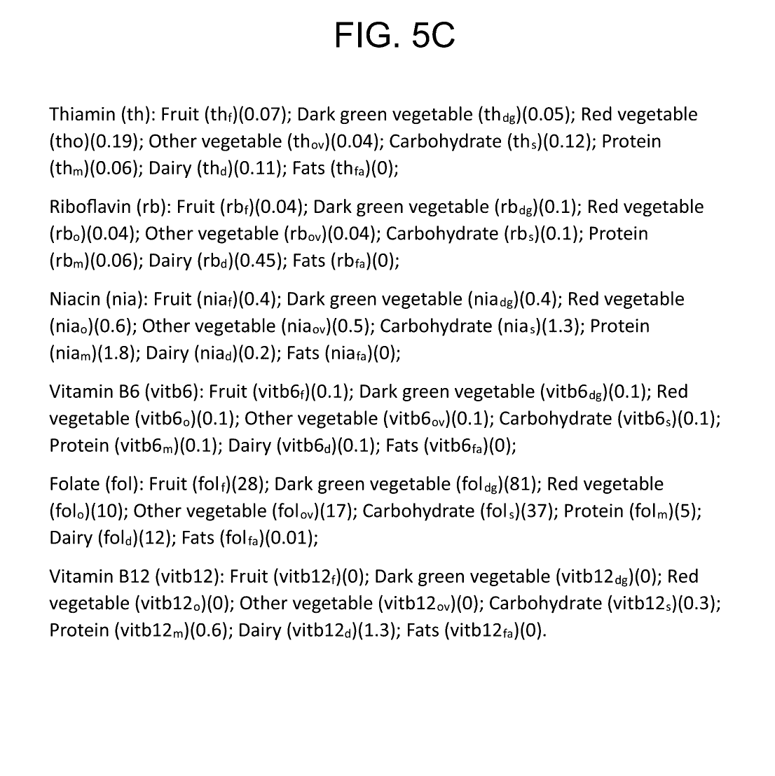

By use of the formulae described in the section “Invention Formulae,” the dietary menu planning system is designed to help improve nutrient intake accuracy, while allowing the subscriber to customize his or her own diet and modify them at any time. Reference is also made to FIG. 4 which shows exemplary nutritional database fields for providing the foregoing formulation of the Macronutrient Model and Nutrient Model, and nutritional data of USDA Nutritional Database SR 27. Reference is also made to FIG. 5 which shows exemplary nutrient food intake patterns per component based on nutritional studies of the USDA and further nutrient modeling tests.

In an embodiment, the present invention defines a component as a unit that provides a discrete nutrient profile that contains a predefined amount of each macronutrient, that is, grams protein, grams carbohydrates, and grams fat. For example, each carbohydrate component contains 16 grams carbohydrate, 2 grams protein, and 2 grams fat. Each protein component contains 2 grams carbohydrate, 8 grams protein, and 2.7 grams fat. Each fat component contains 0 grams of carbohydrate and protein, and 4.5 grams fat (FIG. 5).

In an embodiment, the present invention provides for a MACRONUTRIENT MODEL CALCULATOR (FIG. 1A) that generates nutrient component goals for the subscriber to maintain the pre-selected or default calories and macronutrient model, and a NUTRIENT MODEL (FIG. 1B) that provides the dietary intake food patterns for each food of the extensive USDA Nutritional Database SR 27 including food group component and macronutrient model component, to allow the subscriber to customize his or her diet and modify it at any time, not counting calories or macronutrient intake patterns, while still maintaining with accuracy the pre-selected or default calories and macronutrient model.

### Macronutrient Model Calculator

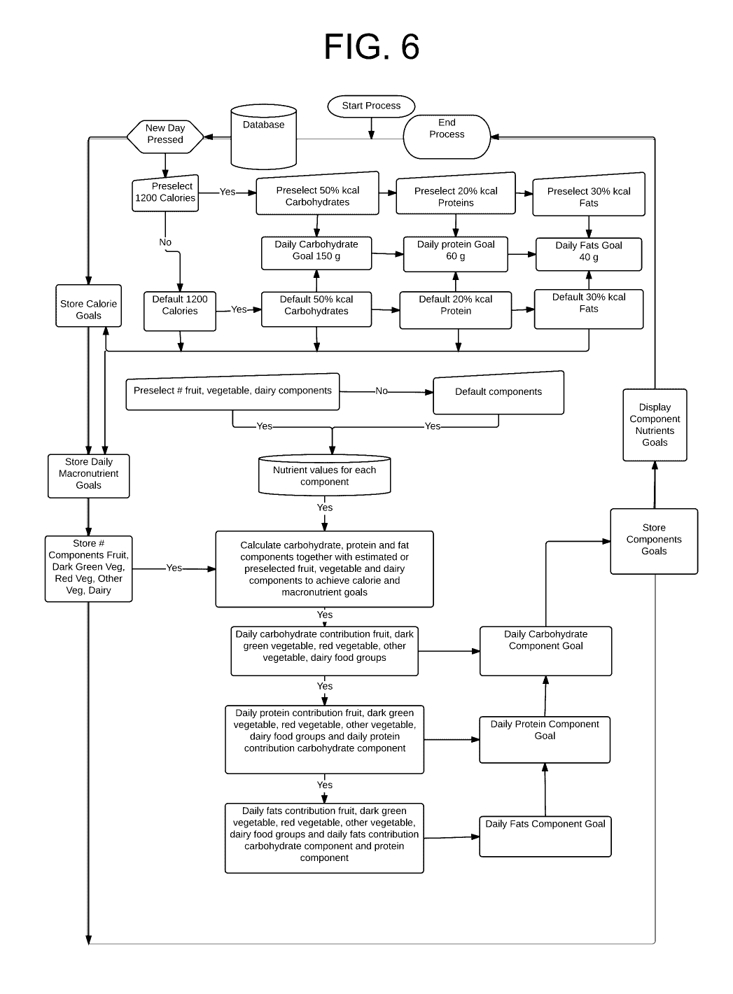

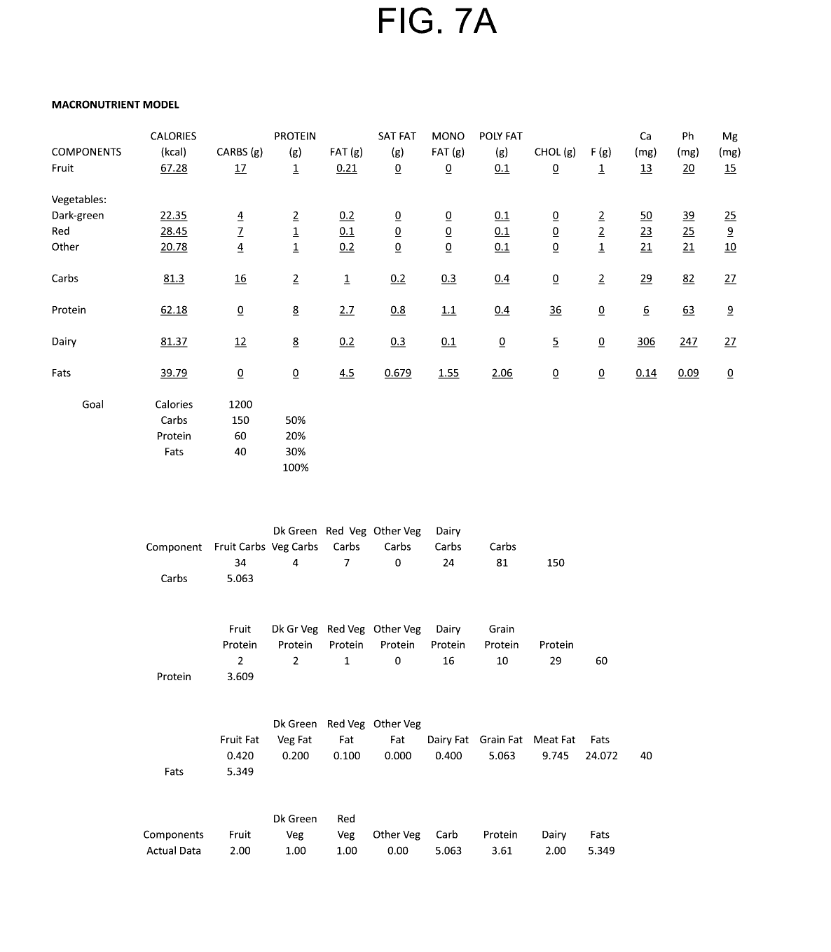

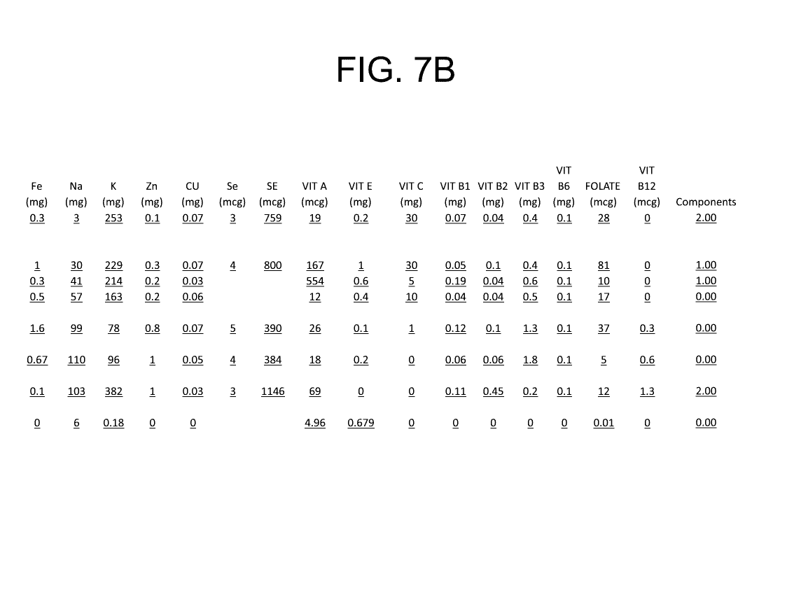

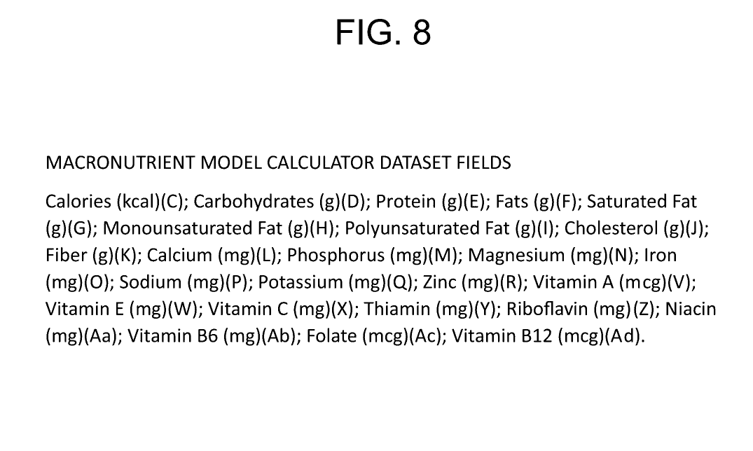

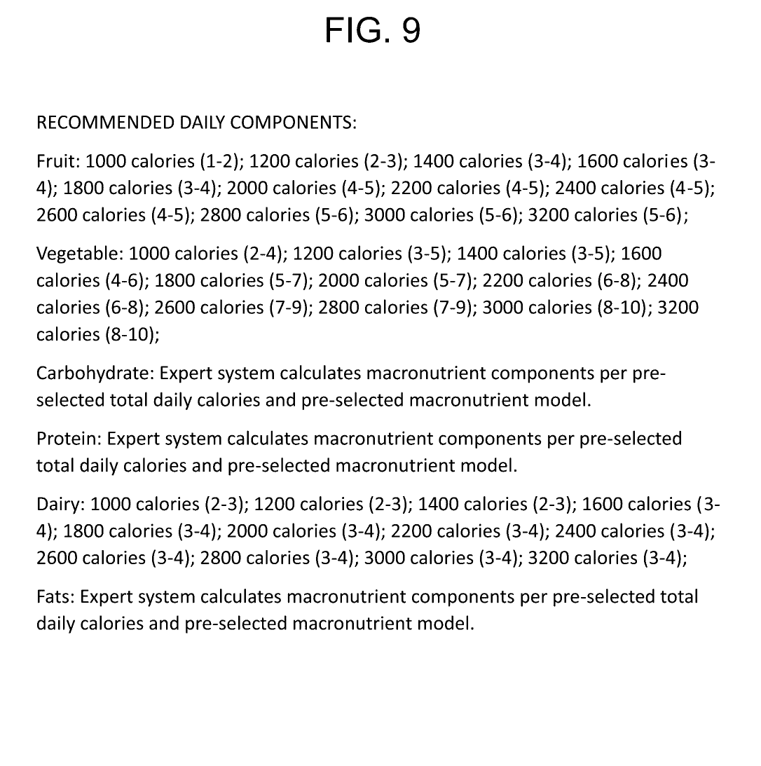

Reference is made to FIG. 1A, FIG. 6 and FIG. 7 which generally illustrate by means of an exemplary expert system and a flow chart how, according to an embodiment of the present invention, the MACRONUTRIENT MODEL CALCULATOR generates target goals to MAINTAIN THE SUBSCRIBER'S PRE-SELECTED CALORIES AND MACRONUTRIENT RATIOS. Reference is made to FIG. 8 which shows the nutritional database fields for the macronutrient model calculator according to an embodiment of the present invention. Reference is made to FIG. 9 which shows the recommended daily component for each food group and caloric level based upon nutritional studies conducted by USDA, according to an embodiment of the present invention.

In accordance with an embodiment of the present invention, the subscriber can preselect calories and macronutrient component goals, or allow the system to choose according to predefined assessment. In this case, the subscriber elects to pre-select his or her nutrient goals. As an example (FIG. 1A), the subscriber chooses 1200 calories and a macronutrient model of 50% kcal carbohydrates, 20% kcal protein, 30% kcal fats. The macronutrient ratio goals are converted to grams per day by the Macronutrient Model Calculator. The system calculates the daily macronutrient goals in grams at 1200 calories, 150 grams carbohydrates, 60 grams protein, and 40 grams fats.

In accordance with an embodiment of the present invention, the subscriber can pre-select component goals for fruits, vegetables, and dairy, or allow the system to choose according to predefined assessment. In one example, the subscriber elects to choose 2 fruit components, 1 dark green vegetable component, 1 red vegetable component, and 2 dairy components. The system calculates the foregoing component in grams at 69 grams carbohydrates, 21 grams protein, and 1.120 grams fats. By the foregoing formulation further described below, the carbohydrate, protein, and fats component goals are computed, stored and displayed for the subscriber. These components are included in the nutritional subscriber account.

The total daily carbohydrate component, protein component, fat component, fruit component, vegetable component, and dairy component of predetermined amounts are assigned to customer pre-selected calorie and macronutrient model goals. For example, to achieve the subscriber's calorie pattern of 1200 daily calories and macronutrient ratio goals of 50% carbohydrates, 20% proteins, and 30% fats, the system calculates the necessary component goals to be attained in the NUTRIENT MODEL as 2 fruit components, 1 dark green vegetable component, 1 red vegetable component, 5.063 carbohydrate components, 3.610 protein components, and 5.349 fat components.

### The Nutrient Model

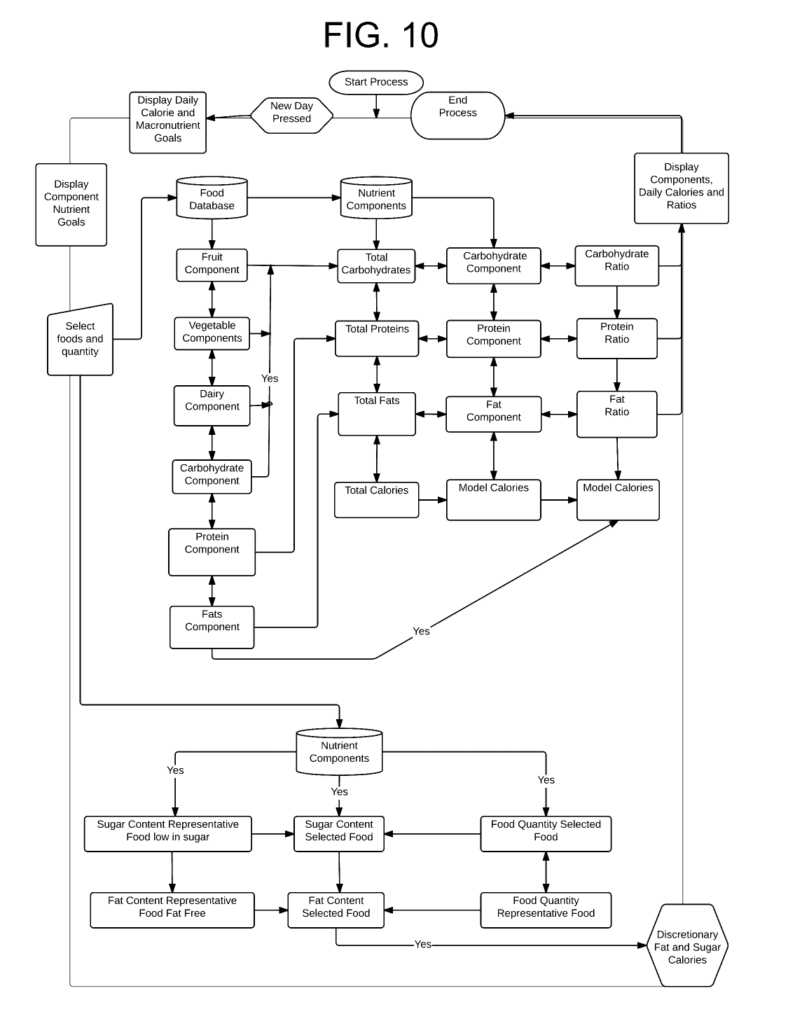

Reference is made to FIG. 1B, FIG. 3 and FIG. 10 which show in an exemplary flow chart a processes of the NUTRIENT MODEL according to an embodiment of the present invention. The subscriber selects a new day and the pre-selected calories and component goals generated by the Macronutrient Model Calculator are displayed.

An embodiment of the present invention includes the formulae described in section “Nutrient Model Formulae”, a calculator and processes for monitoring the customer selection of foods so that the customer can select any food from the extensive USDA SR 27 database while maintaining pre-selected calories, macronutrient ratios, and micronutrient goals to lose weight and/or achieve health goals. The subscriber can choose to customize his or her own diet and modify it at any time, or choose a computer generated daily or weekly menu plan based upon the pre-selected calories and component goals generated by the Macronutrient Model Calculator.

A NUTRIENT MODEL is generated for each food in the database by the foregoing formulation further described beginning on page below. For each food quantity selected, a determination is made of the protein (pro) component, fat (fa) component, carbohydrate (ch) component, and calories (kcal), in accordance with invention formulae. These macronutrient component, together with fruit component, vegetable component, and/or dairy component are used to calculate the actual dietary food intake pattern of subscriber foods selected from the USDA SR 27 database. The foregoing components were tested for accuracy with the NUTRIENT MODEL formulations.

As an example (FIG. 3), 1⅓ medium apples contain 2 fruit components, 126.23 calories, −0.168 protein components (0.627 grams protein); 0 carbohydrate components (33.520 grams carbohydrate); and, 0.101 fat component s(0.410 grams fats). Negative components are sometimes present in foods and help to balance the nutrient profile. After foods are selected, the invention formulae calculate total values of the components as 1197 calories, 3.632 protein components (60.140 grams protein); 5.082s carbohydrate component (149.337 grams carbohydrate); and 5.349 fat components (40.036 grams fats), while achieving the subscriber's desired ratio of calories at 20% protein, 50% carbohydrates, and 30% fats.

### Macronutrient Component Test

In accordance with an embodiment of the present invention, the NUTRIENT MODEL (that is, the carbohydrate component, protein component, fat component, fruit component, vegetable component, and dairy component) is tested for accuracy, in accordance with formulae in the “Macronutrient Test”. Total carbohydrates, proteins, fats and calories are calculated for the NUTRIENT MODEL, then compared to the actual data for carbohydrates, proteins, fats and calories.

### Invention Formulae

### Macronutrient Model Formulae

In an embodiment of the present invention, the formula for total carbohydrate goal, % calories to grams, is;

Ch(grams)=(C*Chr)/a

Where C=Total daily calories (kcal), Chr=carbohydrate ratio (% kcal), a=4. The constant a represents the calories per gram carbohydrates. The formula for proteins, % calories to grams, is:

Pro(grams)=(C*Pror)/b

Where C=Calories (kcal), Pror=protein ratio (% kcal), b=4. The constant b represents the calories per gram protein. The formula for fats, % calories to grams, is:

Tf(grams)=(C*Ftr)/c

Where C=Calories (kcal), Tfr=fats ratio (% kcal), f=9. The constant f represents the calories per gram fats. The values of the constants (that is, the number of calories per gram of carbohydrates (b) or the number of calories per gram of protein (d), or the number of calories per gram of fat (f) were empirically derived from data obtained from the USDA.

For such calories and macronutrient ratios, a determination is made of the carbohydrate (Aa) component, protein (W) component, and fat (Y) component, with following formulae. In a preferred embodiment of the present invention, the formula for the carbohydrate component is:

Aa=(Ch−Ae*Chf−Ag*Chdg−Ai*Ch0−Ak*Chov−Ac*Chd)/Chs

Where Ch=daily intake goal of carbohydrates in grams, Ae=fruit component, Ag=dark green vegetable component, Ai=red vegetable component, Ak=other vegetable component, Ac=dairy component, Chf=17, Chdg=4, Cho=7, Chov=4, Chs=16, and Chd=8. The values of the component (FIG. 7) were readily estimated or pre-selected by customer based upon recommendations derived from data obtains from nutritional studies conducted by USDA. The values of the constants (FIG. 4) were empirically derived from data obtained from nutritional studies conducted by USDA.

The formula for the protein component is:

W=(Pro−Ae*Prof−Ag*Prodg−Ai*Pro0−Ak*Proov−Ac*Prod−Aa*Pros)/Prom

Where Pro=daily intake goal of protein in grams, Ae=carbohydrate component, Ae=fruit component, Ag=dark green vegetable component, Ai=red vegetable component, Ak=other vegetable component, Ac=dairy component, Prof=1, Prodg=2, Proo=1, Proov=1, Pros=2, Prod=8, and Prom=8. The formula for the fat component is:

Y=(Tf−Ae*Tff−Ag*Tfdg−Ai*Tf0−Ak*Tfov−Ac*Tfd−Aa*Tfs−W*Tfm)/Tffa

Where Tf=daily intake goal of fats in grams, Aa=carbohydrate component, W=protein component, Ae=fruit component, Ag=dark green vegetable component, Ai=red vegetable component, Ak=other vegetable component, Ac=dairy component, Tff=0.21, Tfdg=0.2, Tfo=0.1, Tfov=0.2, Tfs=1, Tfd=0.2, and Tfm=2.7, and Tffa=4.5.

### Nutrient Model Formulae

The formula for the fruit component is:

Ae=Aw/Chf

Where Aw=total fruit carbohydrates in grams, and Chf=17. The formula for the carbohydrate component is:

Aaf=(Aw−Ae*Chf)/Chs

Where Aw=total carbohydrates in grams, Ae=fruit component, Chf=17, and Chs=16. The formula for the protein component is:

Wf=(As−Aa*Pros−Ae*Prof)/Prom

Where As=total protein in grams, Aa=carbohydrate component, Ae=fruit component, Pros=2, Prof=1, and Prom=8. The formula for the fat component is:

Yf=(Au−W*Tfm−Aa*Tfs−Ae*Tff)/Tffa

Where Au=total fat in grams, W=protein component, Aa=carbohydrate component, Tfm=2.7, Tfs=1, Tff=0.21, and Tffa=4.5. The formula for the model calories is:

Mcf=W*kcalm+Y*kcalfa+Aa*kcals+Ae*kcalf

Where W=protein component, Y=fat component, Aa=carbohydrate component, Ae=fruit component, kcalm=62.18, kcalfa=39.79, kcals=81.3, and kcalf=67.28. Advantageously, the nutrient component are whole numbers rounded to three decimals and are calculated for all common foods and component values. The decimals are converted to actual fractions. The values of the constants (FIG. 4) were empirically derived from data obtained from nutritional studies conducted by USDA.

Variations of the formula are appropriate for other food groups and food subgroups. For the fruit juice food subgroup, the formula for fruit component is:

Aefj=(Aw−Aa*Chs)/Chf

Where Aw=total carbohydrates in grams, Aa=carbohydrate component, Chs=16, and Chf=17. The formula for the carbohydrate component is:

Aafj=(Aw−Af*Chf)/Chs

Where Aw=total carbohydrates in grams, Af=fruit component fraction, Chf=17, and Chs=16. Other variations of formulae are discussed below.

For the dark green (dg) vegetable food subgroup, the formula for the dark green vegetable component is:

Ag=Aw/Chdg

Where Aw=total carbohydrates in grams, and Chdg=4. The formula for the carbohydrate component is:

Aadg=(Aw−Ag*Chdg)/Chs

Where Aw=total carbohydrates in grams, Ag=dg vegetable component, Chdg=4, and Chs=16. The formula for the protein component is:

Wdg=(As−Aa*Pros−Ag*Prodg)/Prom

Where As=total protein in grams, Aa=carbohydrate component, Ag=dg component, Pros=2, Prodg=2, and Prom=8. The formula for the fat component is:

Ydg=(Au−W*Tfm−Aa*Tfs−Ag*Tfdg)/Tffa

Where Au=total fat in grams, W=protein component, Aa=carbohydrate component, Ag=dg component, Tfm=2.7, Tfs=1, Tfdg=0.2, and Tffa=4.5. The formula for the calories is:

Mcdg=W*kcalm+Y*kcalfa+Aa*kcals+Ag*kcaldg+Ai*kcalo+Ak*kcalov

Where W=protein component, Y=fat component, Aa=carbohydrate component, Ag=dg component, kcalm=62.18, kcalfa=39.79, kcals=81.3, and kcaldg=22.35, kcalo=28.45, kcalov=20.78.

For the red vegetable (o) food subgroup, the formula for the red vegetable component is:

Ai=Aw/Cho

Where Aw=total carbohydrates in grams, and Cho=7. The formula for the carbohydrate component is:

Aao=(Aw−Ai*Cho)/Chs

Where Aw=total carbohydrates in grams, Ai=o component, Cho=7, and Chs=16. The formula for the protein component is:

Wo=(As−Aa*Pros−Ai*Proo)/Prom

Where As=total protein in grams, Aa=carbohydrate component, Ai=o component, Pros=2, Proo=1, and Prom=8. The formula for the fat component is:

Yo=(Au−W*Tfm−Aa*Tfs−Ai*Tfo)/Tffa

Where Au=total fat in grams, W=protein component, Aa=carbohydrate component, Ai=o component, Tfm=2.7, Tfs=1, Tfo=0.1, and Tffa=4.5. The formula for the calories is:

Mc0=W*kcalm+Y*kcalfa+Aa*kcals+Ag*kcaldg+Ai*kcalo+Ak*kcalov

Where W=protein component, Y=fat component, Aa=carbohydrate component, Ai=o component, kcalm=62.18, kcalfa=39.79, kcals=81.3, kcaldg=22.35, kcalo=28.45, and kcalov=20.78.

For the other (ov) vegetable food subgroup, the formula for the other vegetable component is:

Ak=Aw/Chov

Where Aw=total carbohydrates in grams, and Chov=4. The formula for the carbohydrate component is:

Aaov=(Aw−Ak*Chdg)/Chs

Where Aw=total carbohydrates in grams, Ak=ov component, Chdg=4, and Chs=16. The formula for the protein component is:

Wov=(As−Aa*Pros−Ak*Proov)/Prom

Where As=total protein in grams, Aa=carbohydrate component, Ak=ov component, Pros=2, Proov=1, and Prom=8. The formula for the fat component is:

Yov=(Au−W*Tfm−Aa*Tfs−Ak*Tfov)/Tffa

Where Au=total fat in grams, W=protein component, Aa=carbohydrate component, Ak=ov component, Tfm=2.7, Tfs=1, Tfov=0.2, and Tffa=4.5. The formula for the calories is:

Mcov=W*kcalm+Y*kcalfa+Aa*kcals+Ag*kcaldg+Ai*kcalo+Ak*kcalov

Where W=protein component, Y=fat component, Aa=carbohydrate component, Ak=ov component, kcalm=62.18, kcalfa=39.79, kcals=81.3, kcaldg=22.35, kcalo=28.45, and kcalov=20.78.

For the starch (s) food group, meat and meat substitutes (m) food group, fat (tf) food group, combination food group(s), including, but not limited to, soups, and spices, the formula for the carbohydrate component is:

Aas=As/Chs

Where Aw=total carbohydrates in grams, and Chs=16. The formula for the protein component is:

Ws=(As−Aa*Pros)/Prom

Where As=total protein in grams, Aa=carbohydrate component, Pros=2, and Prom=8. The formula for the fat component is:

Ys=(Au−W*Tfm−Aa*Tfs)/Tffa

Where Au=total fat in grams, W=protein component, Aa=carbohydrate component, Tfm=2.7, Tfs=1, and Tffa=4.5. The formula for the calories is:

Mcs=W*kcalm+Y*kcalfa+Aa*kcals

Where W=protein component, Y=fat component, Aa=carbohydrate component, kcalm=62.18, kcalfa=39.79, and kcals=81.3.

For the dairy (d) food group and the sweets group, the formula for the dairy component is:

Ac=(As−W*prom−Aa*pros−Ae*prof)/prom

Where As=total protein in grams, W=protein component, Aa=carbohydrate component, Ae=fruit component, prom=8, pros=2, and prof=1. The formula for the carbohydrate component is:

Aad=(Aw−Ad*Chd−Af*Chf)/Chs

Where Aw=total carbohydrates in grams, Ad=dairy component fraction, Af=fruit component fraction, Chd=12, and Chf=17, Chs=16. The formula for the protein component is:

Wd=(As−Ab*Pros−Ad*Prod−Af*Prof)/Prom

Where As=total protein in grams, Ab=carbohydrate component fraction, Ad=dairy component fraction, Af=fruit component fraction, Pros=2, Prod=8, Prof=1, and Prom=8. The formula for the fat component is:

Yd=(Au−W*Tfm−Aa*Tfs−Ac*Tfd−Ae*Tff)/Tffa

Where Au=total fat in grams, W=protein component, Aa=carbohydrate component, Ac=dairy component, Ae=fruit component, Tfm=2.7, Tfs=1, Tfd=0.2, Tff=0.2, and Tffa=4.5. The formula for the calories is:

Mcd=W*kcalm+Y*kcalfa+Aa*kcals+Ac*kcald

Where W=protein component, Y=fat component, Aa=carbohydrate component, Ac=dairy component, kcalm=62.18, kcalfa=39.79, kcals=81.3, and kcald=81.37.

For the condiments group, the formula for the red vegetable component is:

Aicd=(Aw−Aa*Chs−Ac*Chd)/Cho

Where Aw=total carbohydrates in grams, Aa=carbohydrate component, Ac=dairy component, Chs=16, Chd=12, and Cho=7. The formula for the carbohydrate component is:

Aacd=(Aw−Ad*Chd−Aj*Cho)/Chs

Where Aw=total carbohydrates in grams, Ad=dairy component fraction, Aj=o component fraction, Chd=12, Cho=7, and Chs=16. The formula for the protein component is:

Wcd=(As−Aa*Pros−Ac*Prod−Ai*Proo−Ak*Proov)/Prom

Where As=total protein in grams, Aa=carbohydrate component, Ac=dairy component, Ai=o component, Ak=ov component, Pros=2, Prod=8, Proo=1, Proov=1, and Prom=8. The formula for the fat component is:

Ycd=(Au−W*Tfm−Aa*Tfs−Ac*Tfd−Ai*Tfo)/Tffa

Where Au=total fat in grams, W=protein component, Aa=carbohydrate component, Ac=dairy component, Ai=o component, Tfm=2.7, Tfs=1, Tfd=0.2, Tfo=0.1, and Tffa=4.5. The formula for the calories is:

Mccd=W*kcalm+Y*kcalfa+Aa*kcals+Ac*kcald+Ai*kcalo

Where W=protein component, Y=fat component, Aa=carbohydrate component, Ac=dairy component, Ai=o component, kcalm=62.18, kcalfa=39.79, kcals=81.3, kcald=81.37, and kcalo=28.45.

For the beverage group made with dairy, the formula for the dairy component is:

Acb=(As−W*Prom−Aa*Pros)/Prom

Where As=total protein in grams, W=protein component, Aa=carbohydrate component, Prom=8, and Pros=2. The formula for the carbohydrate component is:

Aab=(Aw−Ad*Chd)/Chs

Where Aw=total carbohydrates in grams, Ad=dairy component fraction, Chd=12, and Chs=16. The formula for the protein component is:

Wb=(As−Ab*Pros−Ad*Prod)/Prom

Where As=total protein in grams, Ab=carbohydrate component fraction, Ad=dairy component fraction, Pros=2, Prod=8, and Prom=8. The formula for the fat component is:

Yb=(Au−W*Tfm−Aa*Tfs−Ac*Tfd)/Tffa

Where Au=total fat in grams, W=protein component, Aa=carbohydrate component, AC=dairy component, Tfm=2.7, Tfs=1, Tfd=0.2, and Tffa=4.5. The formula for the calories is:

Mcb=W*kcalm+Y*kcalfa+Aa*kcals+Ac*kcald

Where W=protein component, Y=fat component, Aa=carbohydrate component, Ac=dairy component, kcalm=62.18, kcalfa=39.79, kcals=81.3, and kcald=81.37.

Variations of the beverage group formula are appropriate for the beverage group made without dairy. For this beverage subgroup, formula (1) is eliminated. The other formulations are the same.

### Macronutrient Component Test Formulae

In an embodiment of the present invention, for the fruit (f) food group, the test formula for total carbohydrates is:

Chf=Aa*Chs+Ae*Chf

Where Aa=carbohydrate component, Ae=fruit component, Chs=16, and Chf=17. The test formula for total proteins is:

Prof=W*Prom+Y*Profa+Aa*Pros+Ae*Prof

Where W=protein component, Y=fat component, Aa=carbohydrate component, Ae=fruit component, Prom=8,Profa=0, Pros=2, Prof=1. The test formula for total fats is:

Tff=W*Tfm+Y*Tffa+Aa*Tfs+Ae*Tff

Where W=protein component, Y=fat component, Aa=carbohydrate component, Ae=fruit component, Tfm=2.7, Tffa=4.5, Tfs=1, and Tff=0.21.

For the dark green vegetable (dg) food subgroup, the test formula for total carbohydrates is:

Chdg=Aa*Chs+Ag*Chdg

Where Aa=carbohydrate component, Ag=dg component, Chs=16, and Chdg=4. The test formula for total proteins is:

Prodg=W*Prom+Y*Profa+Aa*Pros+Ag*Prodg

Where W=protein component, Y=fat component, Aa=carbohydrate component, Ag=dg component, Prom=8, Profa=0, Pros=2, Prodg=2. The test formula for total fats is:

Tfdg=W*Tfm+Y*Tffa+Aa*Tfs+Ag*Tfdg

Where W=protein component, Y=fat component, Aa=carbohydrate component, Ag=dg component, Tfm=2.7, Tffa=4.5, Tfs=1, and Tfdg=0.2.

For the red vegetable (o) food subgroup, the test formula for total carbohydrates is:

Cho=Aa*Chs+Ai*Cho

Where Aa=carbohydrate component, Ai=o component, Chs=16, and Cho=7. The test formula for total protein is:

Proo=W*Prom+Y*Profa+Aa*Pros+Ai*Proo

Where W=protein component, Y=fat component, Aa=carbohydrate component, Ai=o component, Prom=8, Profa=0, Pros=2, Proo=1. The test formula for total fats is:

Tfo=W*Tfm+Y*Tffa+Aa*Tfs+Ai*Tfo

Where W=protein component, Y=fat component, Aa=carbohydrate component, Ai=o component, Tfm=2.7, Tffa=4.5, TfS=1, and Tfo=0.1.

For the other vegetable (ov) food subgroup, the test formula for total carbohydrates is:

Chov=Aa*Chs+AK398*Chov

Where Aa=carbohydrate component, Ak=ov component, Chs=16, and Chov=4. The test formula for total protein is:

Proov=W*Prom+Y*0+Aa*2+Ak*Proov

Where W=protein component, Y=fat component, Aa=carbohydrate component, Ak=ov component, Prom=8, Profa=0, pros=2, Proov=1. The test formula for total fats is:

Tfov=W*Tfm+Y*Tffa+Aa*Tfs+Ak*Tfov

Where W=protein component, Y=fat component, Aa=carbohydrate component, Ak=ov component, Tfm=2.7, Tffa=4.5, Tfs=1, and Tfov=0.2.

For the starch (s) food group and meat and meat substitutes (m) food group, the test formula for total carbohydrates is:

Chs=Aa*Chs

Where Aa=carbohydrate component, and Chs=16. The test formula for total proteins is:

Pros=W*Prom+Y*Profa+Aa*Pros

Where W=protein component, Y=fat component, Aa=carbohydrate component, Prom=8, Profa=0, and Pros=2. The test formula for total fats is:

Tfs=W*Tfm+Y*Tffa+Aa*Tfs

Where W=protein component, Y=fat component, Aa=carbohydrate component, Tfm=2.7, Tffa=4.5, and Tfs=1.

For the dairy (d) food group, fat (tf) food group, and combination food group, including, but not limited to soups, the test formula for total carbohydrates is:

Chd=Aa*Chs+Ac*Chd

Where Aa=carbohydrate component, Ac=d component, Chs=16, and Chd=12. The test formula for total proteins is:

Prod=W*Prom+Y*Profa+Aa*Pros+Ac*Prod

Where W=protein component, Y=fat component, Aa=carbohydrate component, Ac=d component, Prom=8, Profa=0, Pros=2, Prod=8. The test formula for total fats is:

Tfd=W*Tfm+Y*Tffa+Aa*Tfs+Ac*Tfd

Where W=protein component, Y=fat component, Aa=carbohydrate component, Ac=d component, Tfm=2.7, Tffa=4.5, Tfs=1, and Tfd=0.2.

For the condiments group, the test formula for total carbohydrates is:

Chcd=Aa*Chs+Ac*Chd+Ai*Cho

Where Aa=carbohydrate component, Ac=d component, Ai=o component, Chs=16, Chd=12, and Cho=7. The test formula for total proteins is:

Procd=W*Prom+Y*Profa+Aa*Pros+Ac*Prod+Ai*Proov

Where W=protein component, Y=fat component, Aa=carbohydrate component, Ac=d component, Ai=o component, Prom=8, Profa=0, Pros=2, Prod=8, and Proo=1. The test formula for total fats is:

Tfcd=W*Tfm+Y*Tffa+Aa*Tfs+Ac*Tfd+Ai*Tfo

Where W=protein component, Y=fat component, Aa=carbohydrate component, Ac=d component, Ai=o component, Tfm=2.7, Tffa=4.5, Tfs=1, Tfd=0.2, and Tfo=0.1.

For the sweets group, the test formula for total carbohydrates is:

Chsw=Aa*Chs+Ac*Chd+Ae*Chf

Where Aa=carbohydrate component, Ac=d component, Ae=f component, Chs=16, Chd=12, and Chf=17. The test formula for total proteins is:

Prosw=W*Prom+Y*Profa+Aa*Pros+Ac*Prod+Ae*Prof

Where W=protein component, Y=fat component, Aa=carbohydrate component, Ac=d component, Ae=f component, Prom=8, Profa=0, Pros=2, Prod=8, and Prof=1. The test formula for total fats is:

Tfsw=W*Tfm+Y*Tffa+Aa*Tfs+Ac*Tfd+Ae*Tff

Where W=protein component, Y=fat component, Aa=carbohydrate component, Ac=d component, AE=f component, Tfm=2.7, Tffa=4.5, Tfs=1, Tfd=0.2, and Tff=0.21.

For the beverage group and spice group, the test formula for total carbohydrates is:

Chb=Aa*Chs+Ac*Chd

Where Aa=carbohydrate component, Ac=d component, Chs=16, and Chd=12. The test formula for total proteins is:

Prob=W*Prom+Y*Profa+Aa*Pros+Ac*Prod

Where W=protein component, Y=fat component, Aa=carbohydrate component, Ac=d component, Prom=8, Profa=0, Pros=2, and Prod=8. The test formula for total fats is:

Tfb=W*Tfm+Y*Tffa+Aa*Tfs+Ac*Tfd

Where W=protein component, Y=fat component, Aa=carbohydrate component, Ac=d component, Tfm=2.7, Tffa=4.5, Tfs=1, and Tfd=0.2.

### Discretionary Calories

The discretionary calorie allowance is the added amount of sugar and/or fat calories in each food pattern as compared to nutrient-dense forms (that is, forms that contain no added sugars and that are fat-free or low-fat), (the “Representative Food”). Added sugars are the sugars and syrups added to foods and beverages in processing or preparation, not the naturally occurring sugars in fruits or milk. The amount of added sugar calories represents the amounts that can be included at each calorie level. Added fats are the fats consumed when higher fat items are selected in each food pattern as compared to foods in their lowest fat forms (e.g., sweetened cranberry juice cocktail instead of unsweetened cranberry juice, whole milk instead of fat-free milk, chicken with skin instead of skinless chicken, regular cheese instead of fat-free cheese, butter instead of fat-free vegetable oil spread).

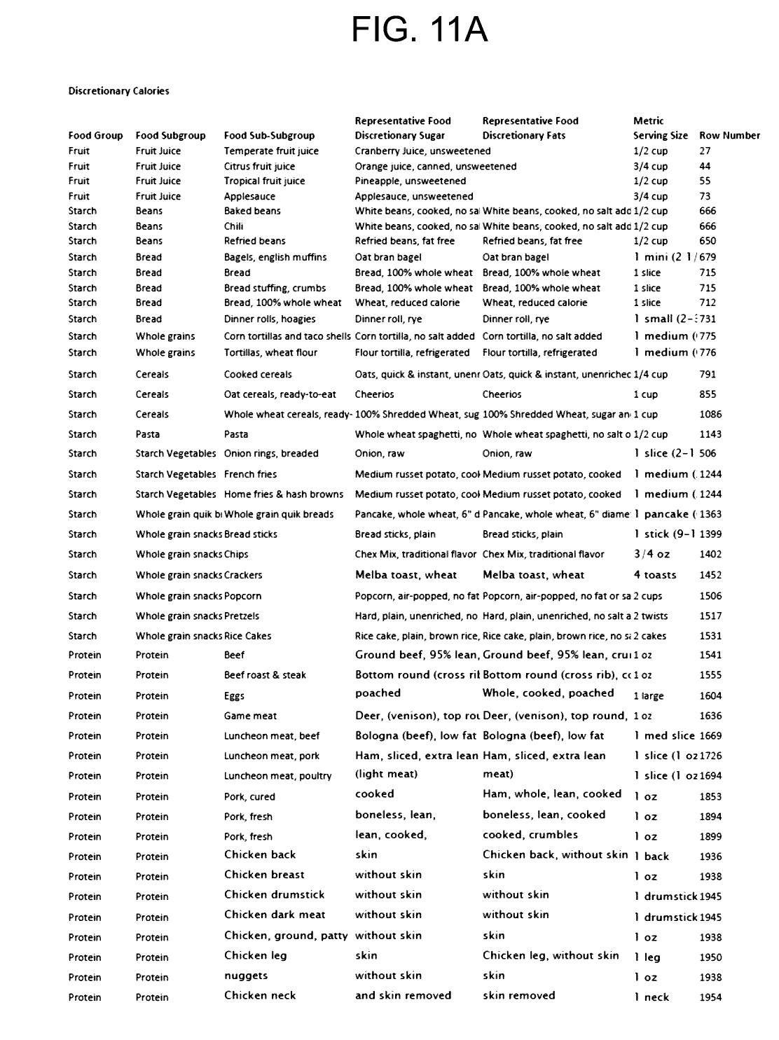

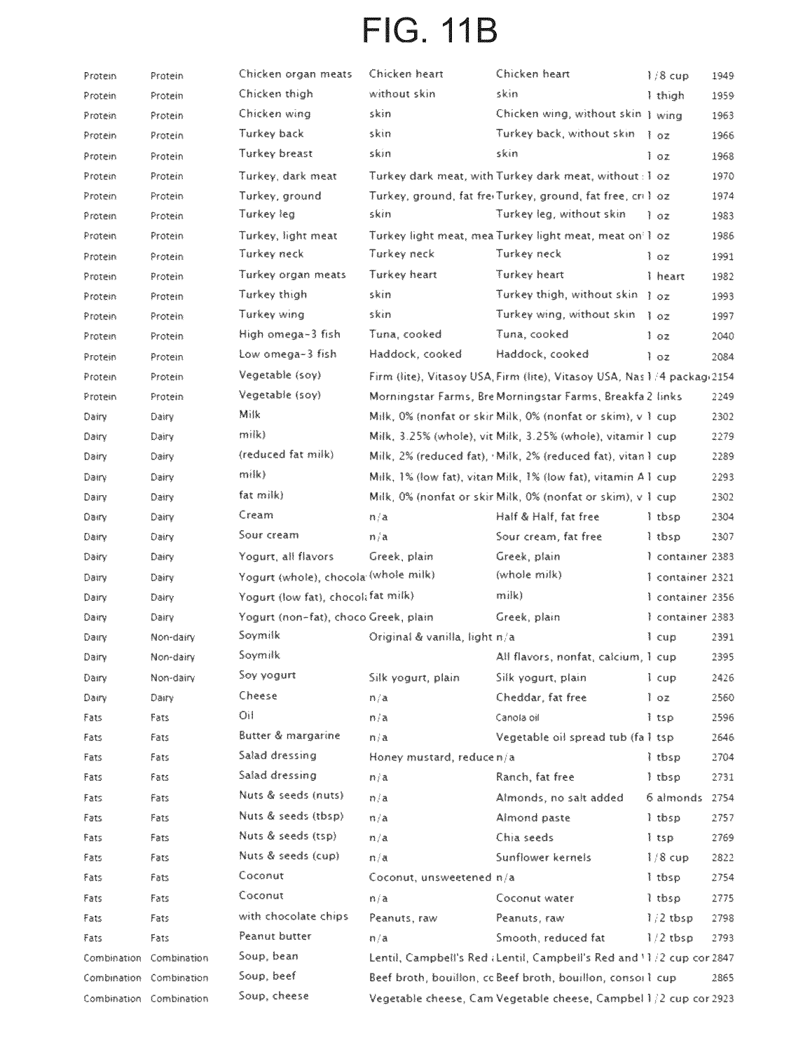

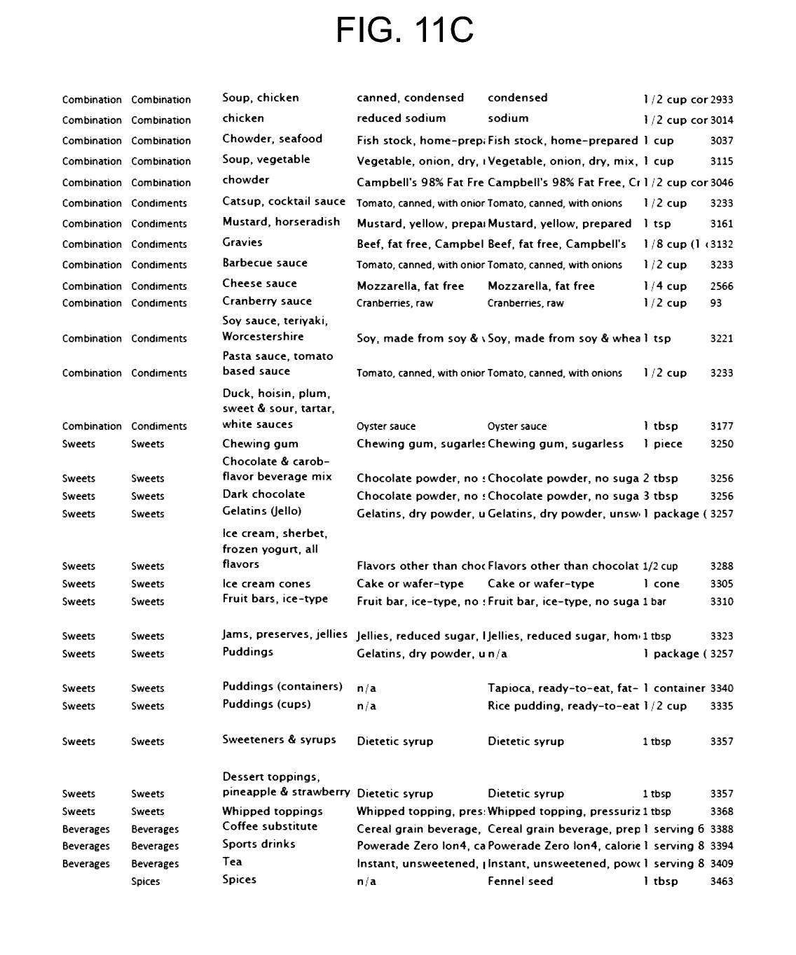

In accordance with preferred embodiments of the present invention, a REPRESENTATIVE FOOD (FIG. 11) is assigned to each customer food or food subgroup of readily estimated or predetermined added sugar and added fat content. For example, applesauce, unsweetened is the representative food for the food applesauce, sweetened; ground beef, 95% lean is the representative food for meat and meat substitute food subgroup beef. For such foods or food subgroups, a determination is made of the added sugar calories and added fat calories, in accordance with formulae described in section “Discretionary Calories Formulae.”

### Discretionary Calories Formulae

In an embodiment of the present invention, the formula for added sugar calories is:

ASC=(Ay−(Ayr*(T/Tr)))*a

Where Ay=total sugar in grams, Ayr=total sugar of representative food in grams, T=food quantity in whole numbers, Tr=food quantity of representative food in whole numbers, and a=4. The formula for added fat calories is:

AFC=(Au−(Aur*(T/Tr)))*b

Where Au=total fat in grams, Aur=total fat of representative food in grams, T=food quantity in whole numbers, Tr=food quantity of representative food in whole numbers, and b=9. The values of the constants (that is, the number of calories per gram of sugar (a) or the number of calories per gram of fat (b)) were empirically derived from data obtained from the USDA.

### Micronutrient Model

Most diseases and conditions alter needs for only a few nutrients, with other nutrient needs remaining similar to those of healthy persons. Each food group or subgroup or food(s) contribute specific nutrients. Major contribution means that the food group or subgroup or food(s) provide more of the total amount of a specific nutrient than any other single food group or subgroup or food, over all calorie levels. A substantial contribution means that the food group or subgroup or food(s) provide 10% or more of the total amount of a specific nutrient, over all calorie levels. Only the major contribution food group(s) or food subgroup(s) or foods are used in the modification of the daily intake of a specific nutrient. The goal is to find a balance between food choices and nutrient contribution across all nutrients.

### Micronutrient Modelling by Food Group(s) or Food Subgroup(s)

FIG. 5 provides a summary of the nutrient contribution of each food group, averaged over food patterns at all energy levels, according to an embodiment of the current invention. To increase or decrease specific nutrients, the system allows the subscriber to either change the calories and macronutrient ratio or increase components for major contribution food group(s), followed by increase in components for substantial contribution food group(s). These food group(s) include fruit, dark green vegetable, red vegetable, other vegetable, and dairy.

### Example (According to an Embodiment)

The 1200 calorie diet and macronutrient model (carbohydrates 50%, protein 20%, fat 30%) and components (fruit 2; dark green vegetable 1; red vegetable 1; dairy 2) achieves the following micronutrient goals: Saturated fat: 8.13 g; Monounsaturated fat: 13.98 g; Polyunsaturated fat: 14.89 g; Cholesterol: 139.94 g; Fiber: 16.13 g; Calcium: 880.22 mg; Phosphorus: 1241 mg; Magnesium: 287.17 mg; Iron: 12.62 mg; Sodium: 1213.32 mg; Potassium: 2455.34 mg; Zinc: 10.36 mg; Vitamin A: 1120.13 mcg; Vitamin E: 6.86 mg; Vitamin C: 100.06 mg; Thiamin: 1.42 mg; Riboflavin: 1.84 mg; Niacin: 15.28 mg; Vitamin B6: 1.47 mg; Folate: 376.41 mcg; Vitamin B12: 6.28 mcg.

Increasing fruit and vegetable components (fruit 3; dark green vegetable 3, red vegetable 2, dairy 2) increases Polyunsaturated fat: 15.29 g; Fiber: 19.13 g; Calcium: 956.78 mg; Magnesium: 304.92 mg; Potassium: 3200.42 mg; Vitamin A: 1972.79; Vitamin E: 9.71 mg; Vitamin C: 193.06 mg; Thiamin: 1.53 mg; Riboflavin 1.91 mg; Folate: 501.17 mcg; Vitamin B6: 1.64 mg.

To the contrary, increasing fruit and vegetable components (fruit 3; dark green vegetable 3, red vegetable 2, dairy 2) decreases Saturated fat: 7.83; Monounsaturated fat: 13.78 g; Cholesterol: 130.94 g; Phosphorus: 1184.29 mg; Iron: 11.85 mg; Sodium: 1094.44 mg; Zinc: 9.41 mg; Niacin: 14.03 mg; Vitamin B12: 5.53 mcg.

### Micronutrient Modeling by Food Choices

Food sources are ranked by amounts of a specific nutrient present. Baseline contributions (FIG. 5) have been established for each nutrient for achieving dietary food pattern goals. These foods are readily identified by the subscriber with their elemental letters.

### Individual Health Assessment

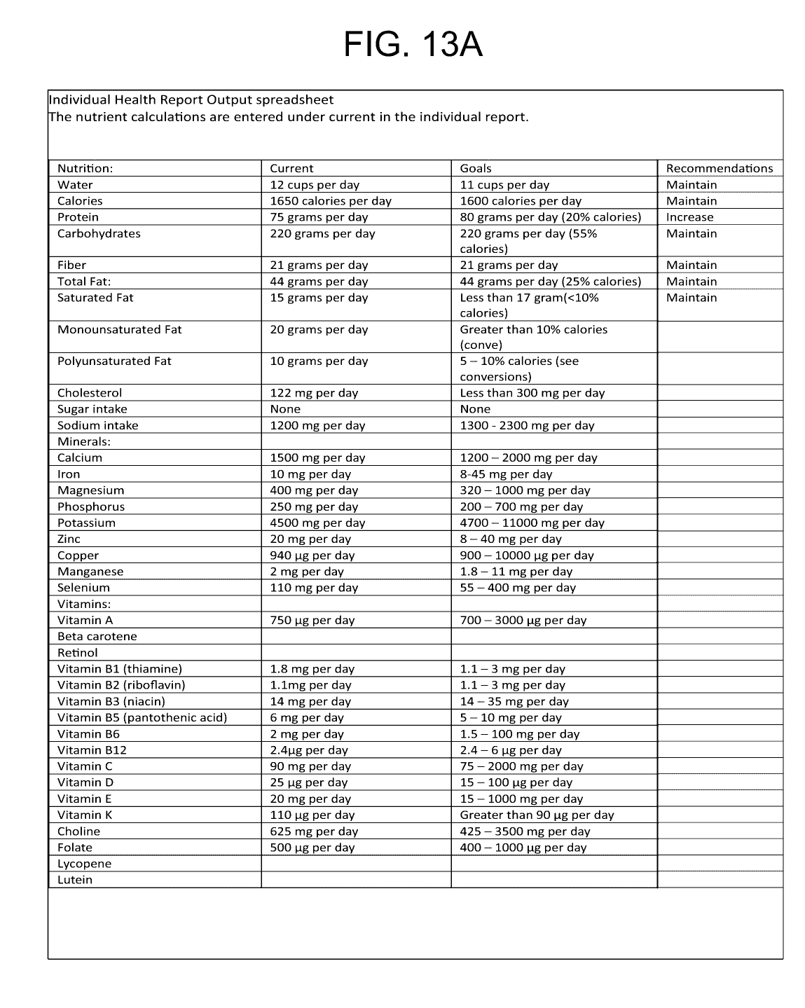

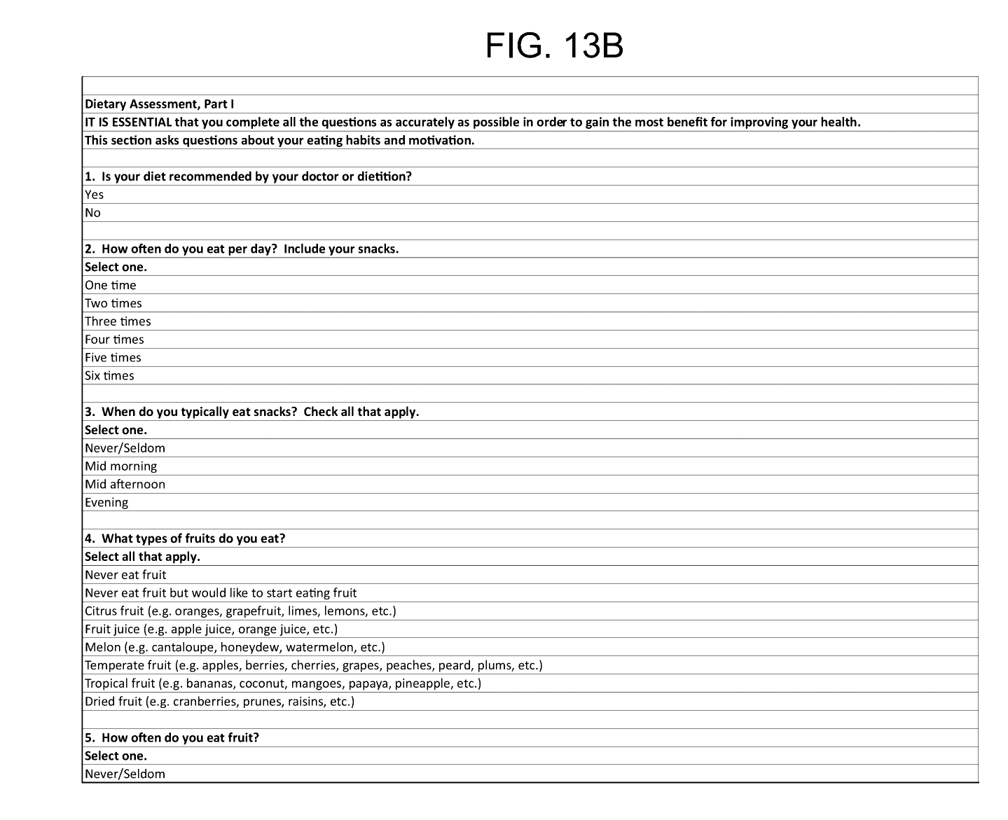

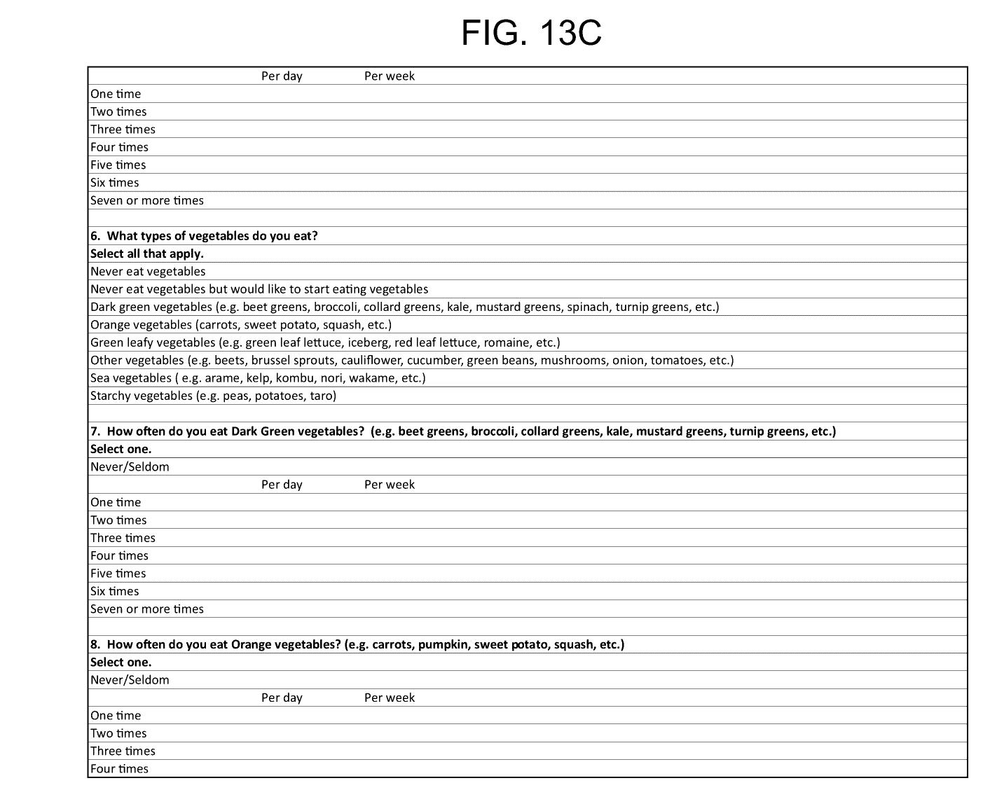

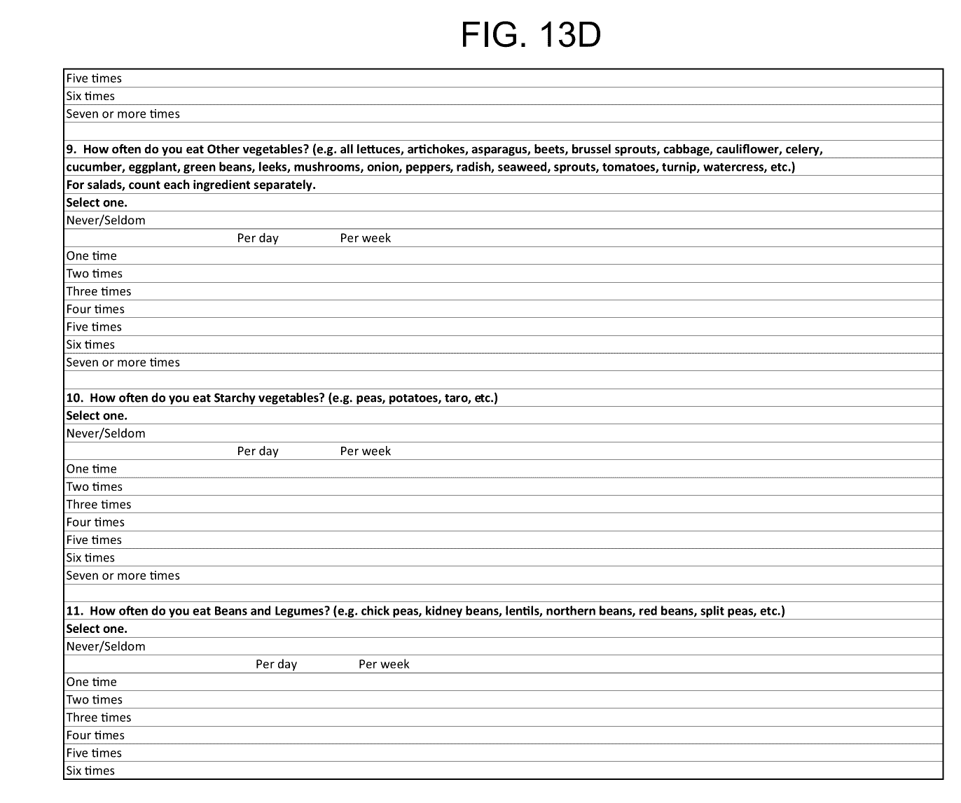

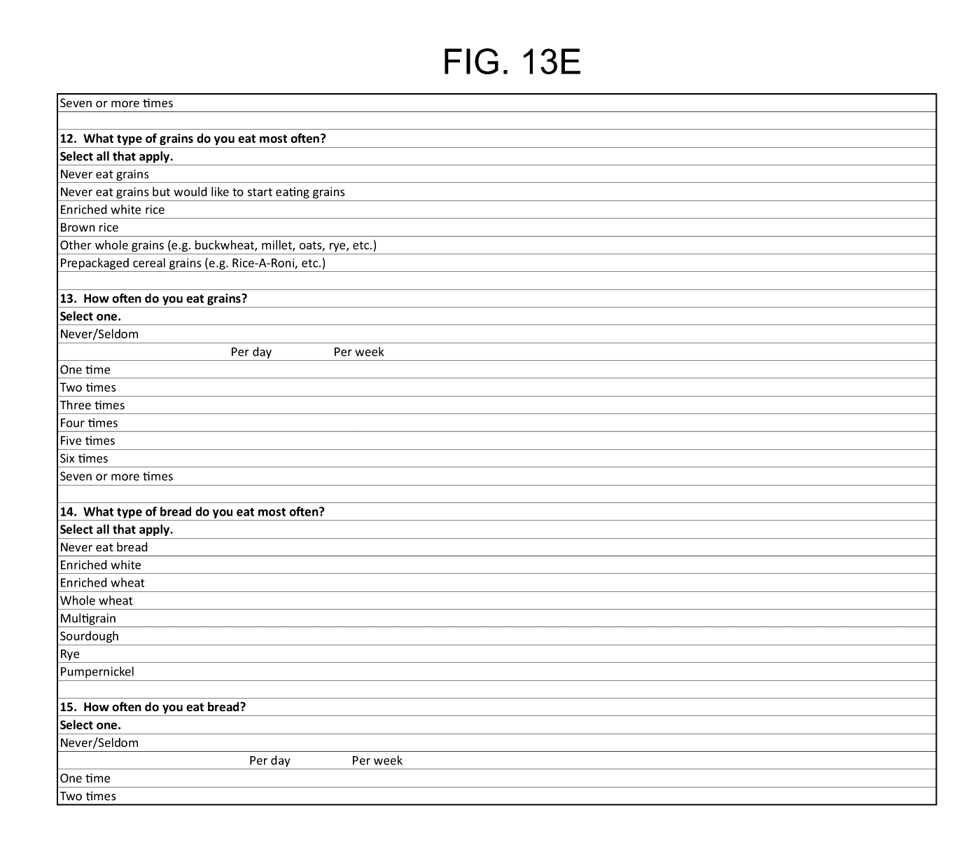

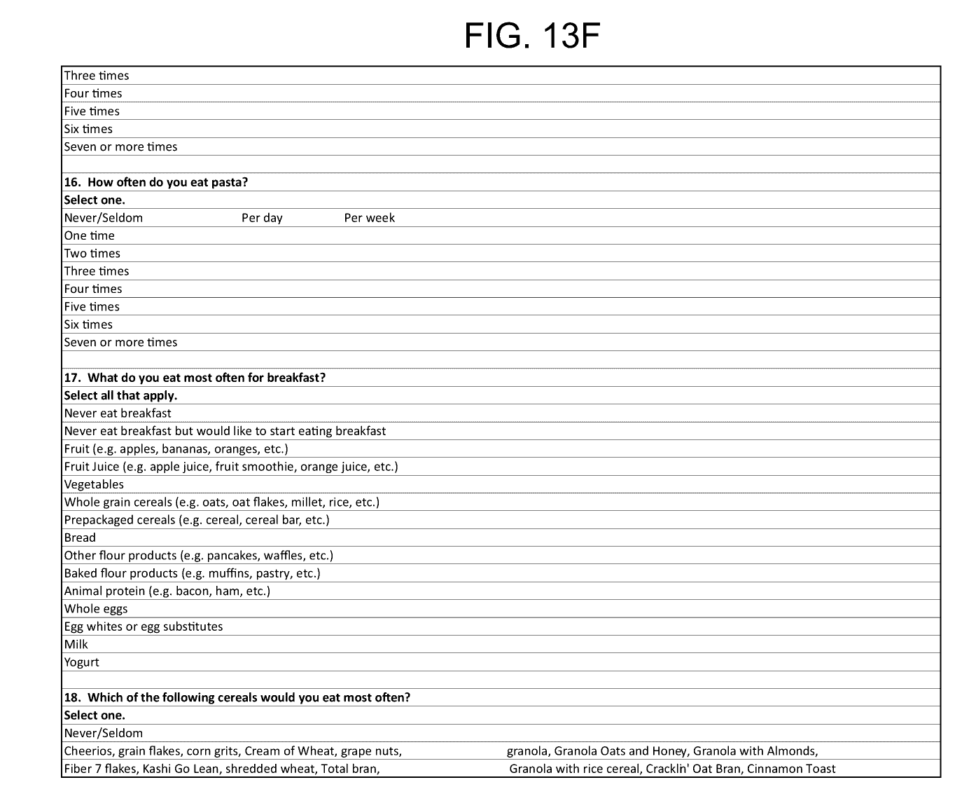

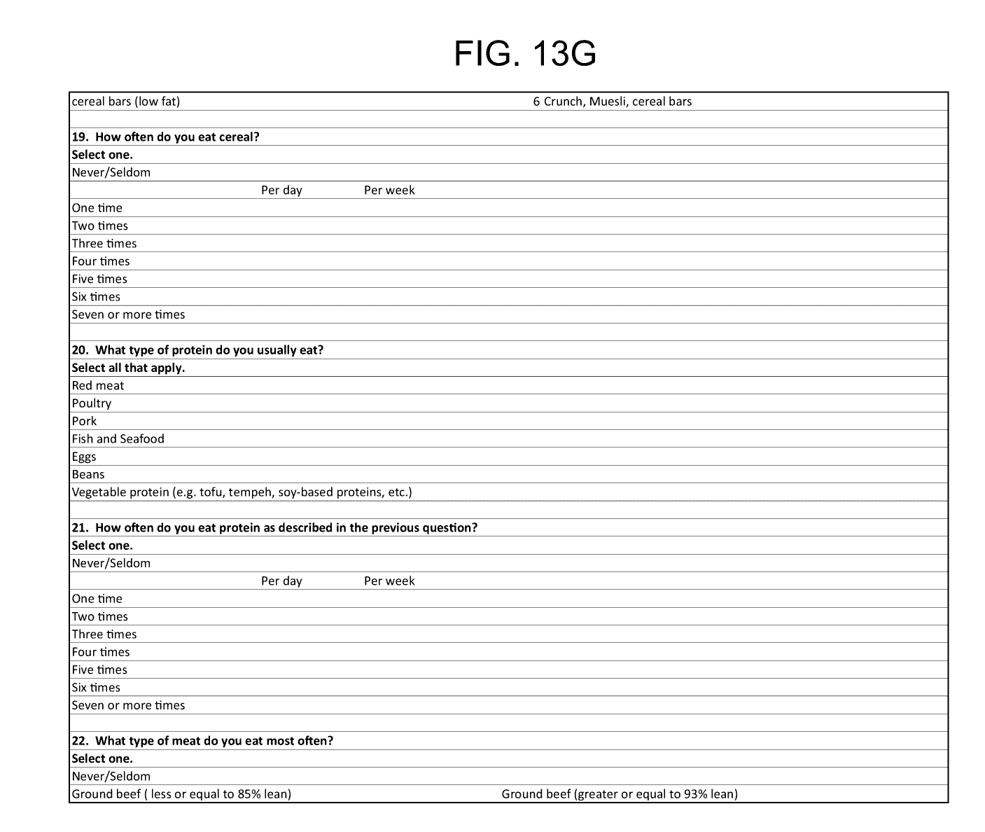

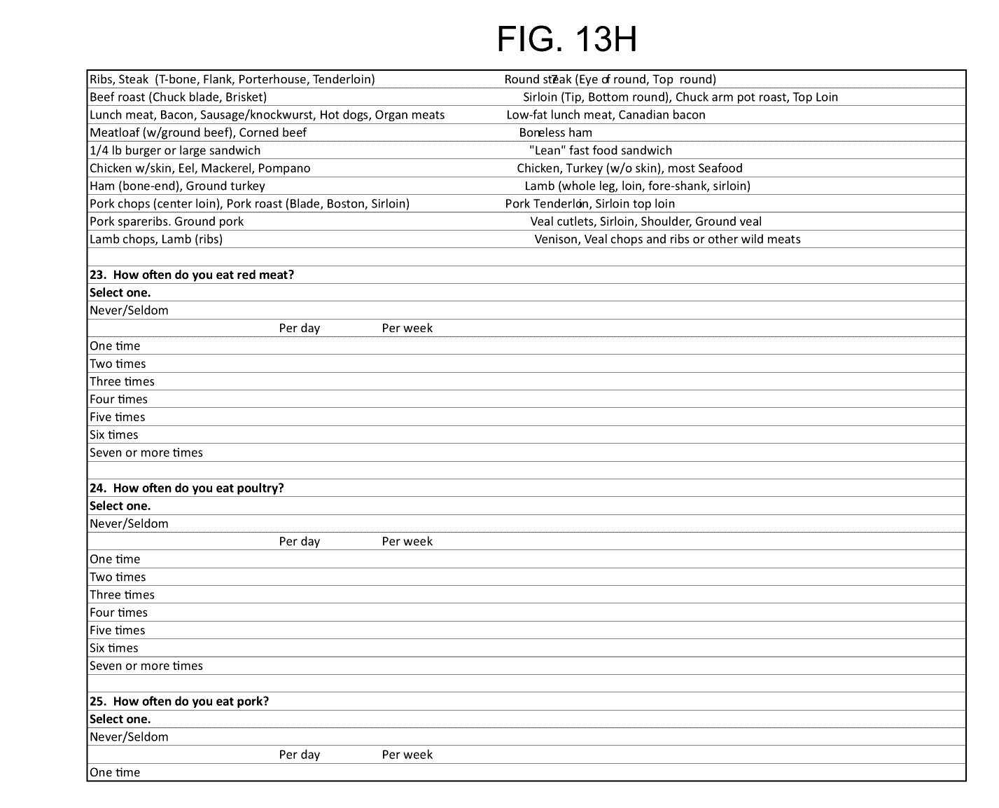

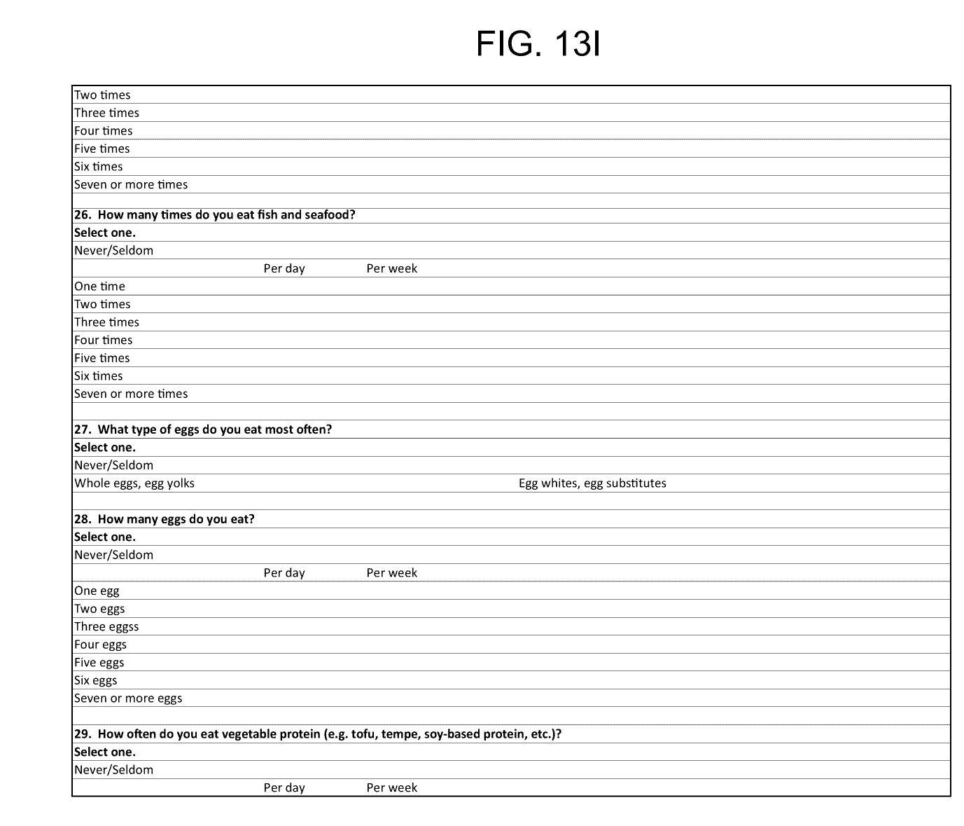

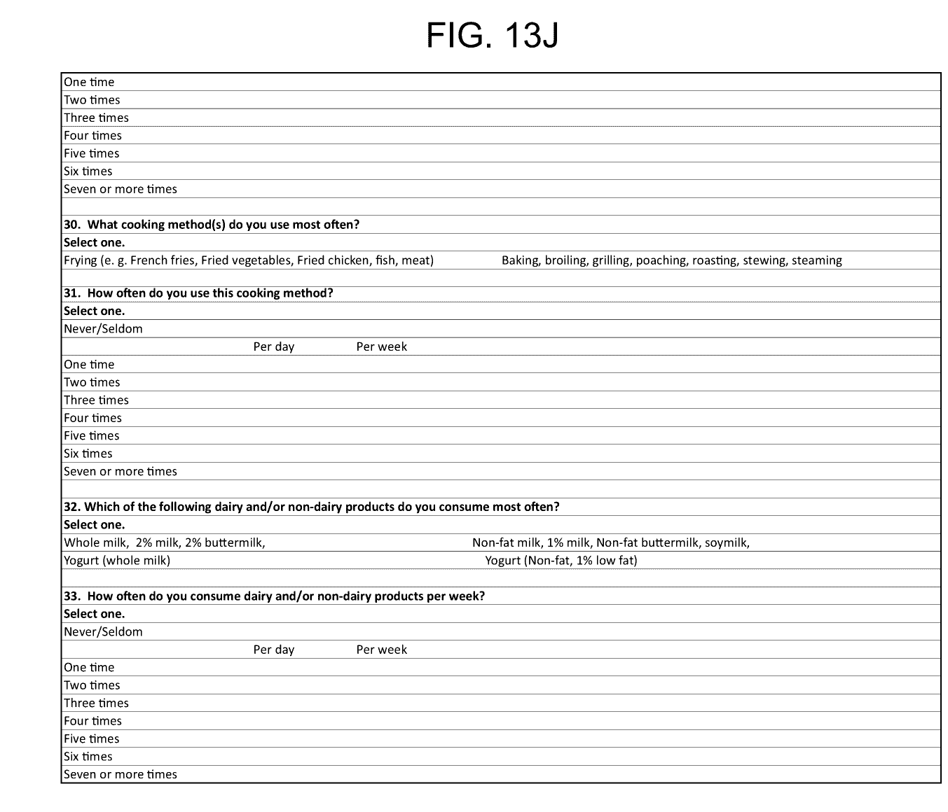

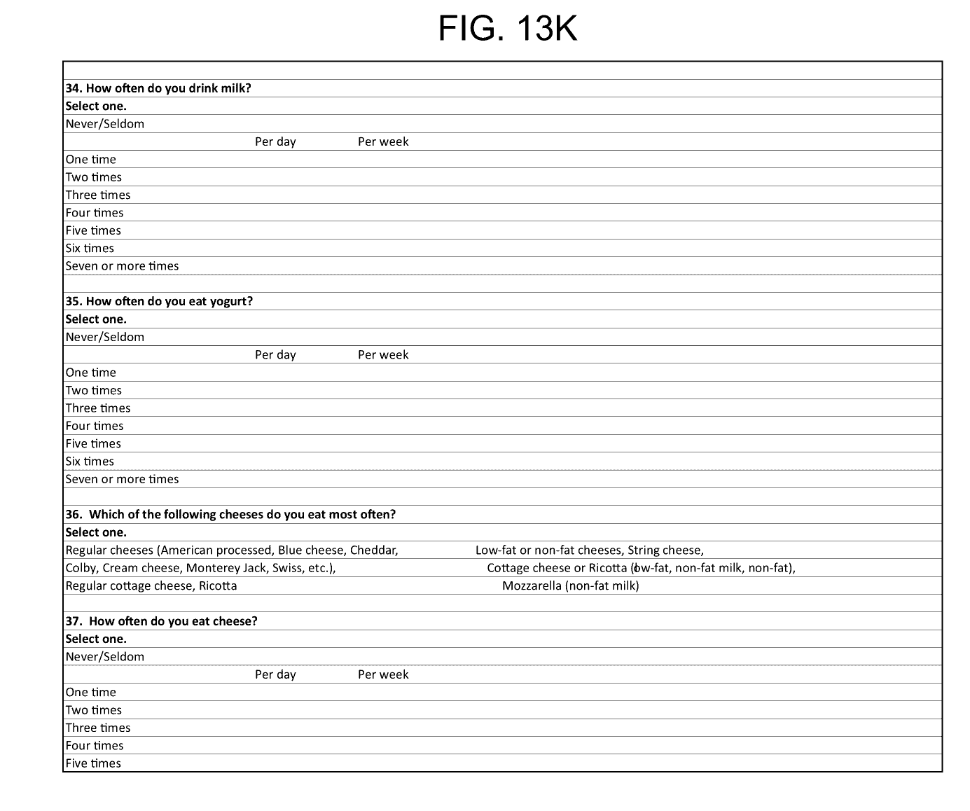

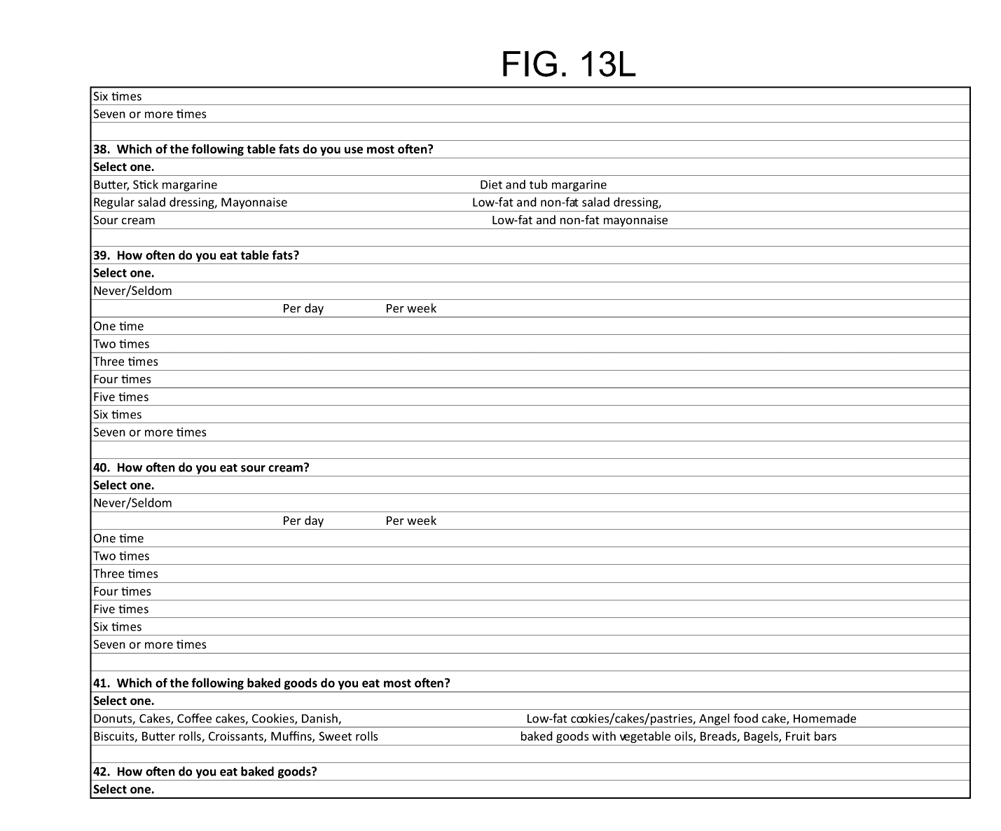

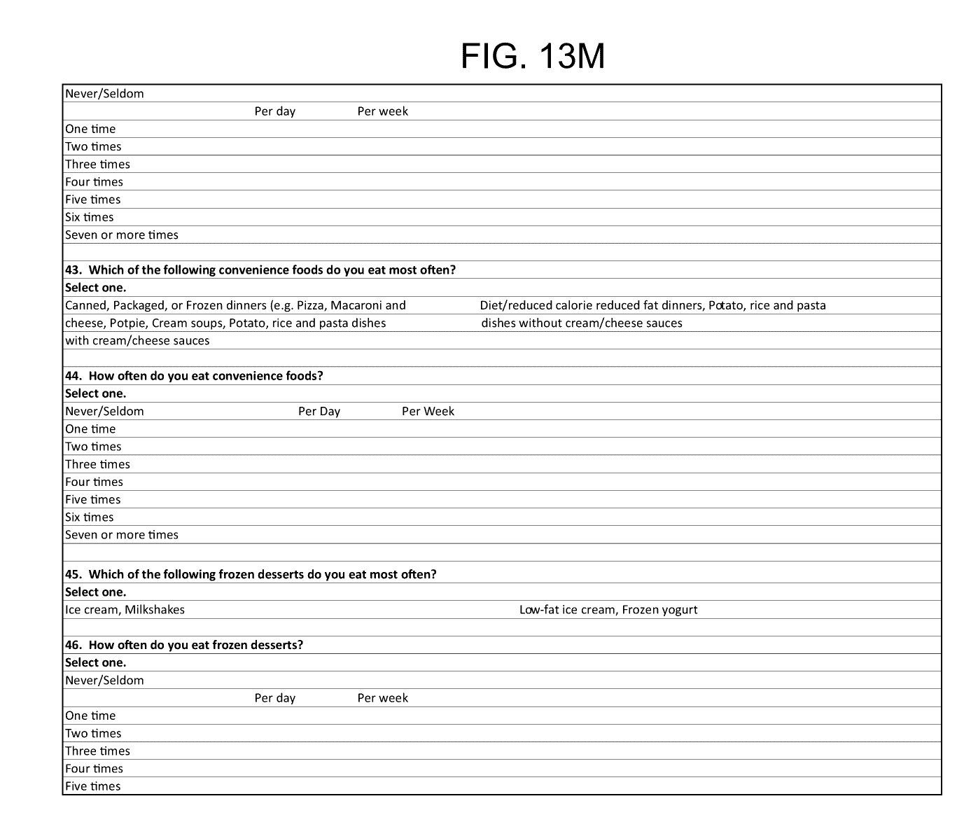

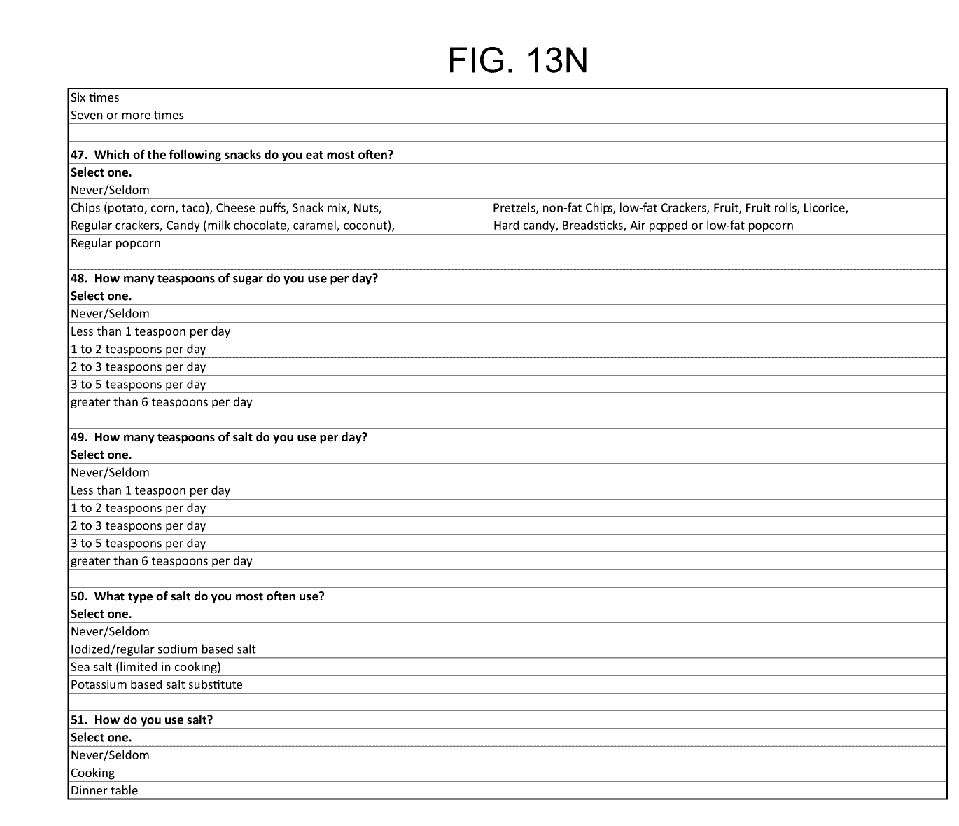

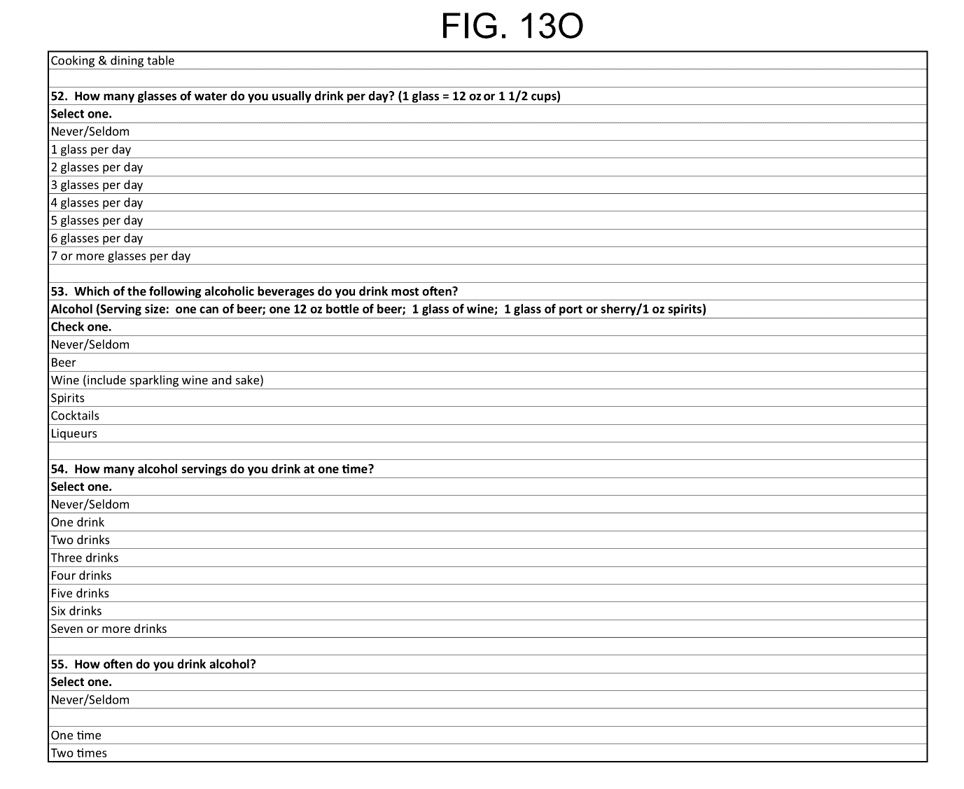

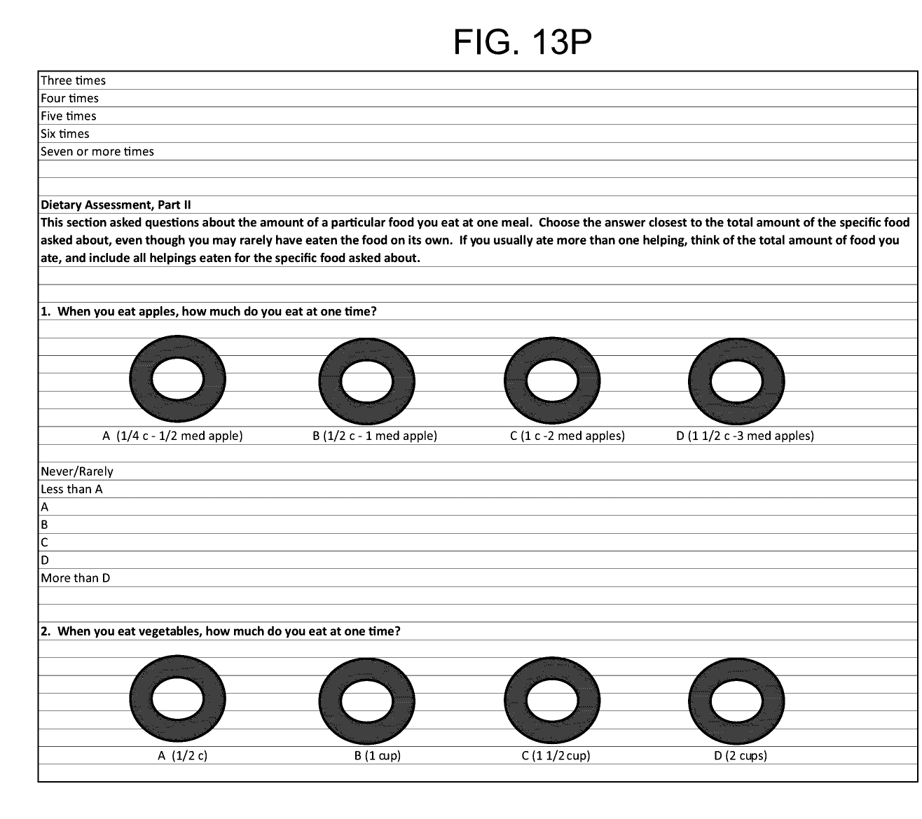

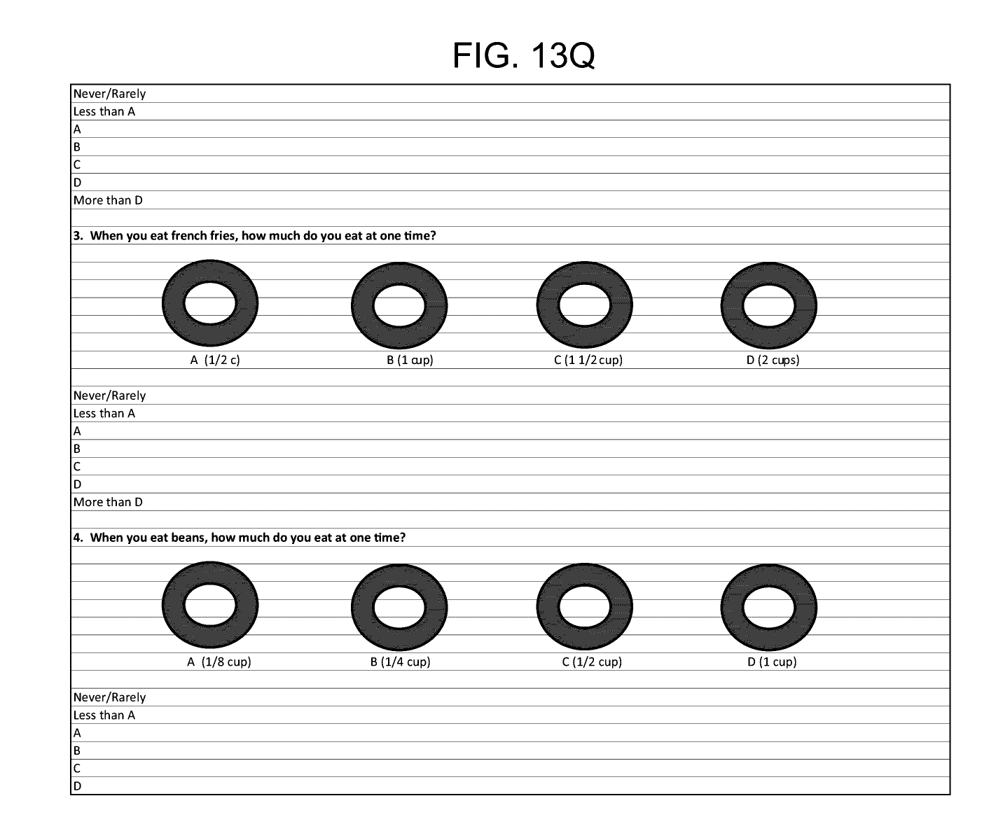

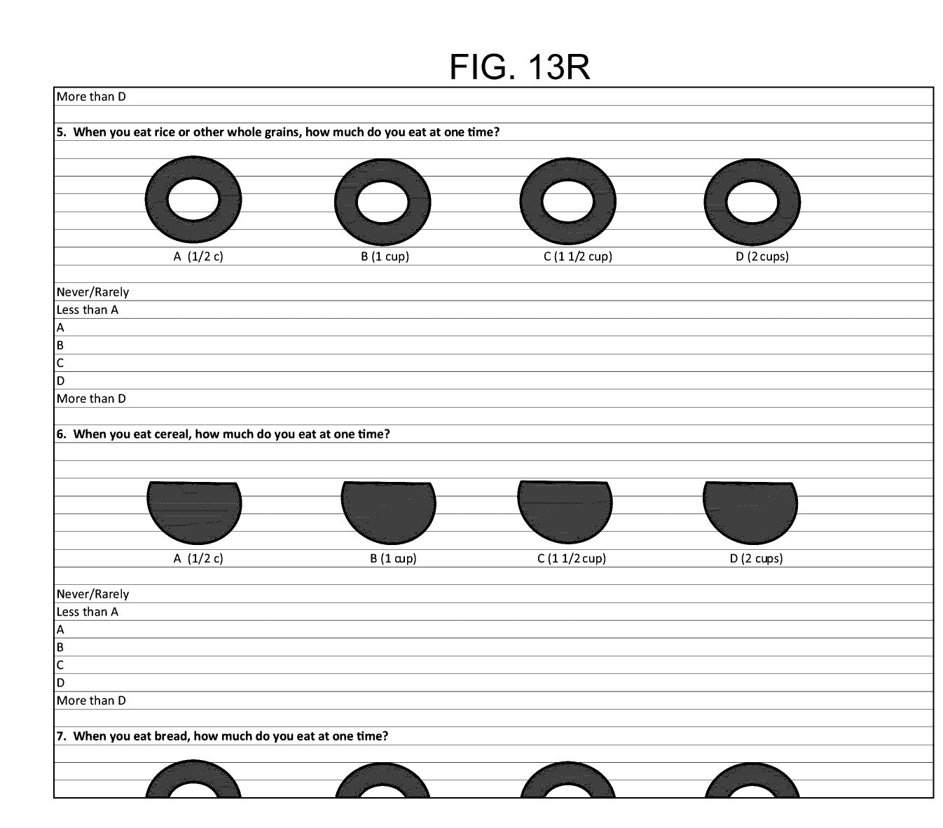

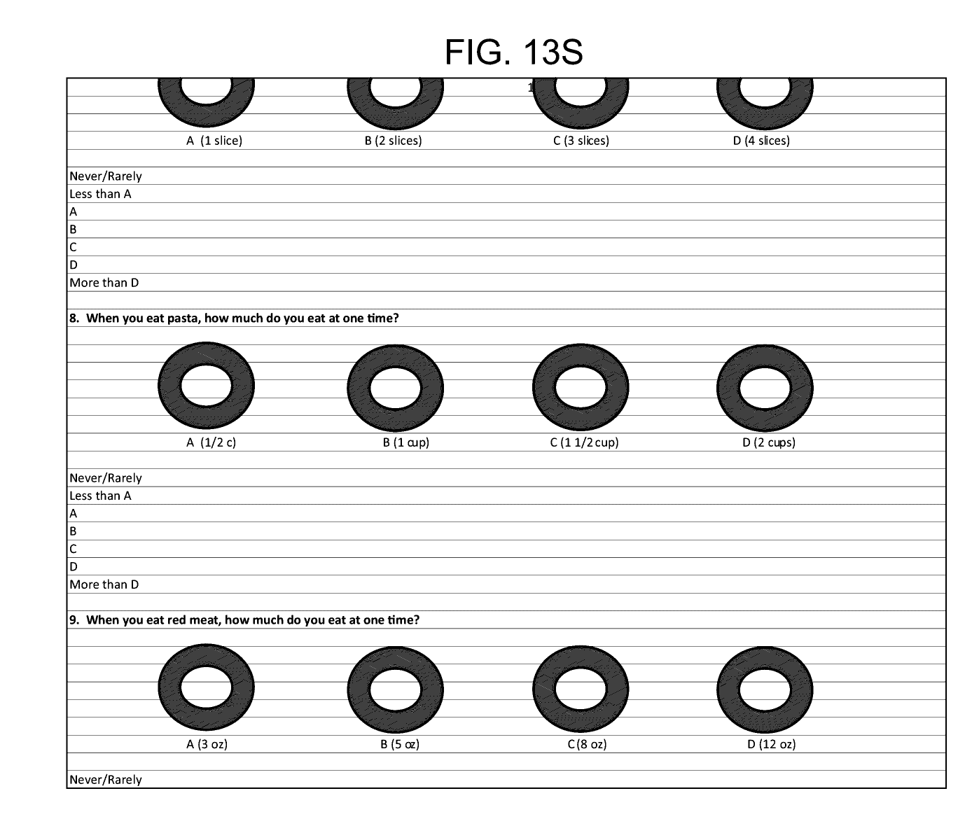

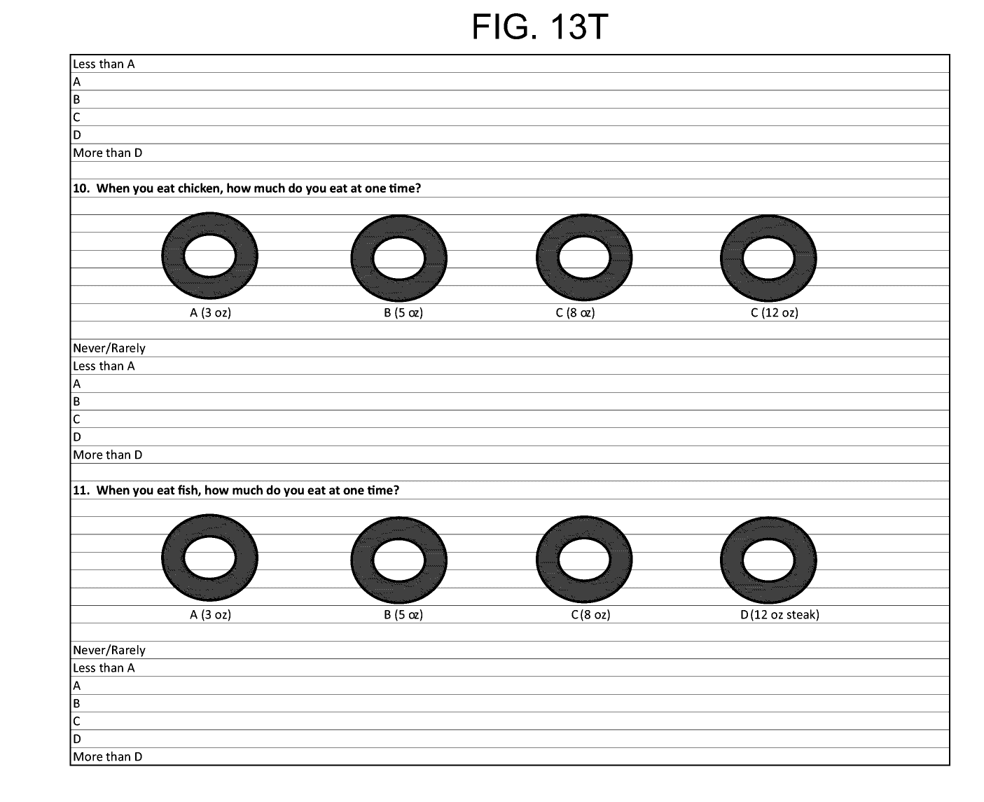

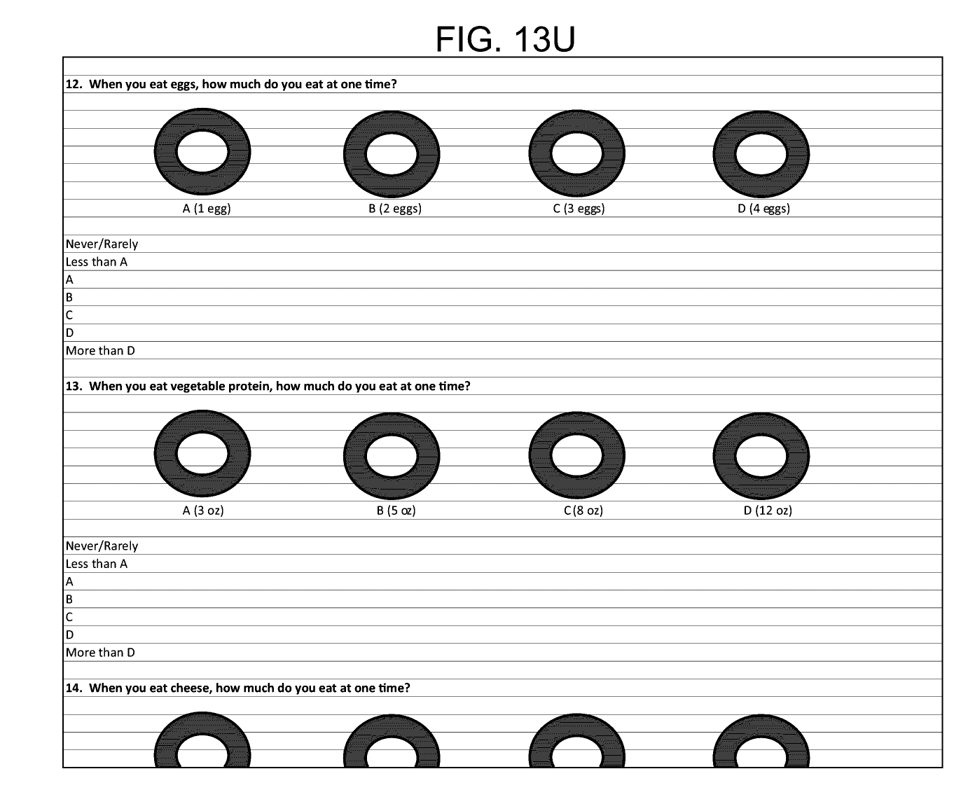

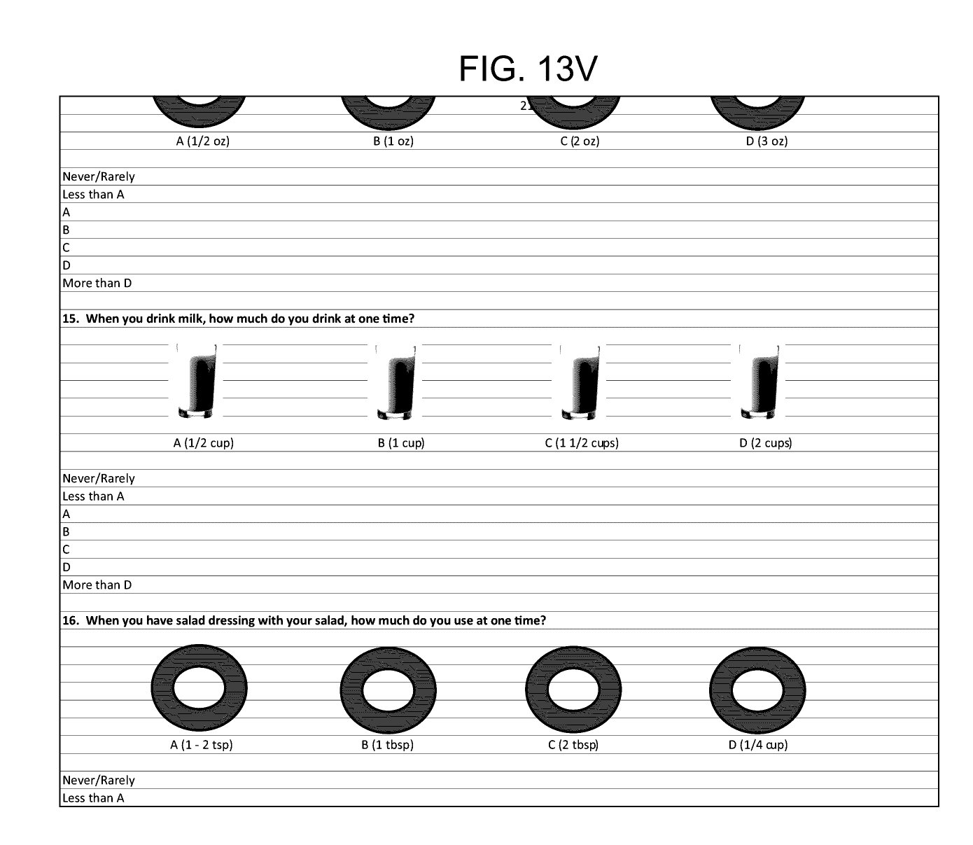

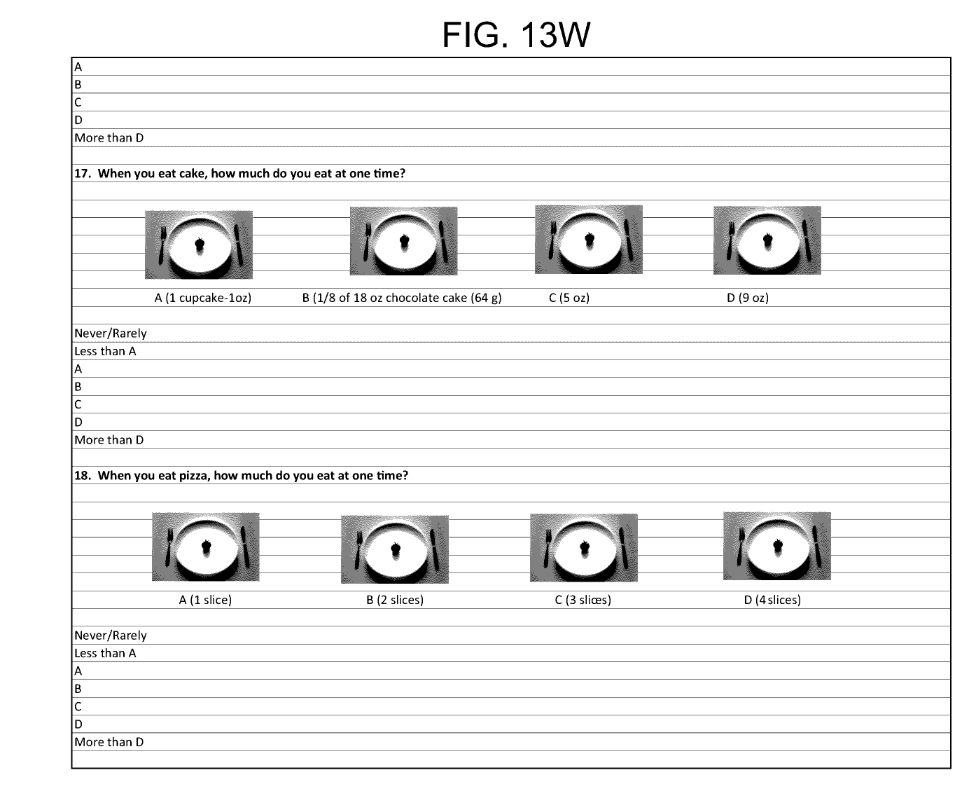

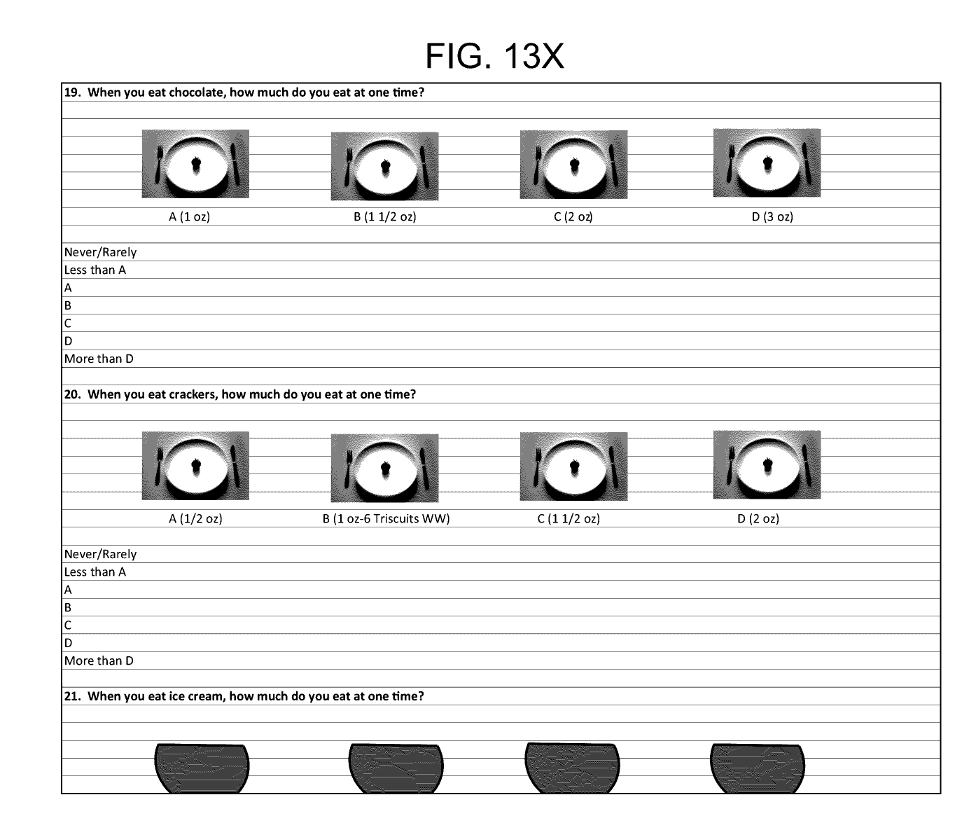

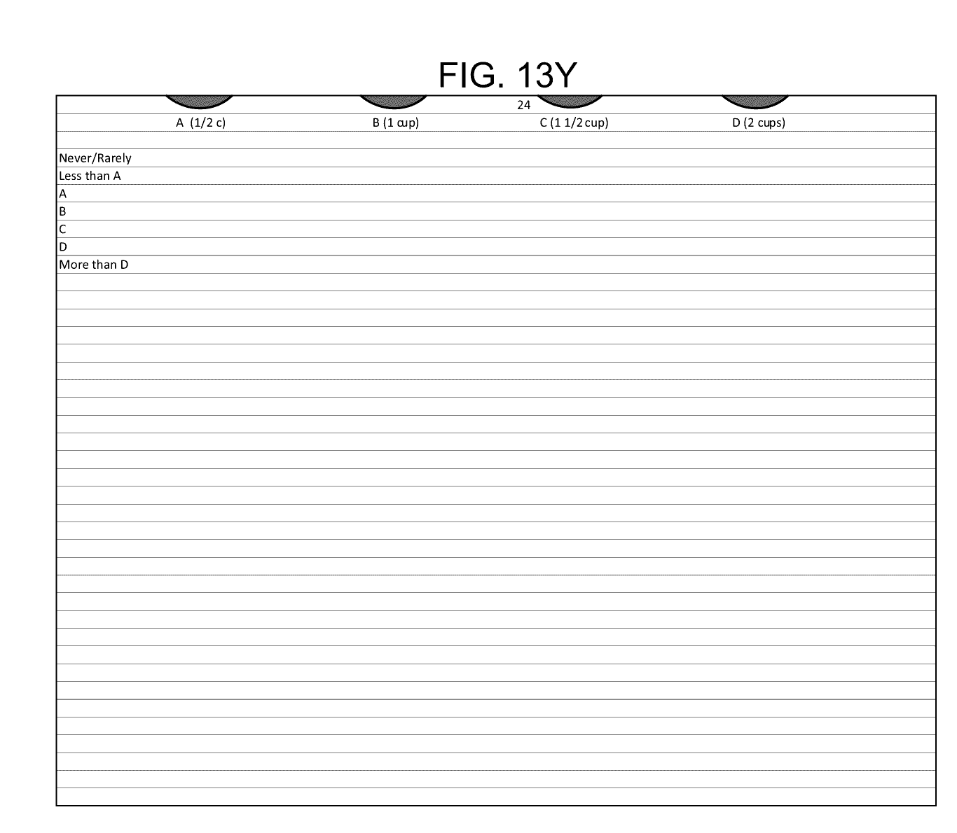

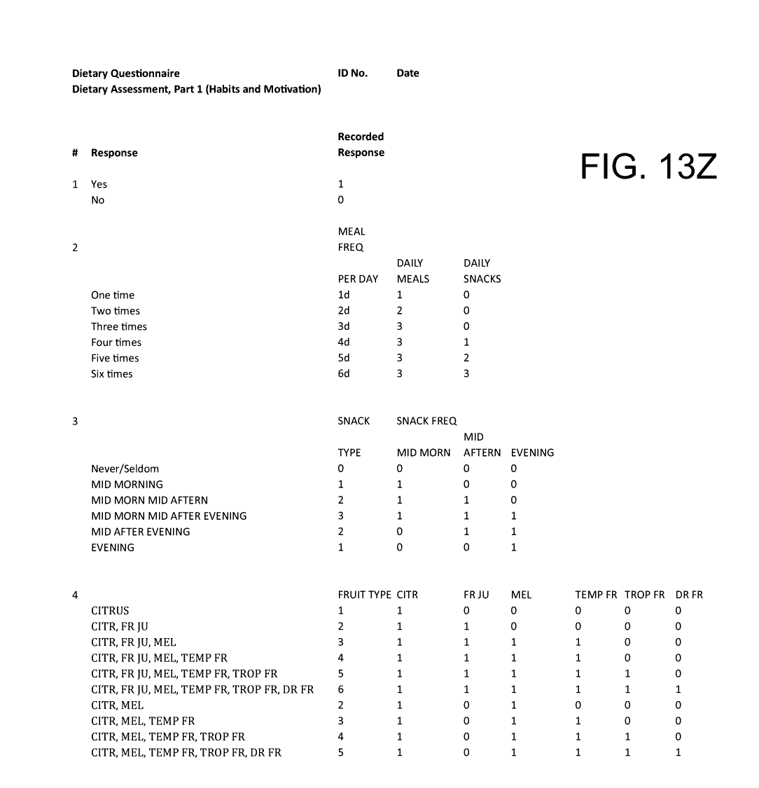

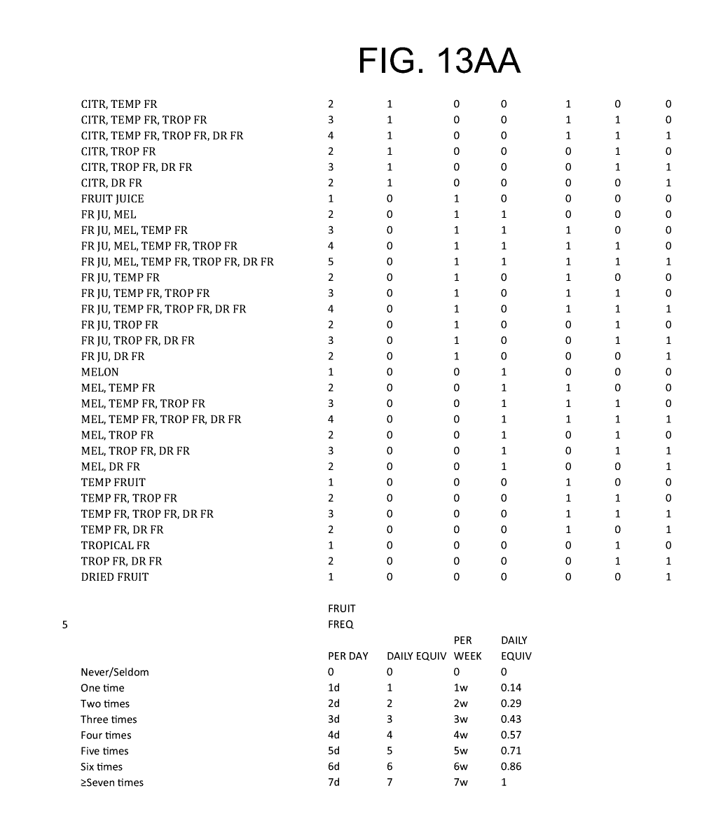

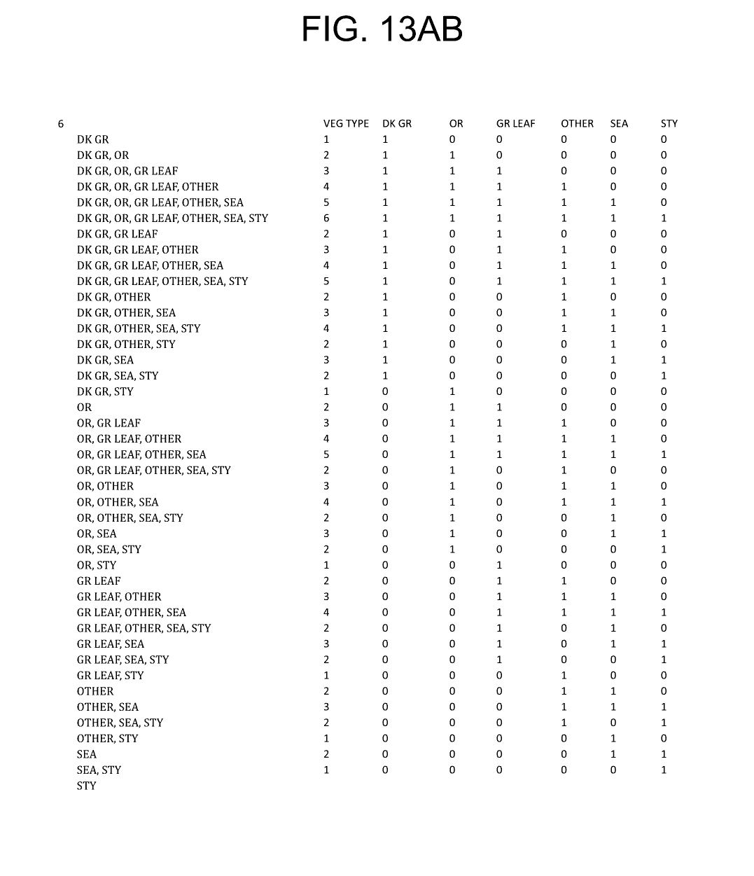

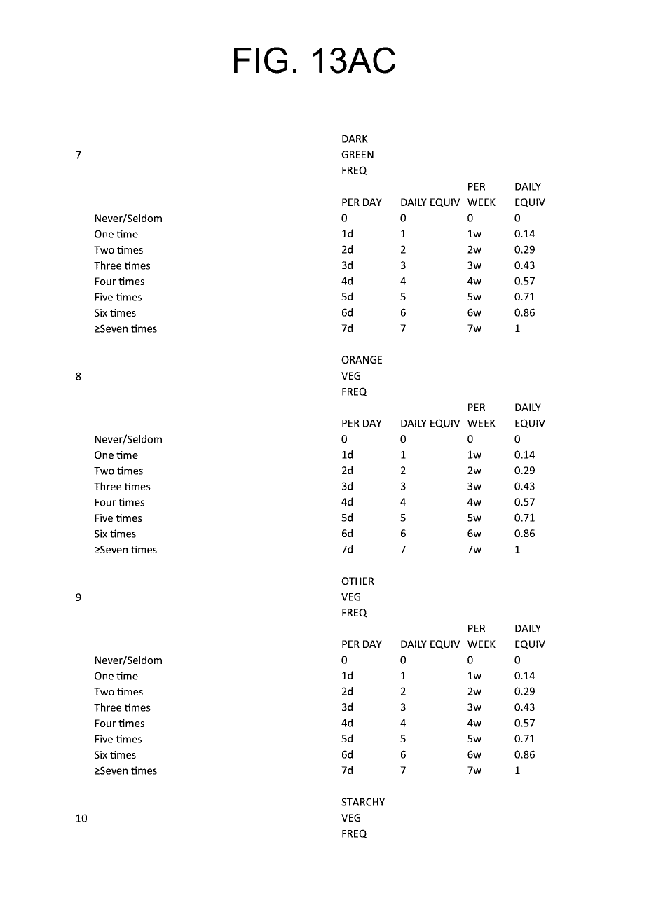

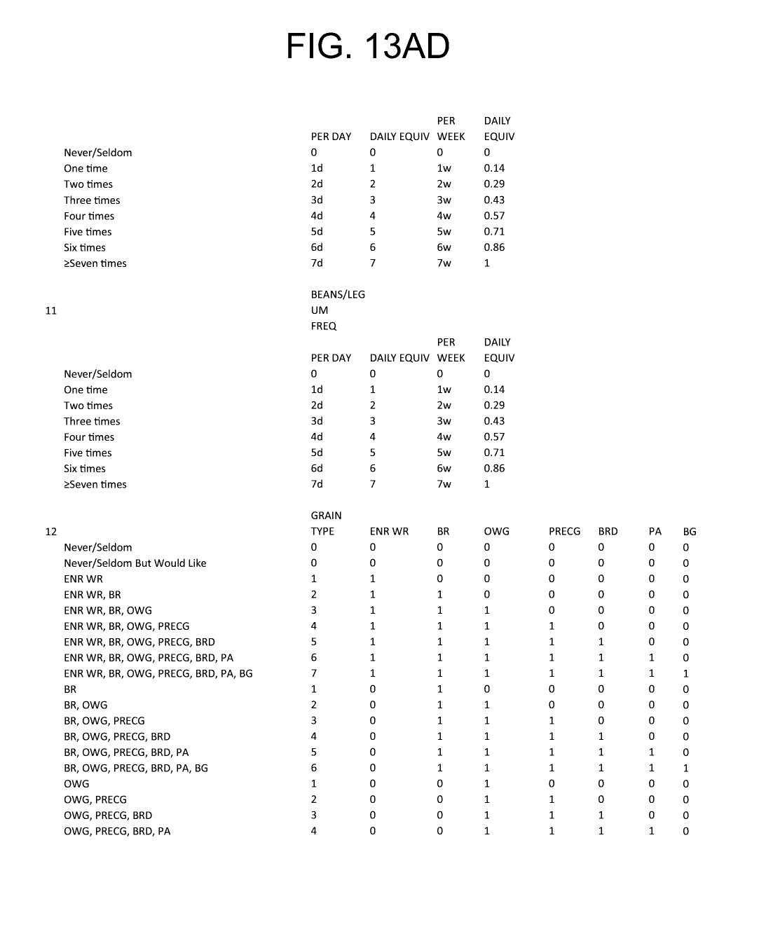

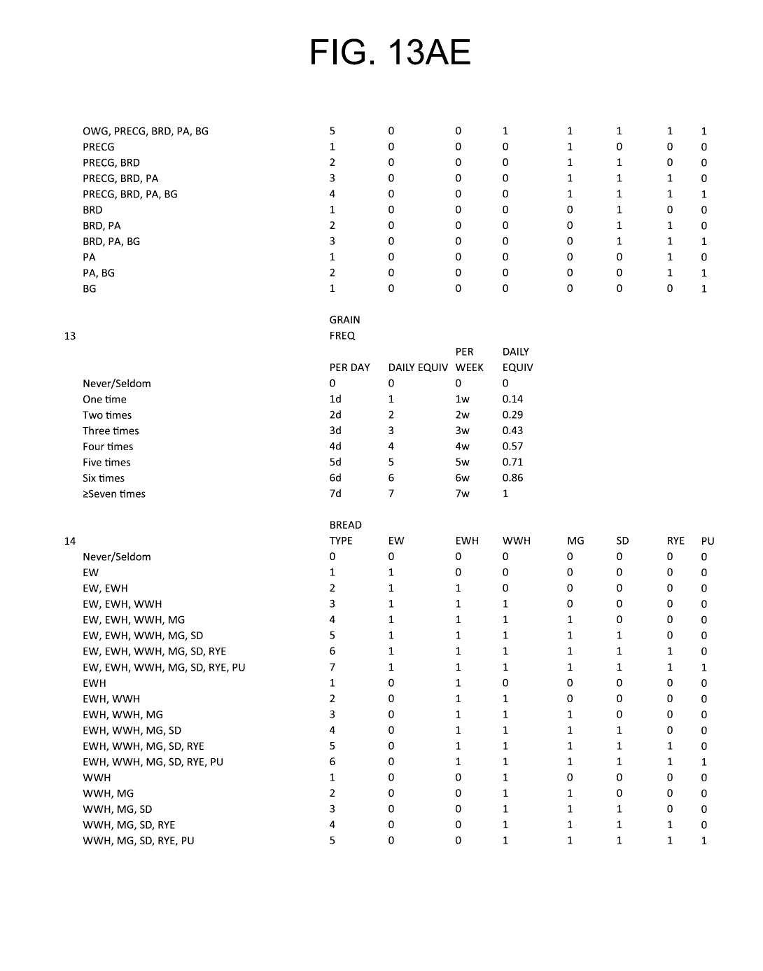

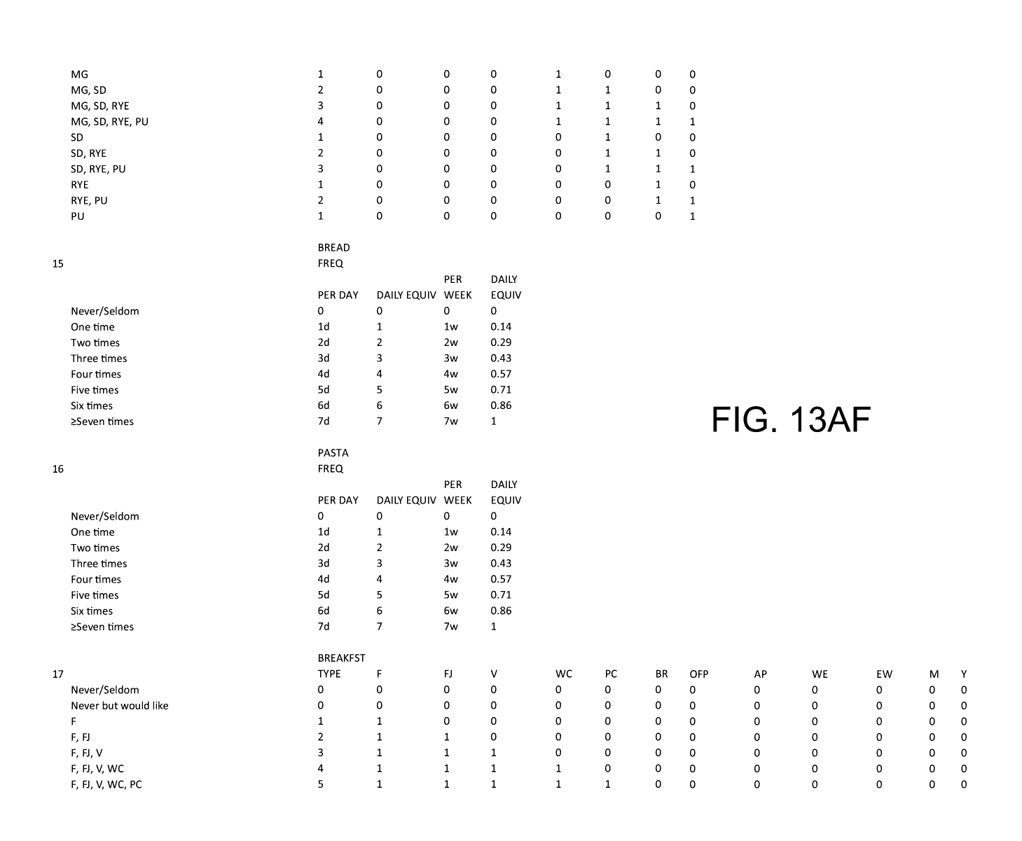

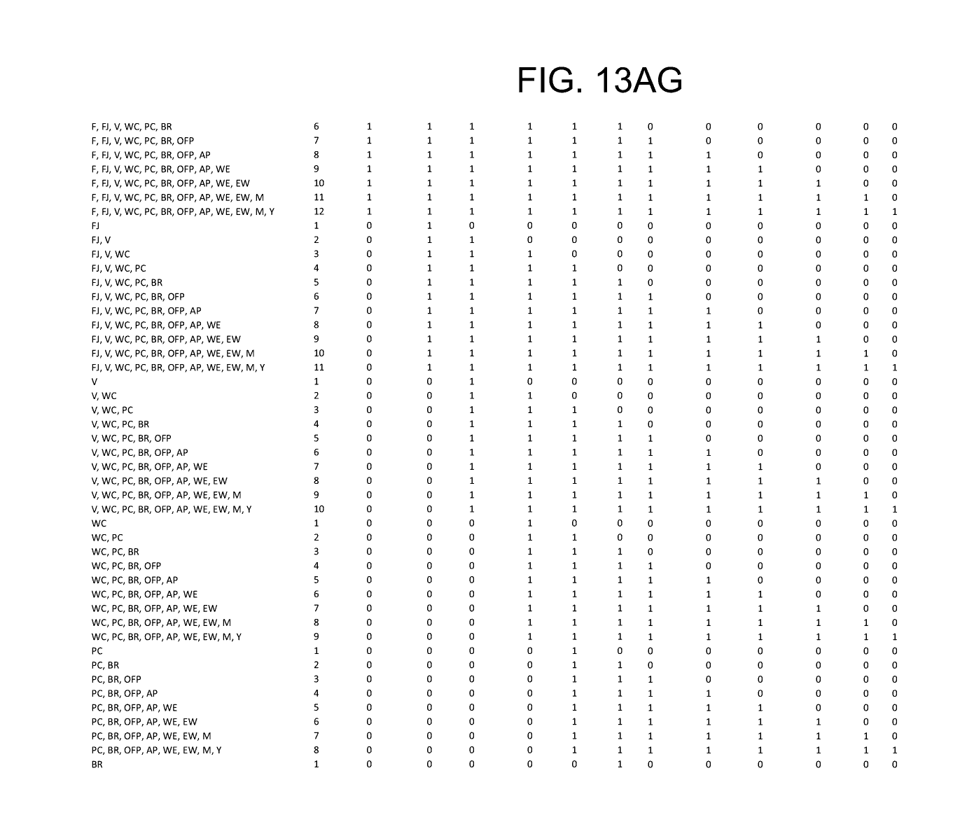

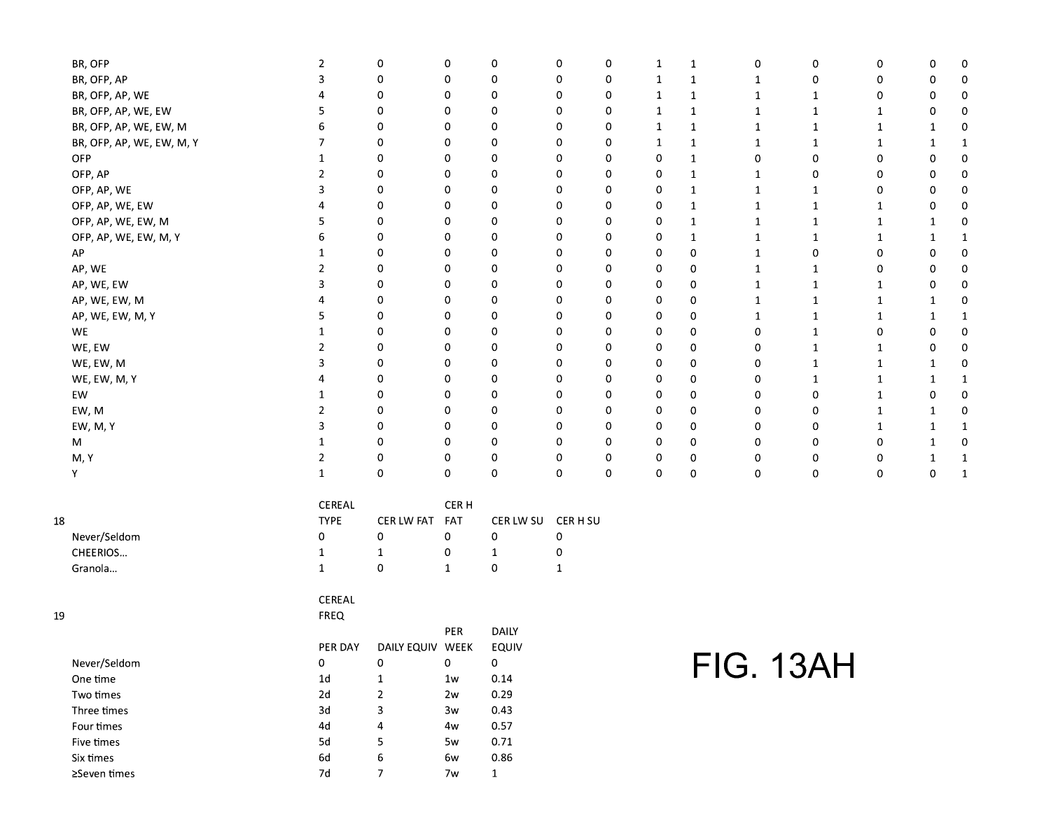

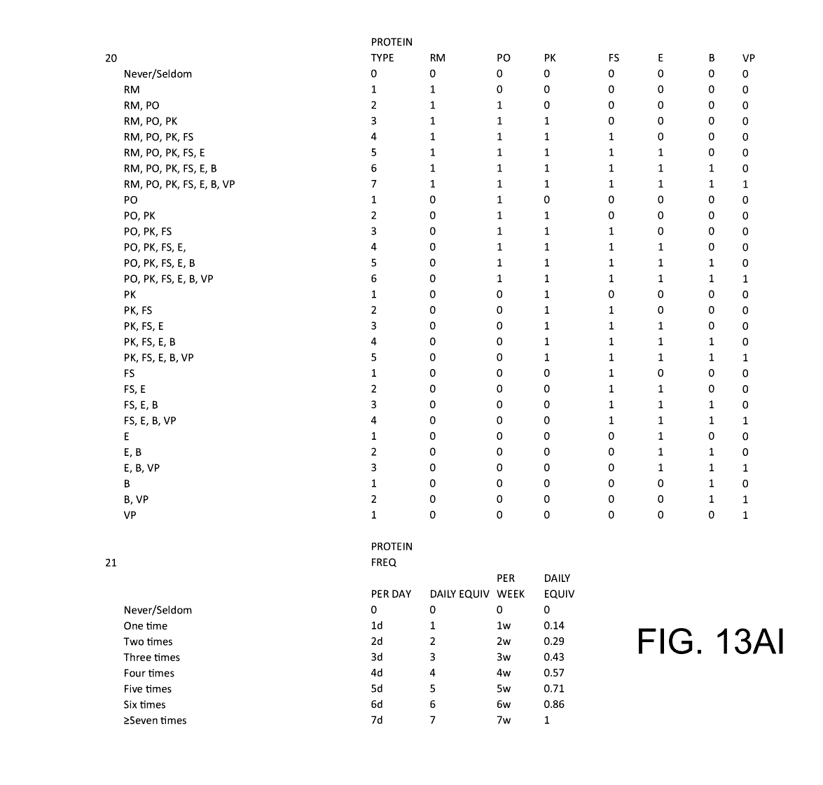

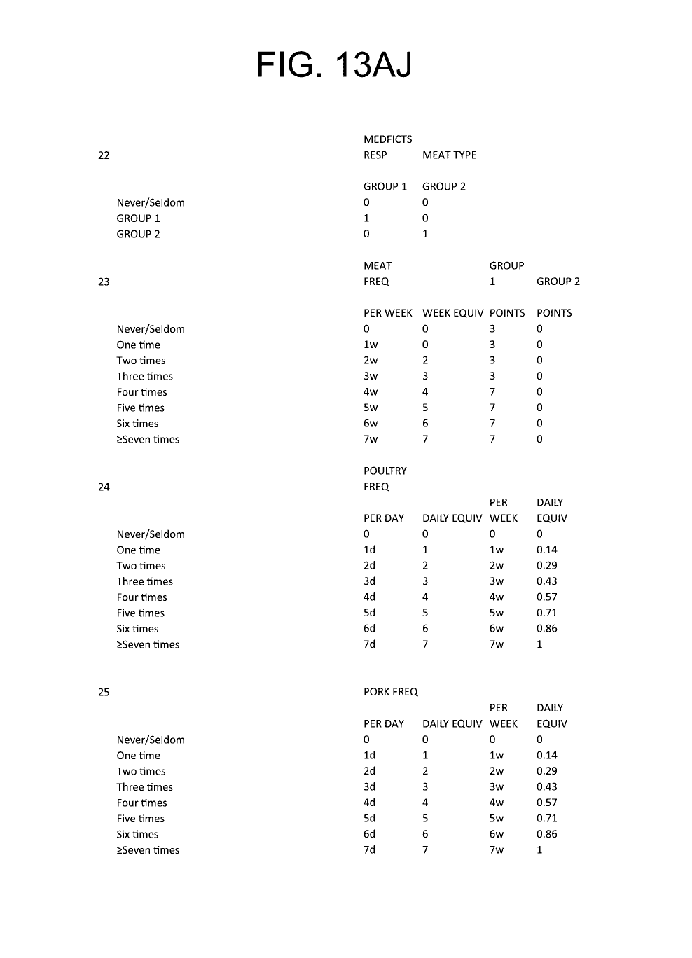

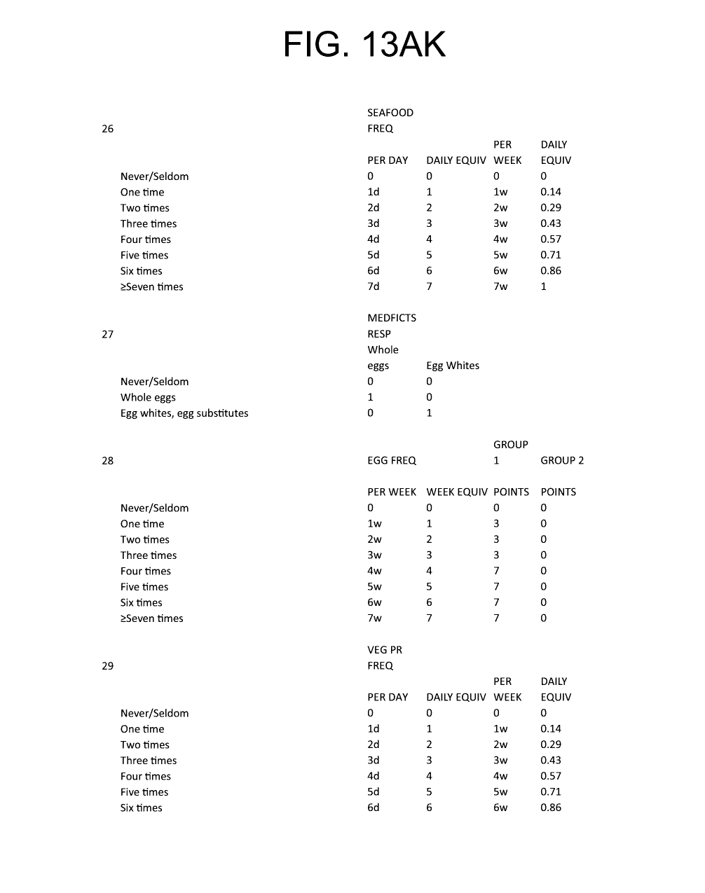

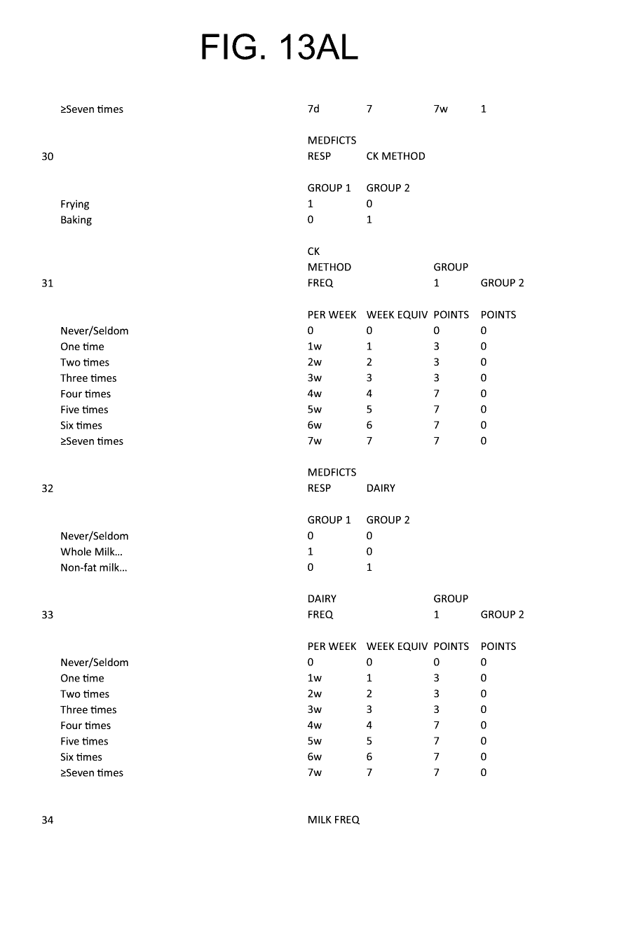

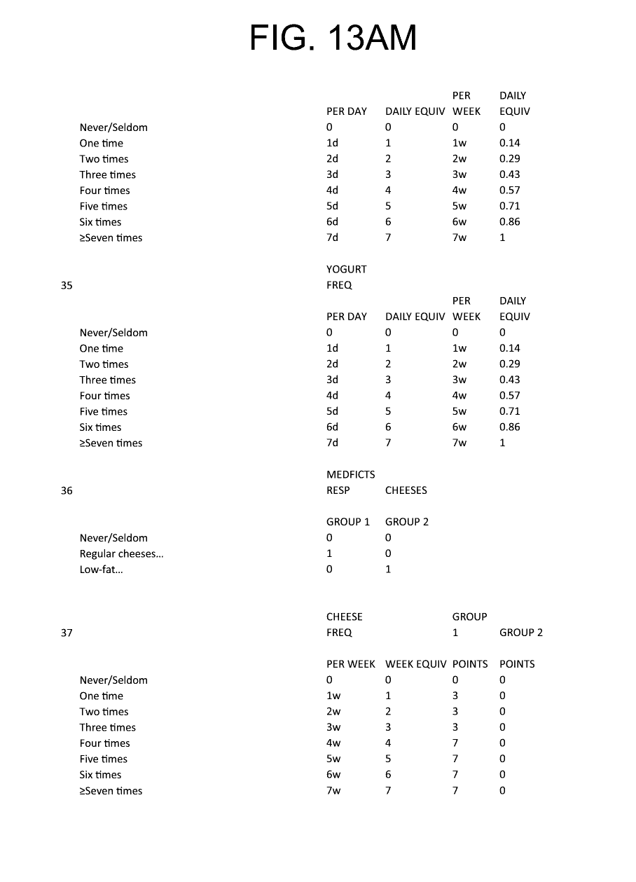

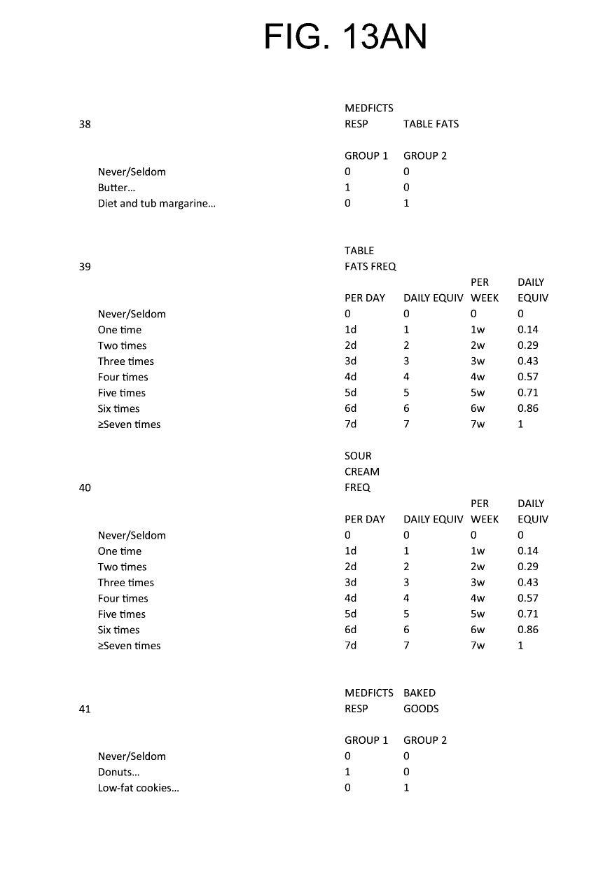

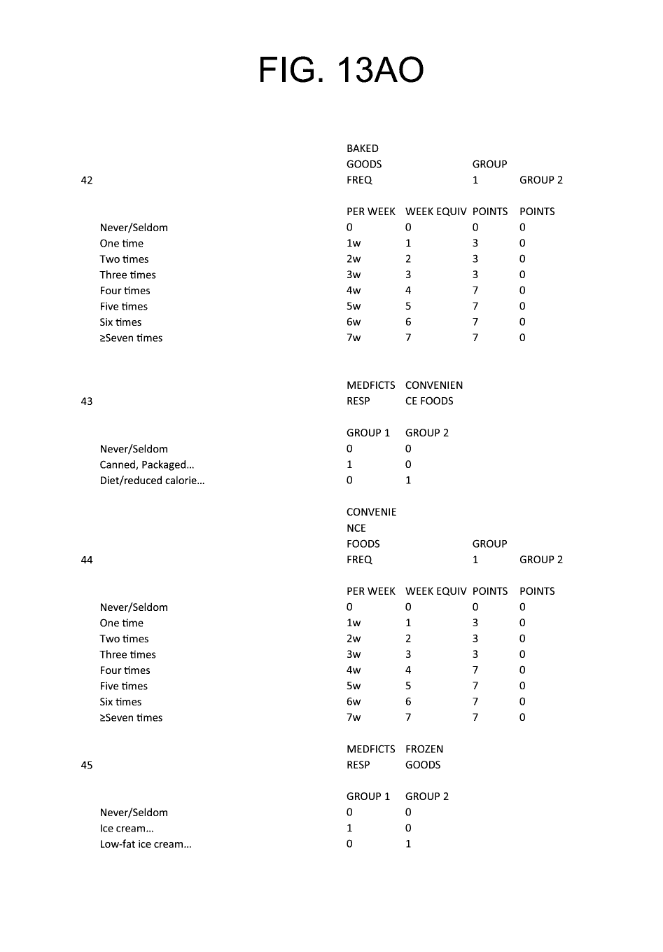

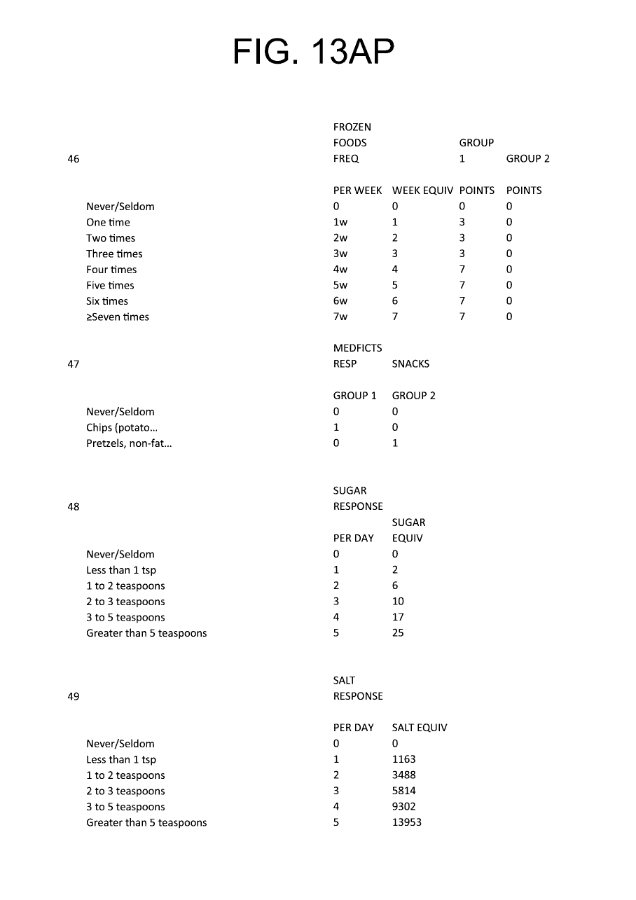

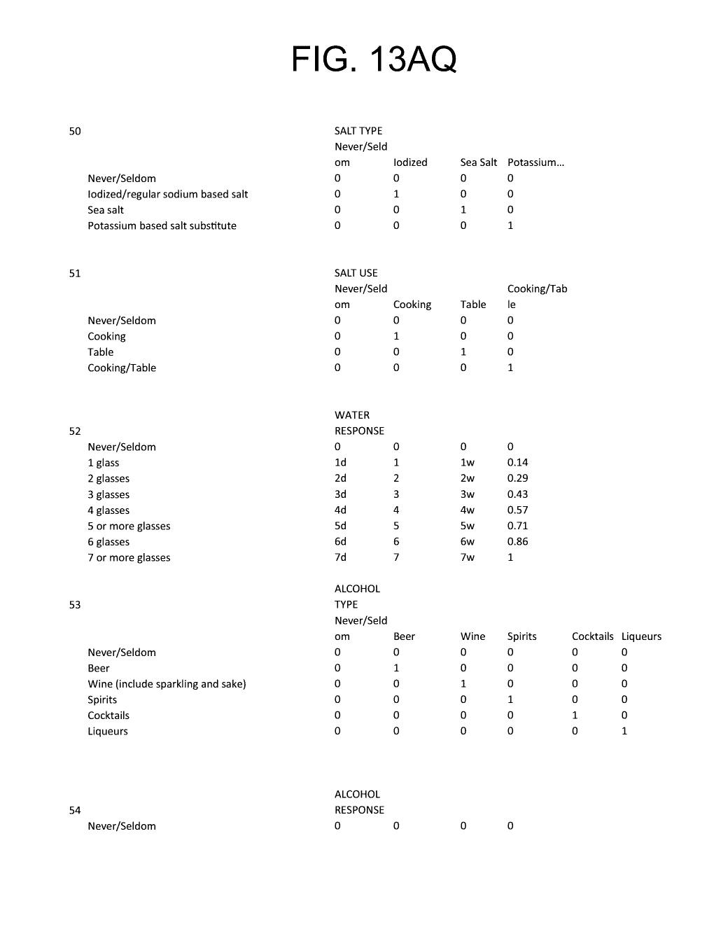

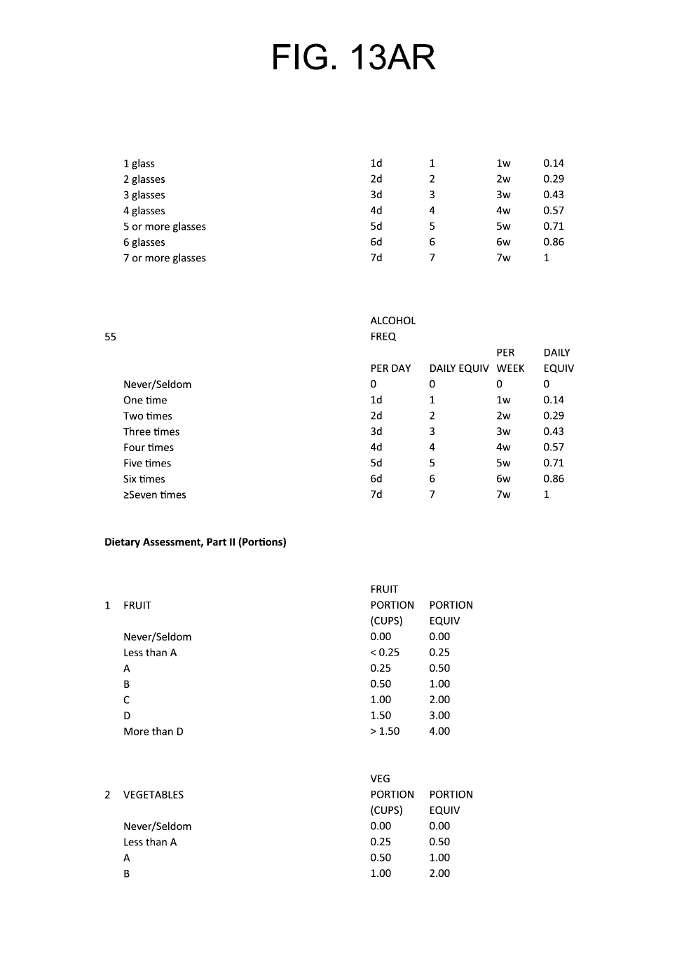

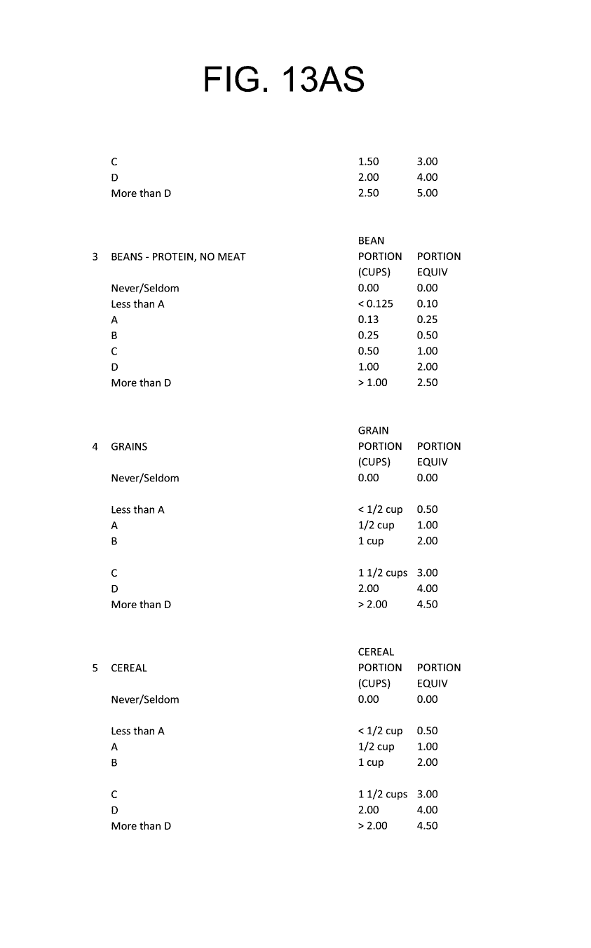

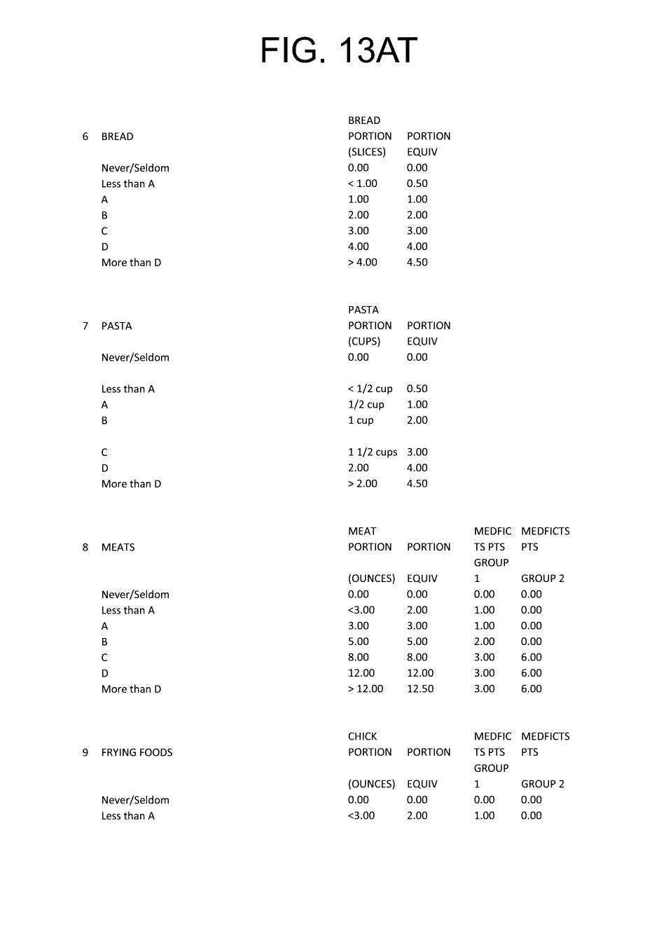

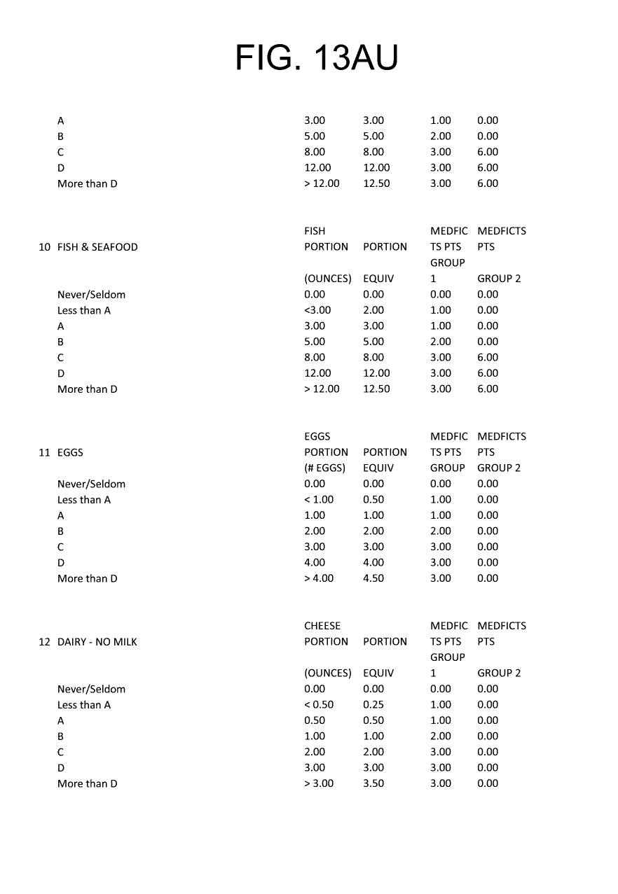

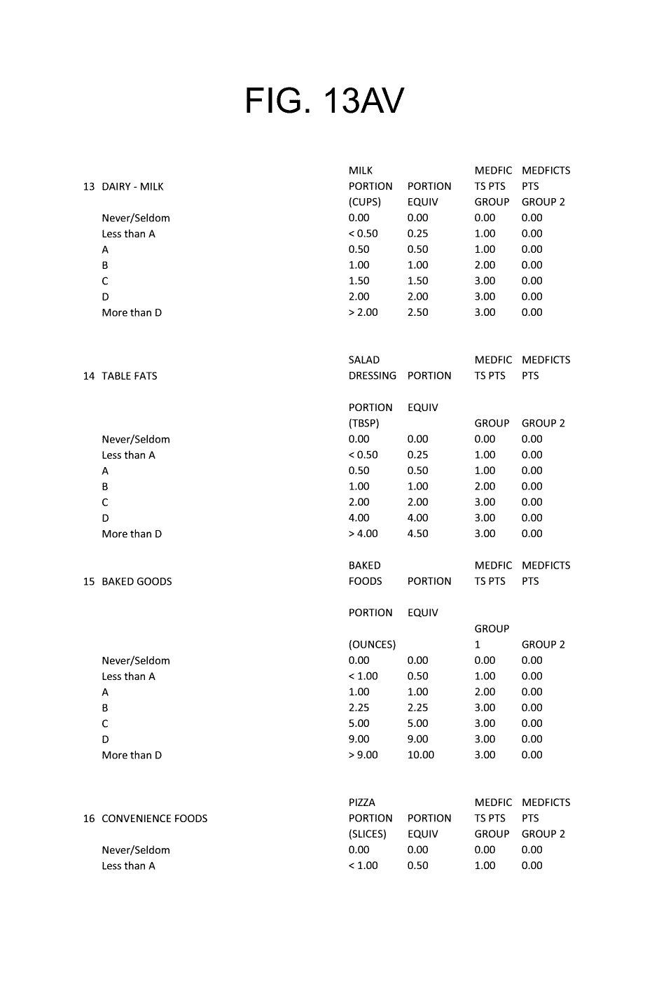

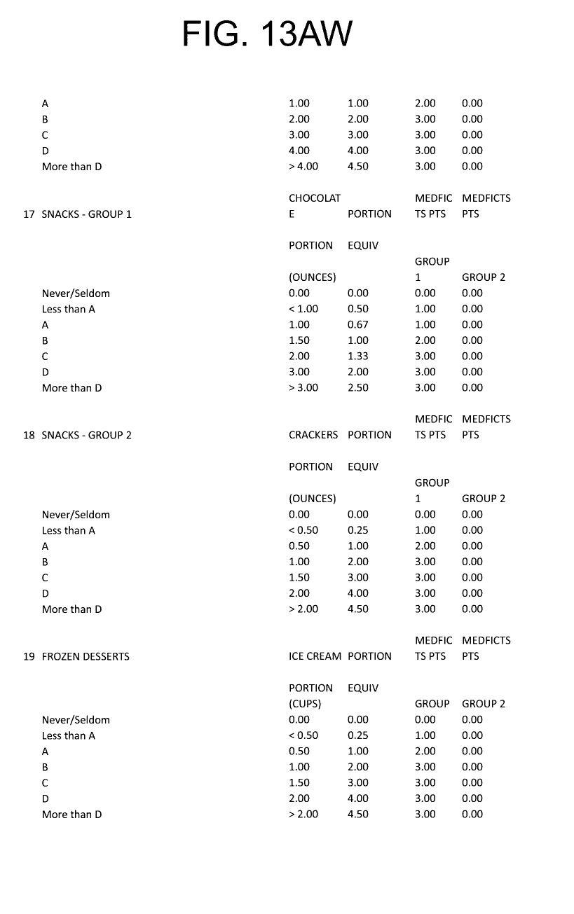

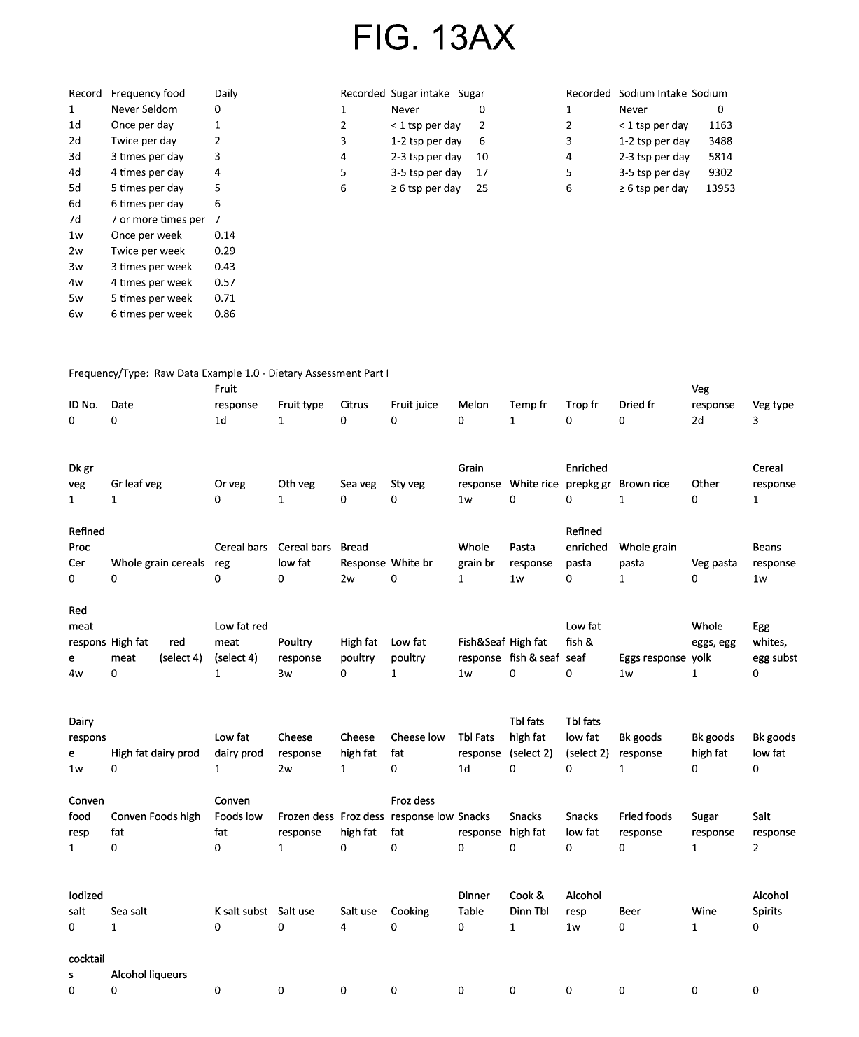

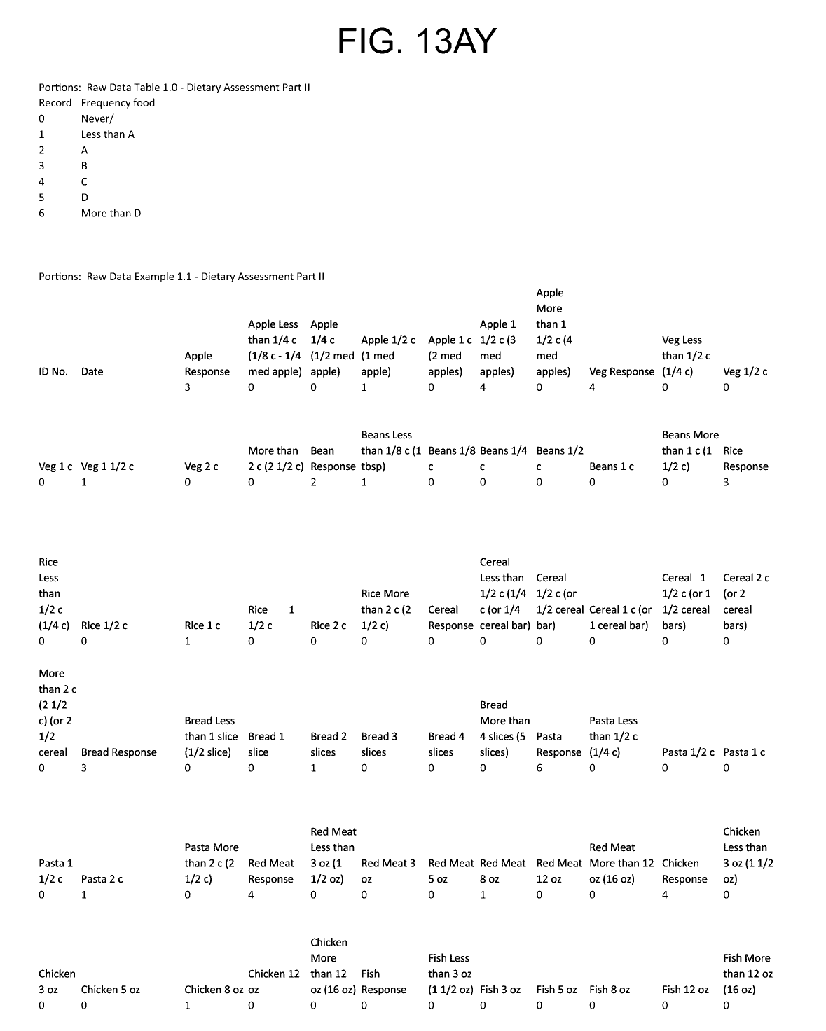

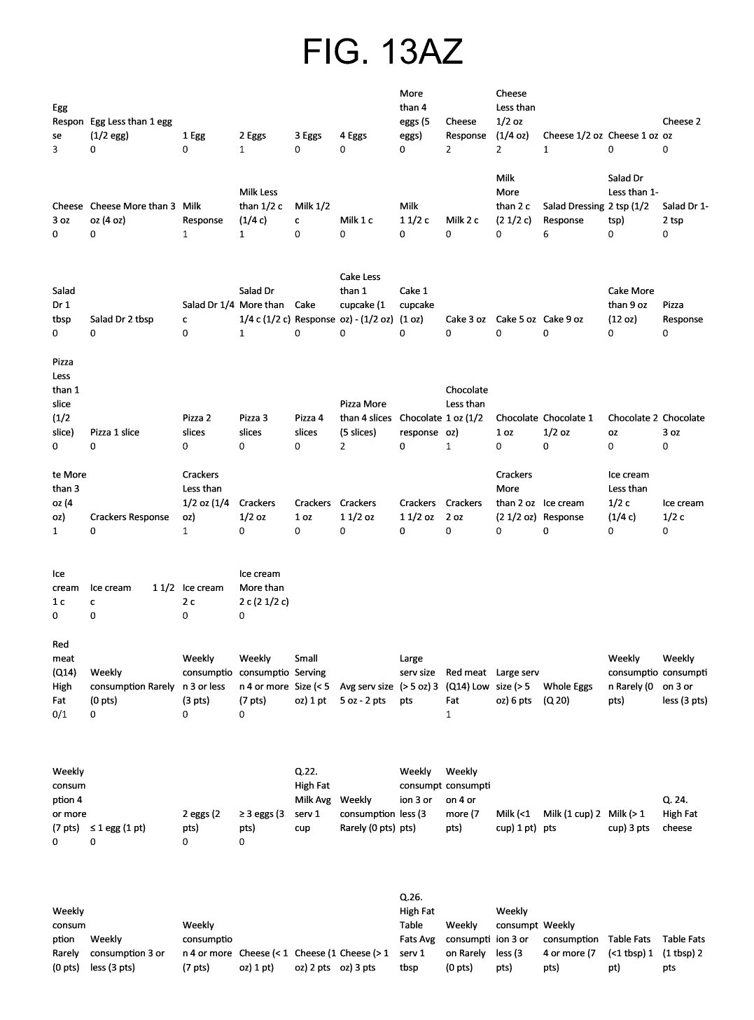

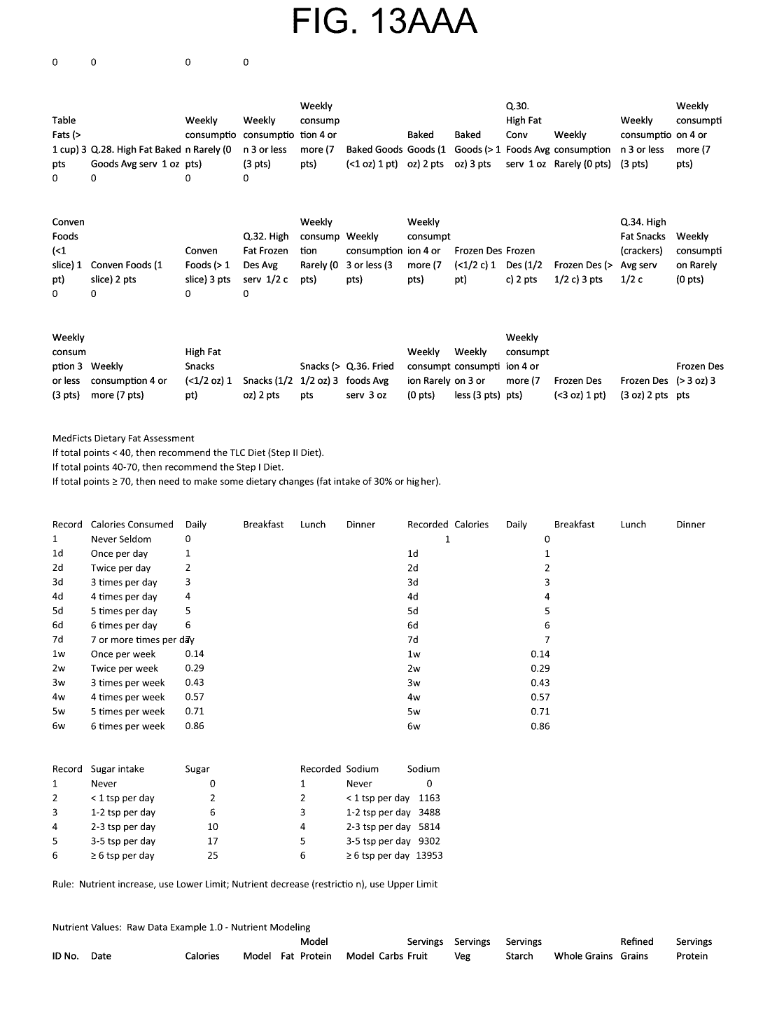

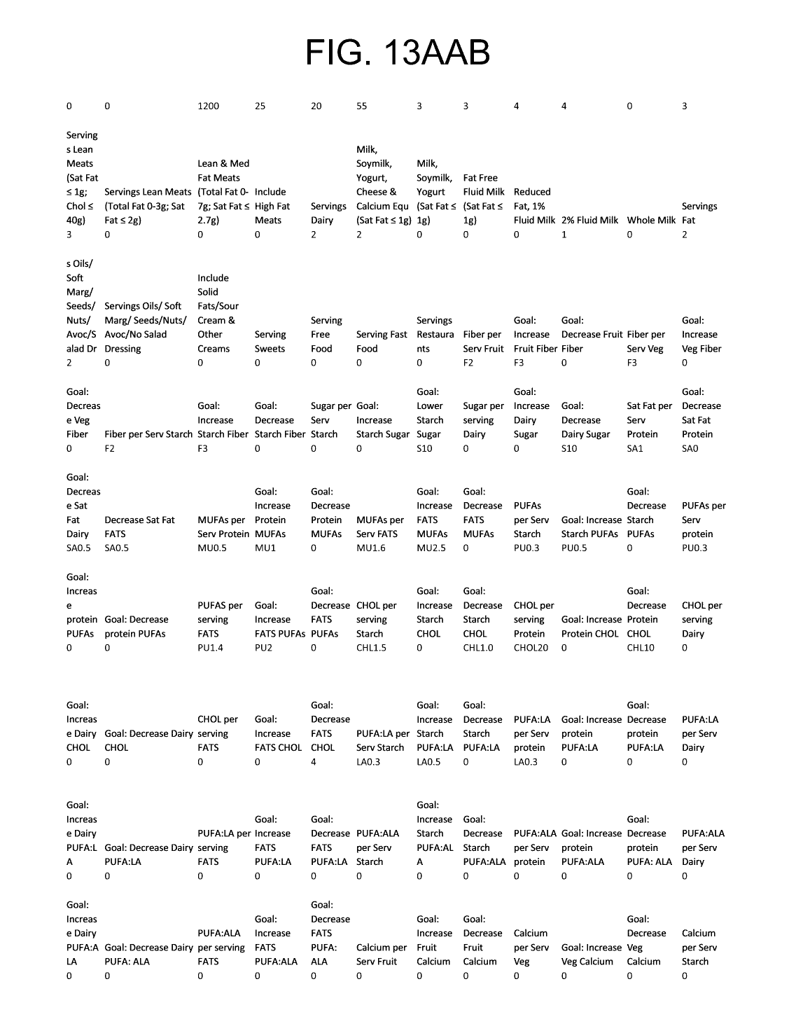

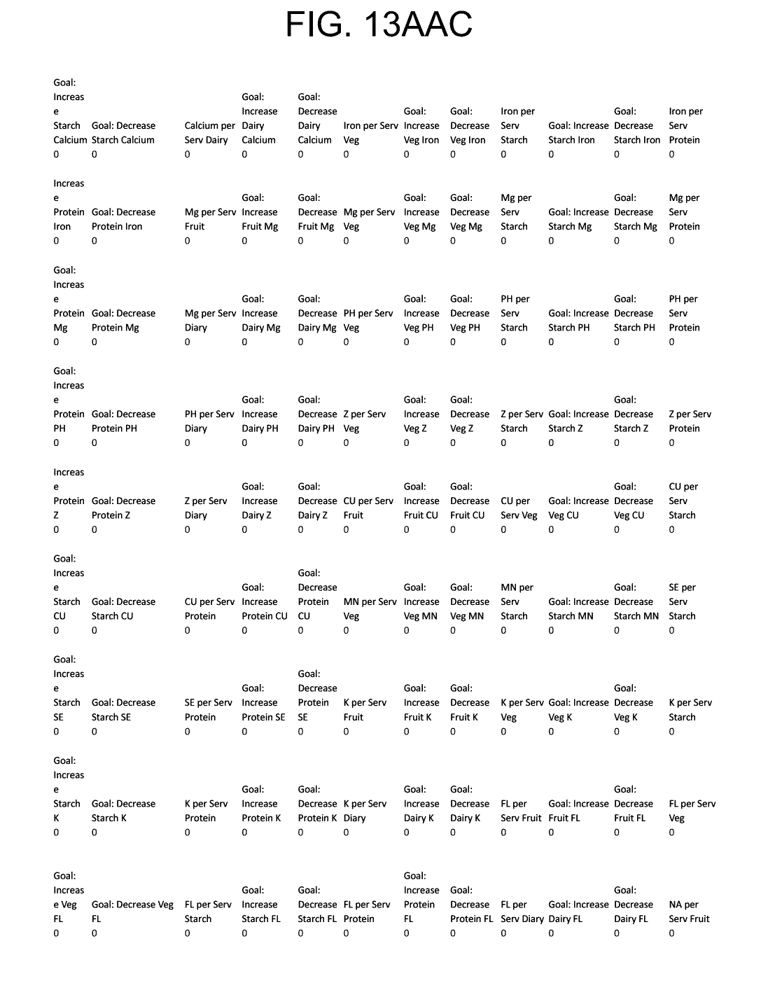

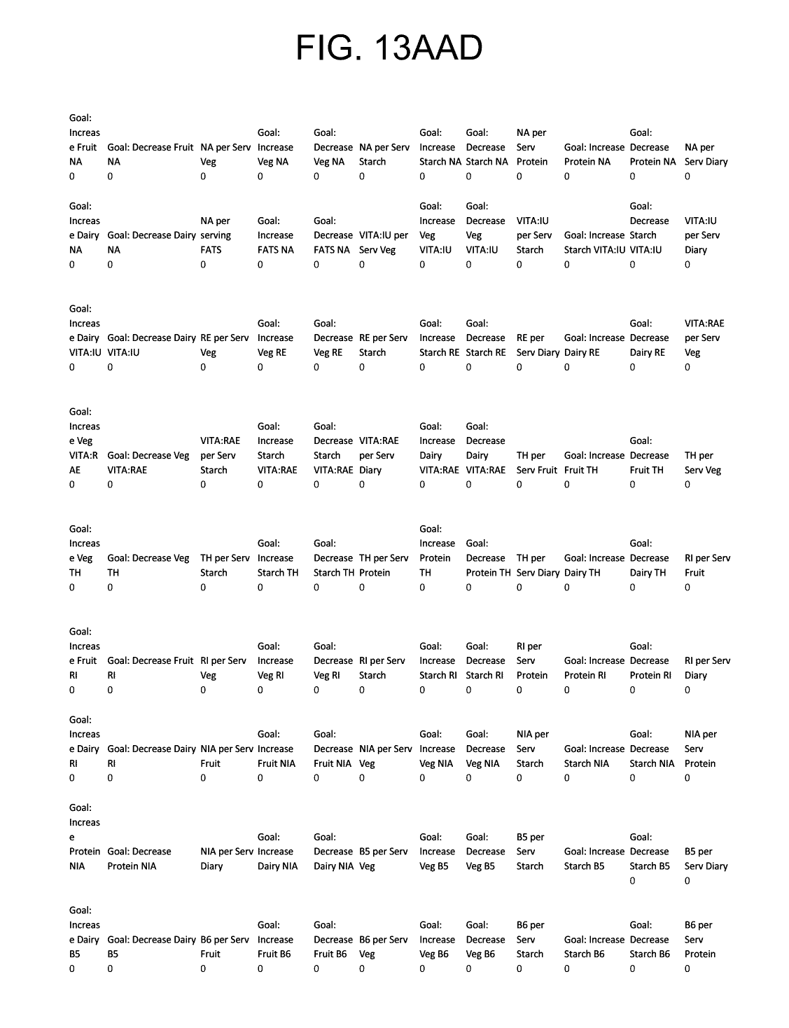

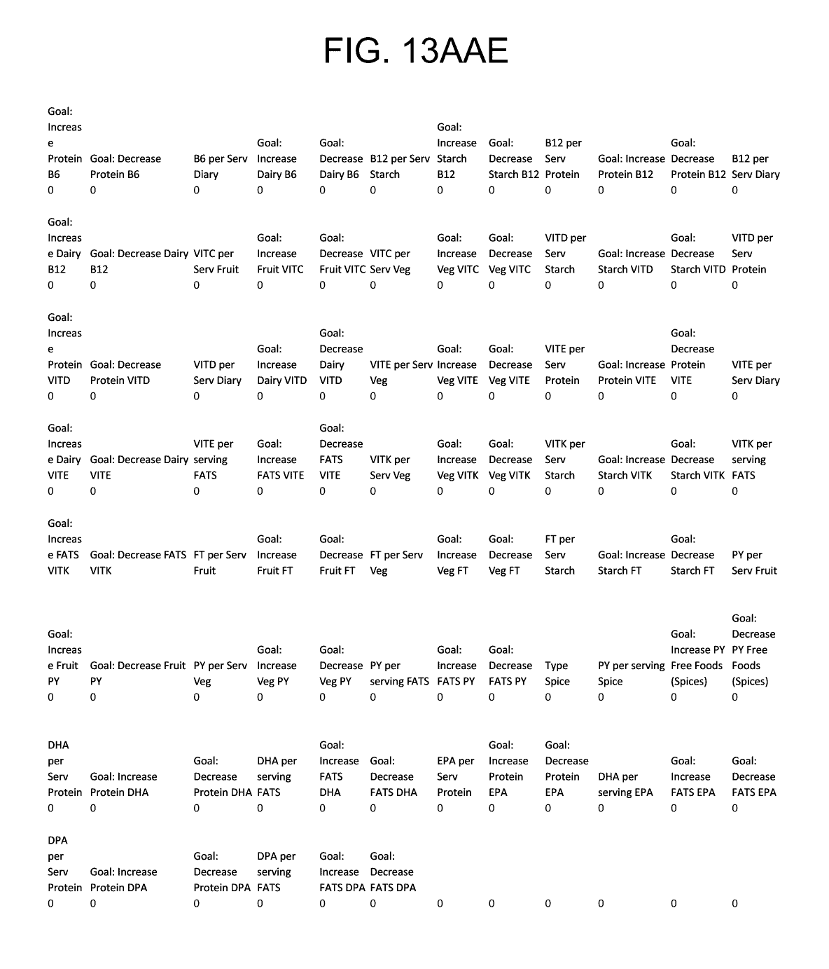

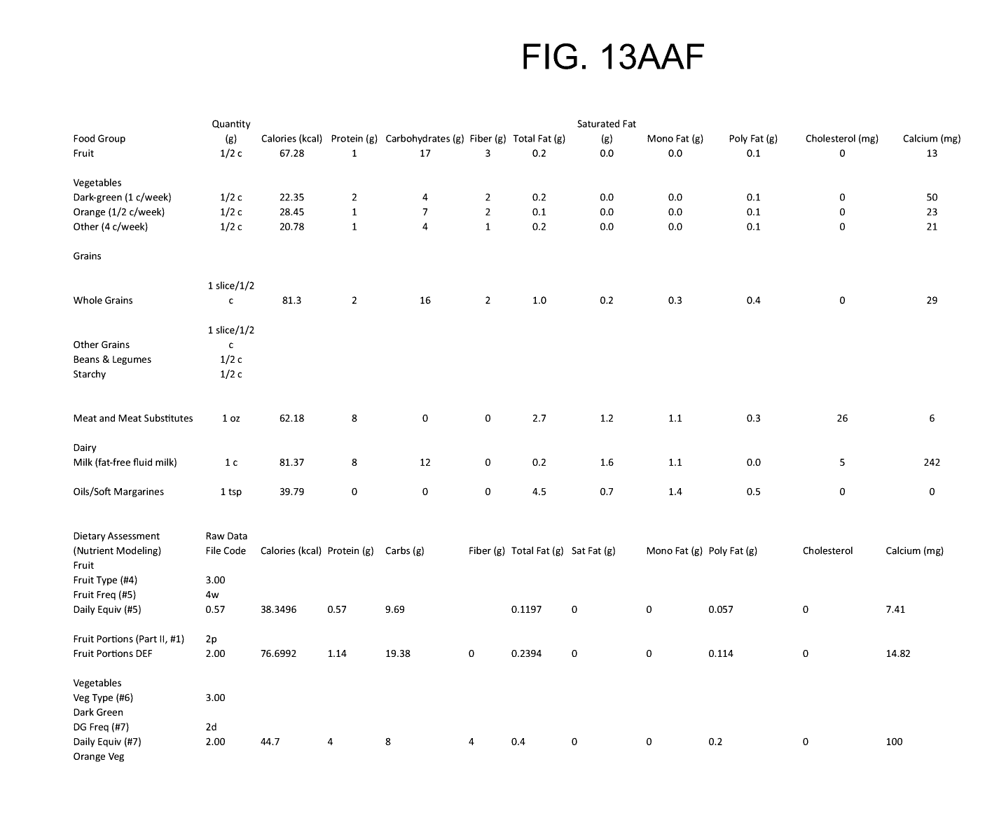

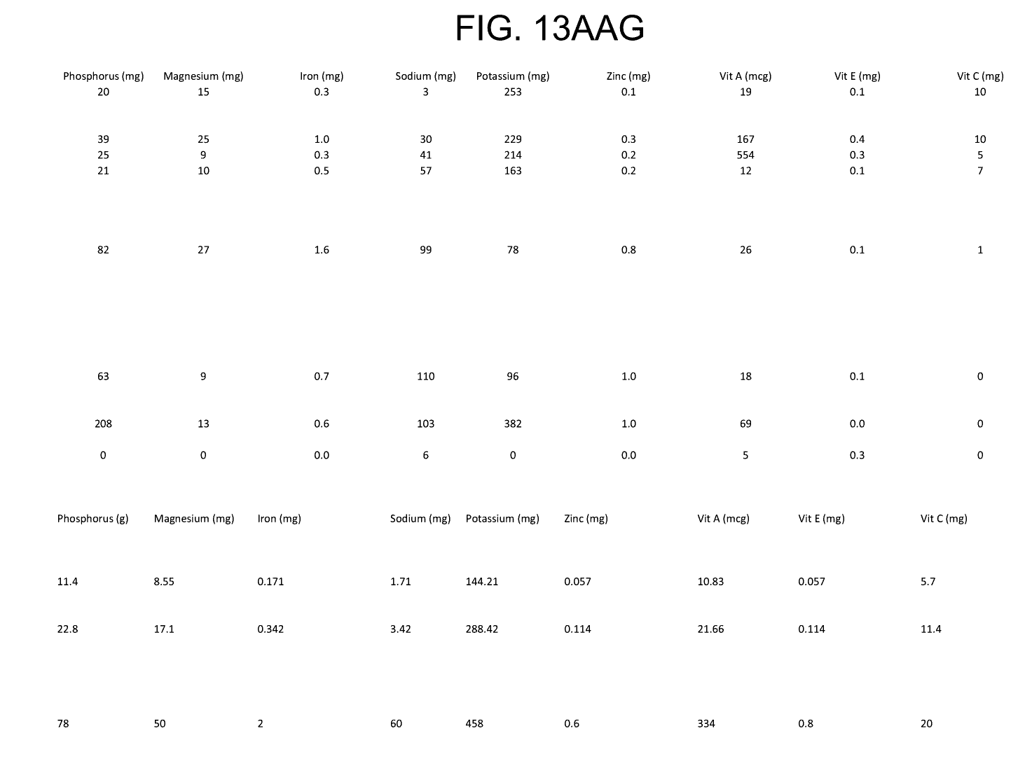

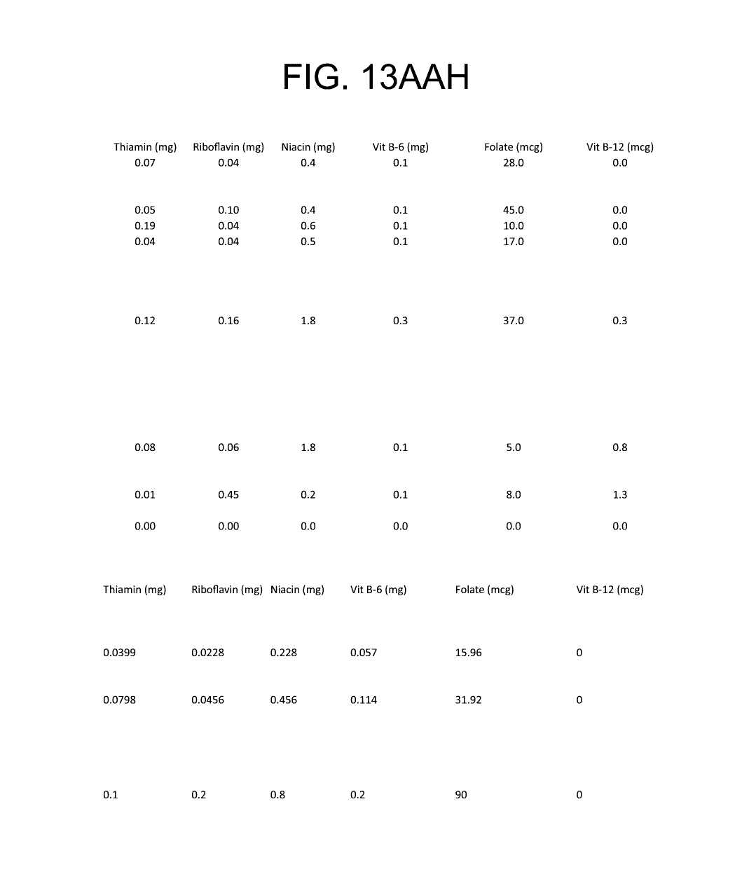

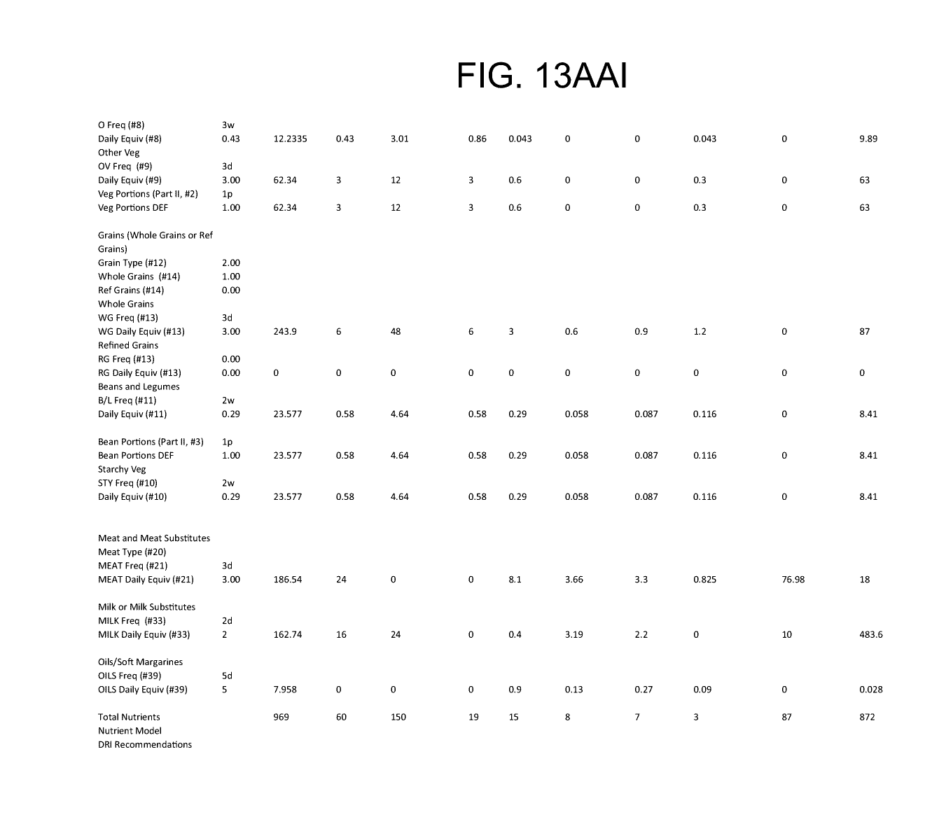

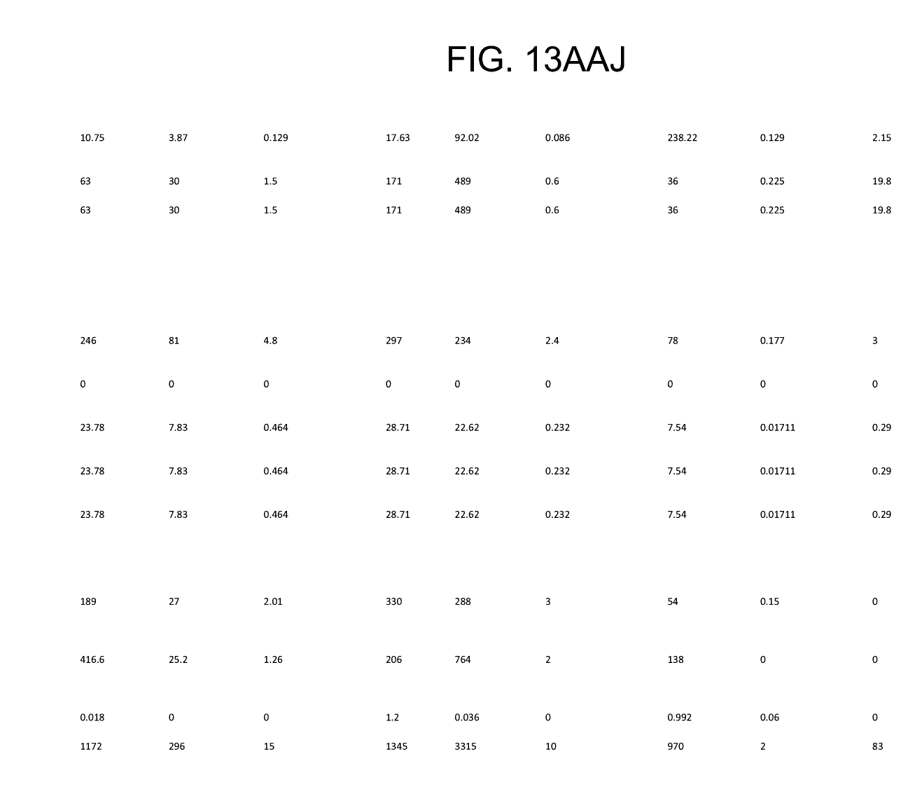

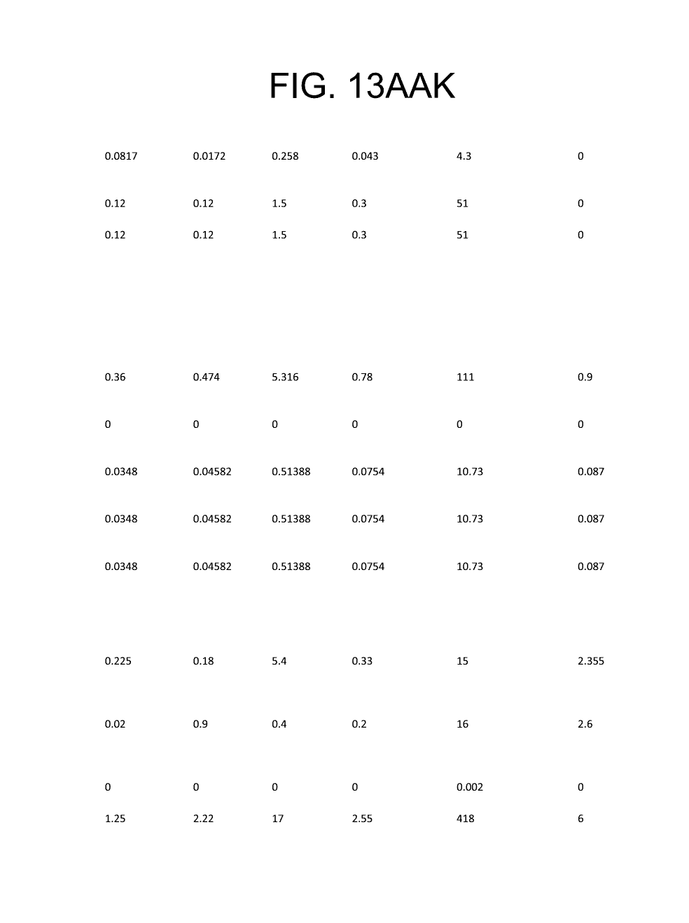

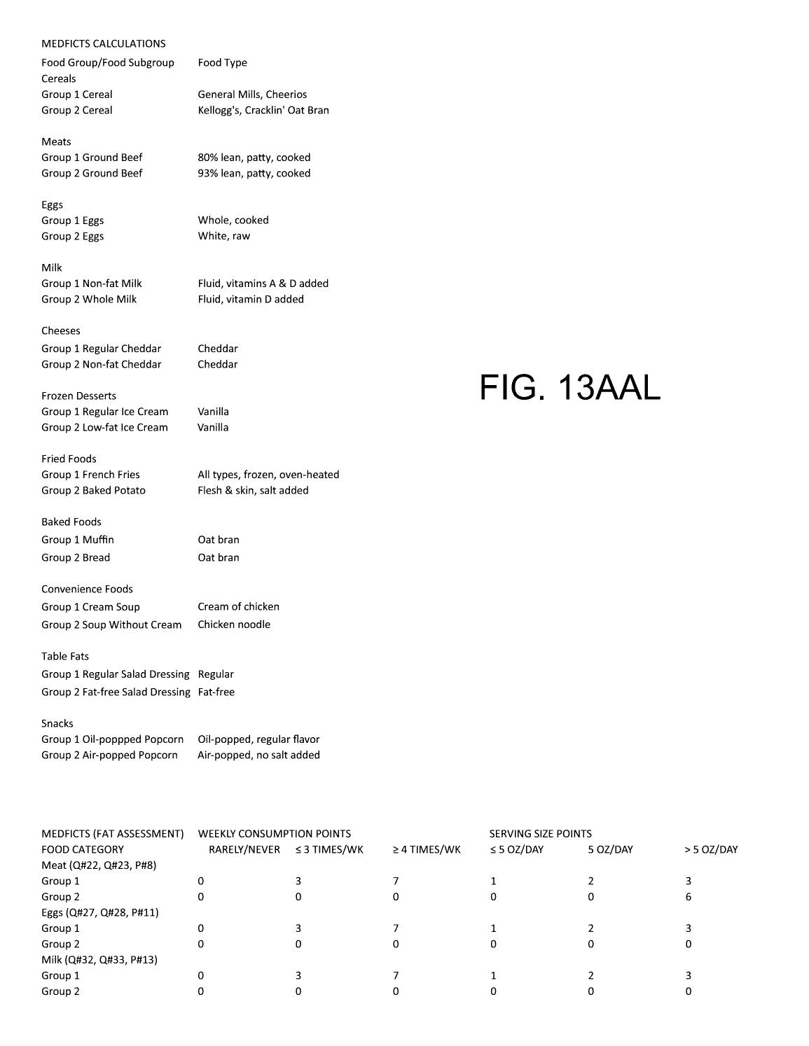

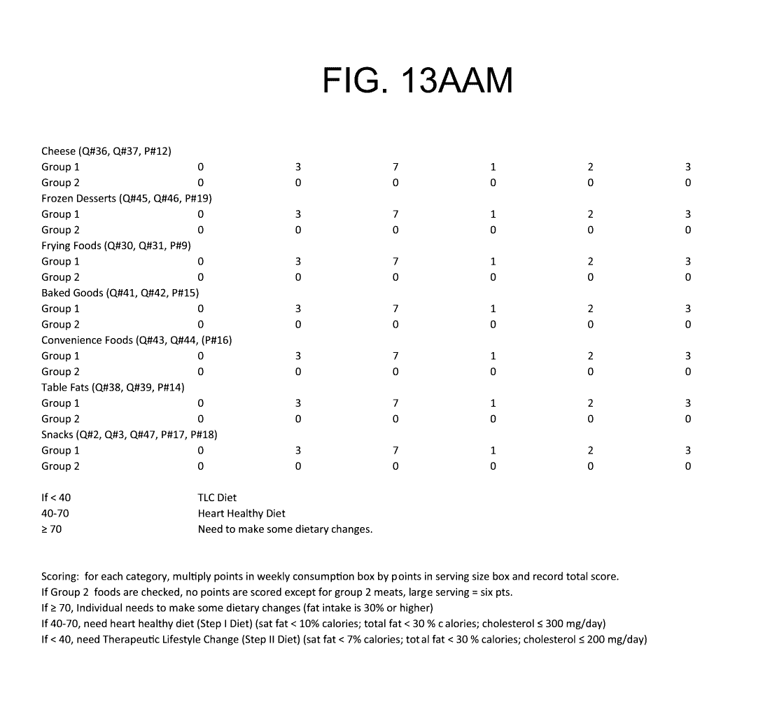

According to an embodiment of the present invention, an ‘Individual Dietary Medical Assessment’ (IDMA) provides an individual online subscriber with a discrete health report described in FIG. 13a based upon their specific answers as recorded through their use of a dietary assessment and the medical assessment.

The system and method according to an embodiment provide an online subscriber the opportunity to perform a unique health assessment in the form of a combined dietary and medical questionnaire. Using an expert system, the program delivers an immediate, scientific dietary analysis that emulates an individualized nutrition assessment as customarily conducted by a dietitian or nutritionist. The program then provides the online subscriber a robust and accurate nutrient analysis for an individual's current food intake patterns. The program also provides an online subscriber the ability to readily redefine dietary food patterns that are adapted to the subscriber's identified nutritional needs and individual food preferences.

### Dietary Questionnaire

In an embodiment, the nutrition section assesses the individual online subscriber's current nutrient intake. Reference is made to FIG. 13B-13Y that includes one input file, the Dietary Questionnaire. The dietary questionnaire contains questions on the overall frequency of consumption of fruits and vegetables, and questions of consumption of types of foods such as grains, cereals, bread, pasta, beans, and red meat that do not fit easily into the frequency format. These foods have been grouped into 19 categories: 1) fruits 2) vegetables 3) soups; 4) grains; 5) cereals & cereal bars; 6) bread; 7) pasta; 8) beans 9) red meat; 10) poultry; 11) fish & seafood; 12) eggs; 13) milk & yogurt; 14) cheeses; 15) table fats; 16) baked goods; 17) convenience or packaged foods; 18) frozen desserts; 19) snacks and other sections such as fried foods, sugar, and salt that do not easily fit into the “frequency” format. A separate set of questions covers intake of alcoholic beverages.

Certain foods such as sandwiches and salads are not listed the composition varies. The online subscriber answering the dietary questionnaire should consider the separate ingredients that make up certain of these foods and answer the questions as accurately as possible. For example, if the respondent ate a salad that included chicken once a week and a chicken sandwich once a week, the correct dietary questionnaire answer for chicken would be ‘2 times per week.’ Information obtained in the “portion” section of the questionnaire is necessary for accuracy of component sizes. Studies have shown that many individuals will more often have different ideas of the quantity of food she/he typically consumes.

The “portion” section of the Dietary Questionnaire contains photographs of measured portions for various foods used to visually represent a measured portion size in order to allow the subscriber to select portions that more closely reflect true portion sizes. The foods selected for visual display are representative of a certain food group, e.g., the apple represents the fruit group; vegetables represents the vegetable group; beans representing bean group; rice represents the starch group; cereal represents the cereal subgroup; bread represents the bread subgroup; pasta represents the pasta subgroup; beef represents the red meat group; chicken represents the poultry group; fish represents the fish & seafood group; eggs represent the egg group; cheese represents the cheese group; milk represents the milk & yogurt group; regular salad dressing represents the table fats group; cake represents the baked goods group, pizza represents the convenience or packaged foods group; ice cream represents the frozen desserts group; both crackers and chocolate represent the snacks food group. The assumption is that if an individual does not eat either crackers or chocolate, then the section will be not be covered; if an online subscriber chooses both groups, then they need to select the food response that represents the highest portion typically consumed.

In an embodiment, representative foods for each food group or food subgroup and standard component sizes are as follows: 1. Fruit food group: ½ cup or 1 apple; 2. Vegetable food group: ½ cup; (3) Starch food group: beans: ½ cup; rice: ½ cup; cereal: 1 cup; bread: 1 slice; pasta: ½ cup; 4. Meat and meat substitutes food groups: red meat: 3 oz.; chicken: 3 oz.; fish and seafood: 3 oz.; eggs: 1 egg; 5. Dairy food group: milk: 1 cup, cheese 1 oz.; and 6. Fats food group: salad dressing: 1 tbsp.

Representative foods for questions asking the subscriber to choose the group of foods that she/he consumes most often are as follows: Meats: Group 1: ground beef 80%, 3 oz. patty, Group 2: ground beef 93%, 3 oz. patty; Eggs: Group 1: 1 whole egg, Group 2: 1 egg white; Dairy: Group 1: 1 cup whole milk, Group 2: 1 cup non-fat milk; Frozen Desserts: Group 1: ½ cup regular ice cream, Group 2: ½ cup low-fat ice cream; Fried Foods: Group 1: French fries; Group 2: baked potato; Baked foods: Group 1: 1 small oat bran muffin, Group 2: 1 slice oat bran bread; Convenience foods: Group 1: 1 cup cream soup, Group 2: 1 cup soup without cream; Table fats: Group 1: 1 tbsp. regular salad dressing; Group 2: 1 tbsp. fat-free salad dressing; Snacks: Group 1: 2 cups oil-popped popcorn, Group 2: 2 cups air-popped popcorn.

Reference is made to FIGS. 13Z-13AAM that include three output data files including the Raw Data file, Dietary Food Intake, and Error Messages. These files determine the subscriber's dietary intake patterns, including personal dietary habits and personal health motivations.

The Raw Data File System includes ID number, date, and goes through the answers to all questions. The questions are coded as recorded responses to formulate each individual subscriber's current dietary food intake patterns in order to guide them toward establishing long-term objectives for positively modifying eating behavior, and in particular, assist them in achieving a nutritious, balanced diet.

Because the integral dietary questionnaire within the program computes nutrient intake values from the responses to questions in Part I, the subscriber must answer each question as accurately as possible so as to further inform the corollary answers about dietary intake in Part II. However, if either of these set of questions are left blank, the program cannot calculate an accurate nutrient intake profile for that subscriber. Therefore, there must be an alert to the respondent to go back and answer the entire questionnaire as accurately as possible in order to maximize potential output (nutritional) benefits.

Only one response is required for most questions. However, for some questions, more than one answer is acceptable. For example, if more than a single type of fruit is selected, then it will be assumed that each is consumed in equal quantities for the completion of such nutrient intake. Inconsistencies between question answers determining types of foods and amounts consumed will result in the data for that person being rejected, so respondent may be alerted to revise the response. If more than one response is given (such as chocolate and crackers), the highest consumption response will be recorded for purposes of nutrient intake analysis. However, when a “frequency” response has been given to one question, and the “portion” question for that food group or food subgroup has been left unanswered, it is assumed that the intended response implies an average component.

Reference is made to FIG. 8f which indicates that in an embodiment, the program includes the MEDFICTS assessment tool originally developed for ATP II, and included in ATP III, which is used to obtain an individual's dietary fat intake patterns in order to recommend a discrete dietary approach to reduce the subscriber's fat intake, helping she/he to achieve their individual weight loss and/or overall health goals. Individual subscribers are also assigned points for certain weekly consumption patterns, including component size restrictions. These are then multiplied together to obtain a total dietary profile score, e.g., ≧70 which means the individual's dietary fat intake is approximately 30%, higher than recommend, indicating that they need to make some dietary changes; 40-70 means the subscriber needs to follow a “Heart-Healthy Diet” (saturated fat <10% calories, total fat <30% calories, and cholesterol ≦300 mg per day); and <40 means that the subscriber needs to follow a “Therapeutic Lifestyle Change (TLC) Diet,” (saturated fat <7% calories, total fat <30% calories, and cholesterol ≦200 mg per day. Points are recorded responses in the raw data file.

In an embodiment, the program includes unique methods and processes, formulated to fully utilize individual online subscriber's dietary questionnaire responses to assess their individual DIETARY HABITS and DIETARY INTAKE. Questions obtaining yes or no answers are recorded in the raw data file as 1 for yes, 0 for no. Frequency questions obtaining information about number of times per day or week that the subscriber consumes a certain food type are recorded from 0 for “Never/Seldom” to 7/d for “7 times per day” or 7/w for “7 times per week.” The letter “d” represents daily intake, the letter “w” represents weekly intake, and the constants represent the “number of times” that the subscriber consumes a type of food. The weekly frequency responses are converted to daily equivalencies. For example, question 5 asks the number of times per week that the individual eats fruit. The frequency response of 4/w (“4 times per week”) is converted to a daily equivalency factor (DEF) of 0.57 (4/7).

Questions listed in the Dietary Questionnaire regarding component sizes are coded as portion equivalencies relative to the USDA National Nutrient Database (2014) standard component sizes. For example, the standard portion size factor (PSF) indicating whether a person eats a standard component size (PSF=1), more than the standard component size (PSF>1), or less than the standard component size (PSF<1). The PSF is used to scale the standard portion size for different foods up or down. For example, question 1 in Part II asks the amount of food subscriber eats at one time. The portion response of 2 medium apples eaten at one time is converted to PSF=2.0 (twice the standard component size). The standard component size for fruit is ½ cup recorded as PSF=1.00, ‘never late’ recorded as 0, 1 cup fruit recorded as PSF=2.00. Apple is the representative food for the fruit group.

Questions regarding type of foods are necessary to determine the relative contribution of different types of foods to the individual's total dietary food intake patterns. Where it is possible to choose more than one type, there are separate variables for each type, which are coded 0 if not used, 1 if used. The number of types of foods range from 0 to 12 food types.

### Medical Questionnaire

In an embodiment, the Medical Questionnaire section provides for a basic assessment of the subscriber's previously diagnosed medical condition(s) and/or individual risk(s) for existing and/or potential future health problems. The online subscriber's questionnaire responses enable scientifically verifiable dietary opportunities to be discretely identified and selected for them to thereby improve their nutrient intake. The Medical Questionnaire results are always recommended to be used in consultation with the online subscriber's preferred medical practitioners in order to maintain and/or improve their nutritional intake and overall health.

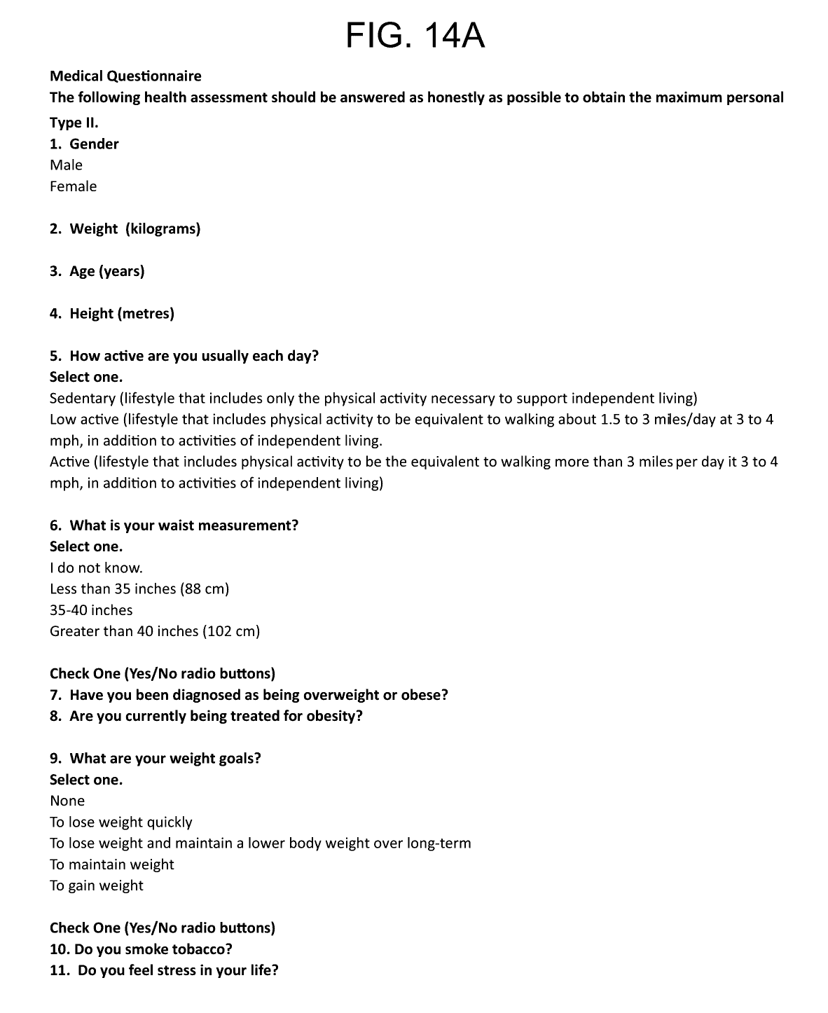

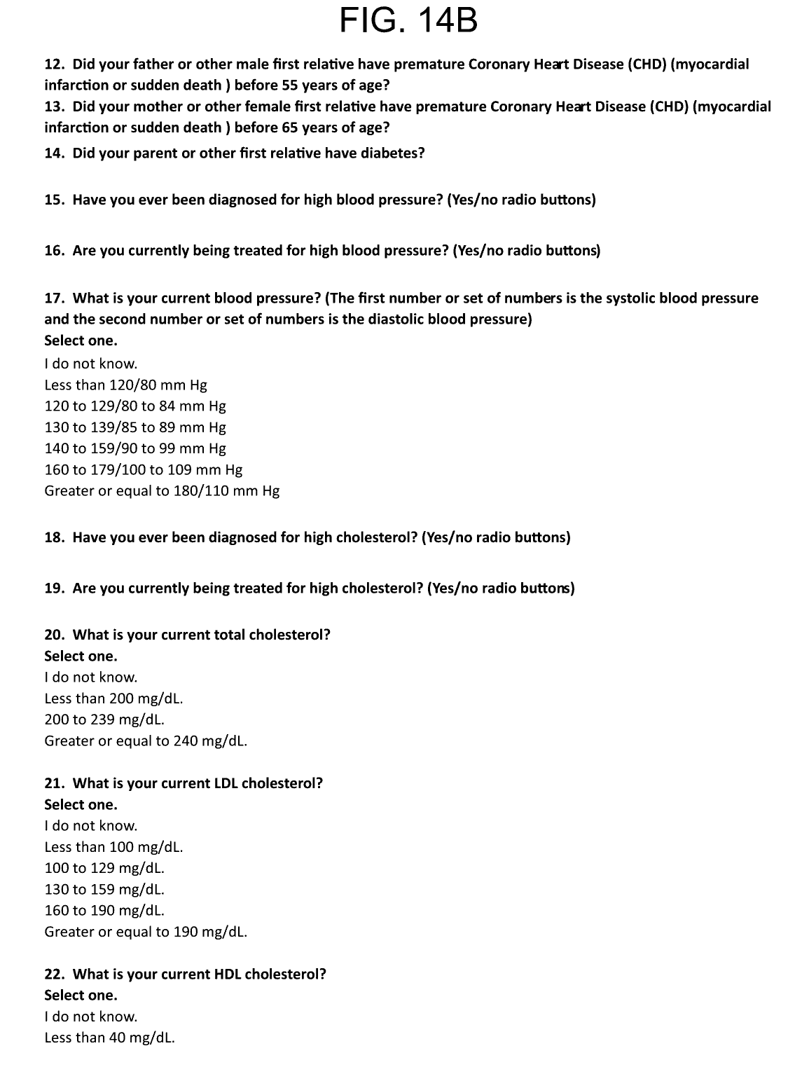

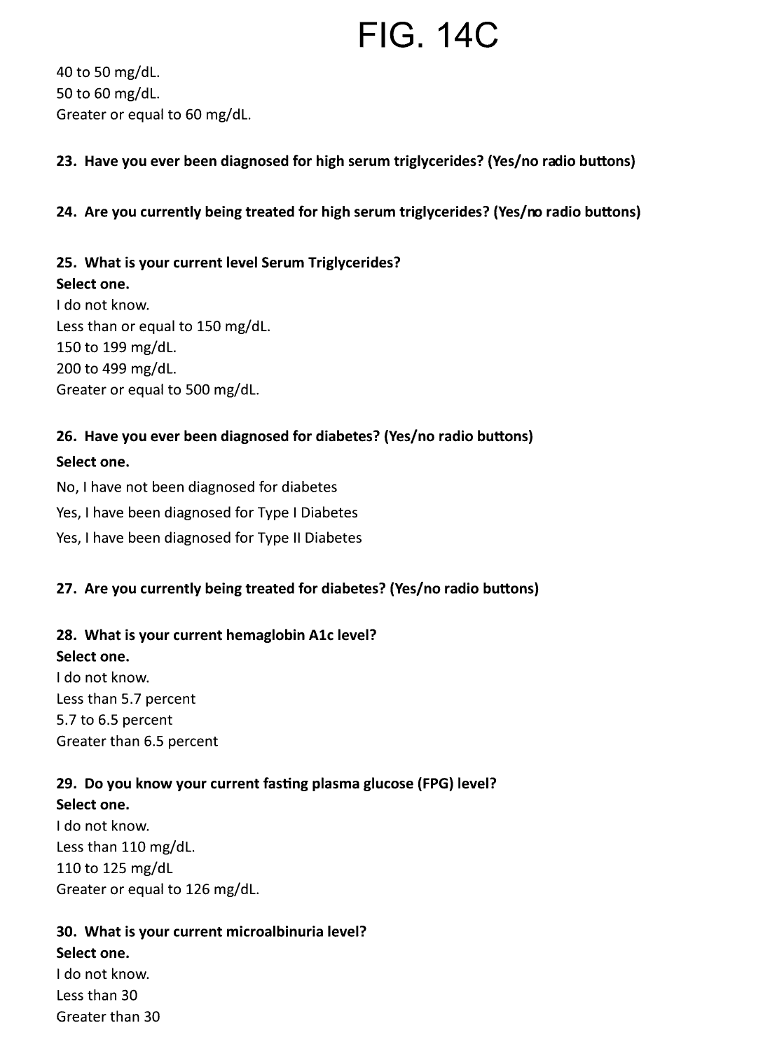

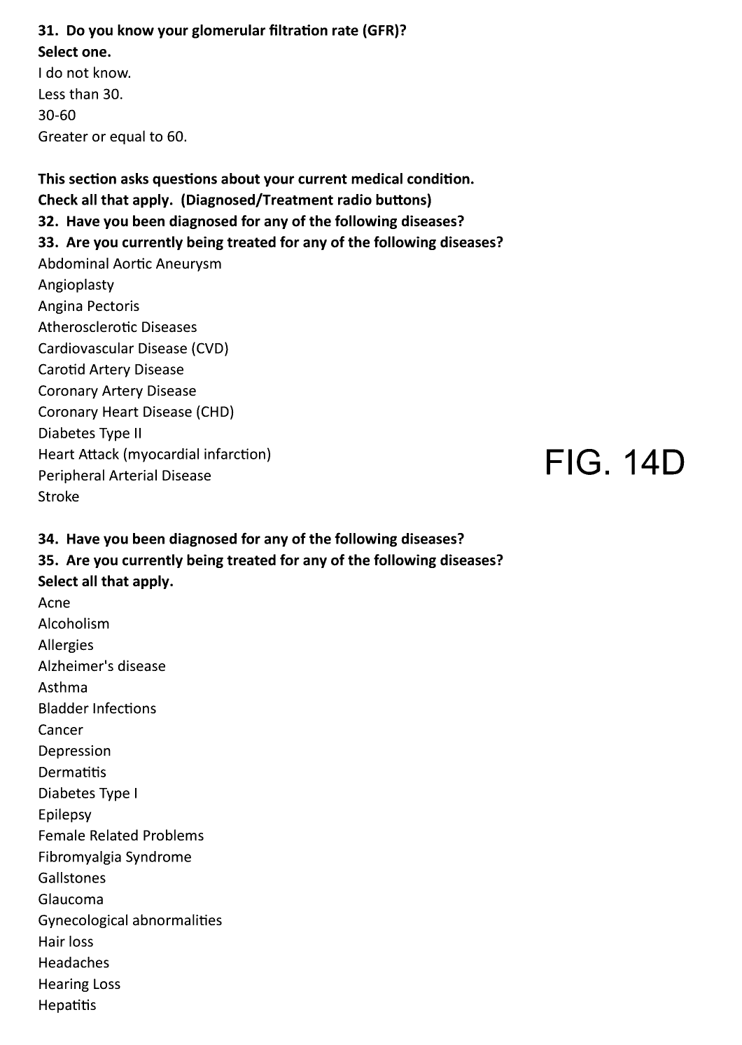

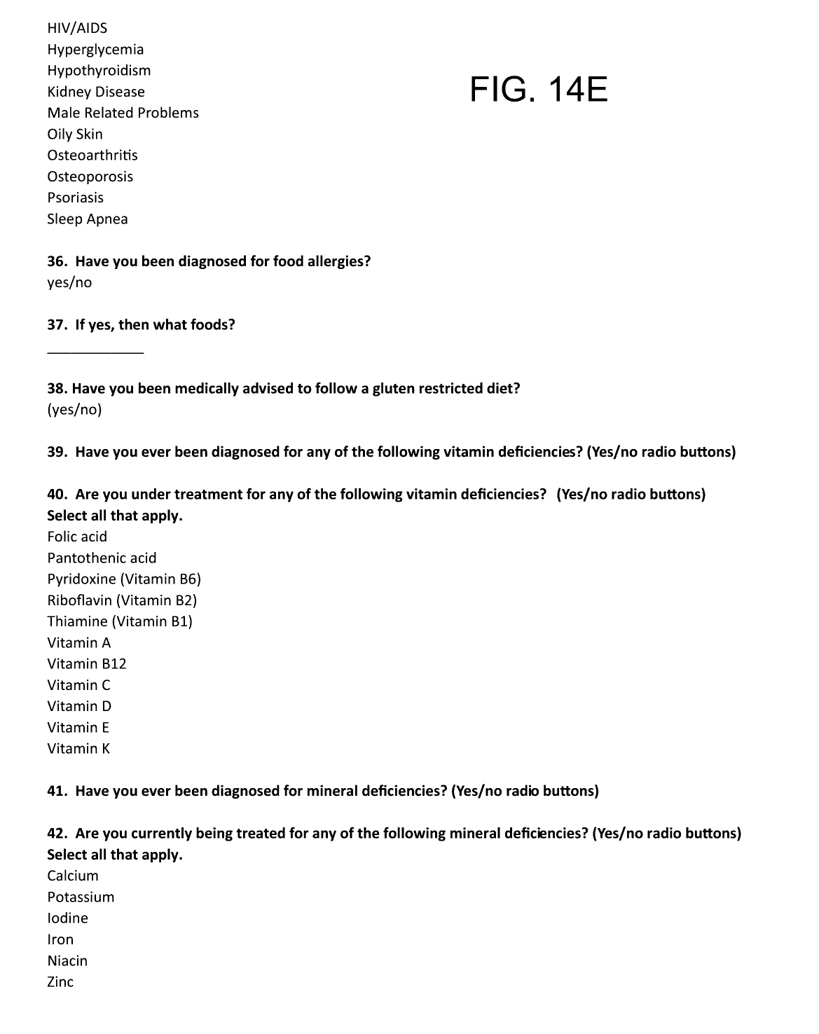

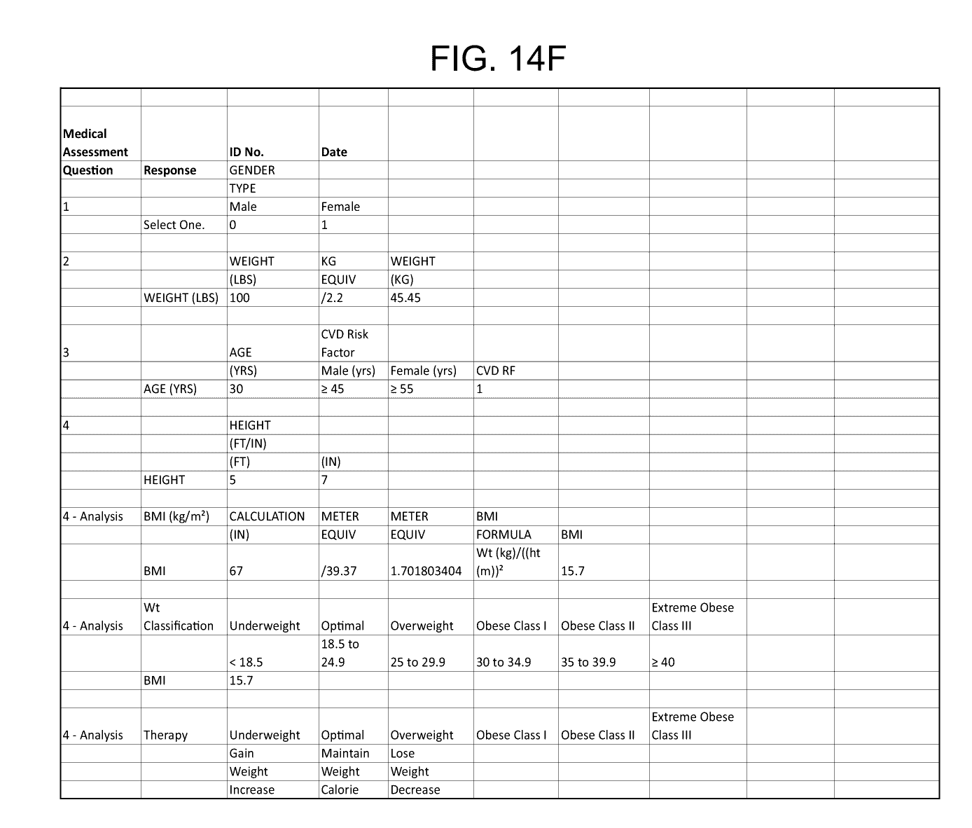

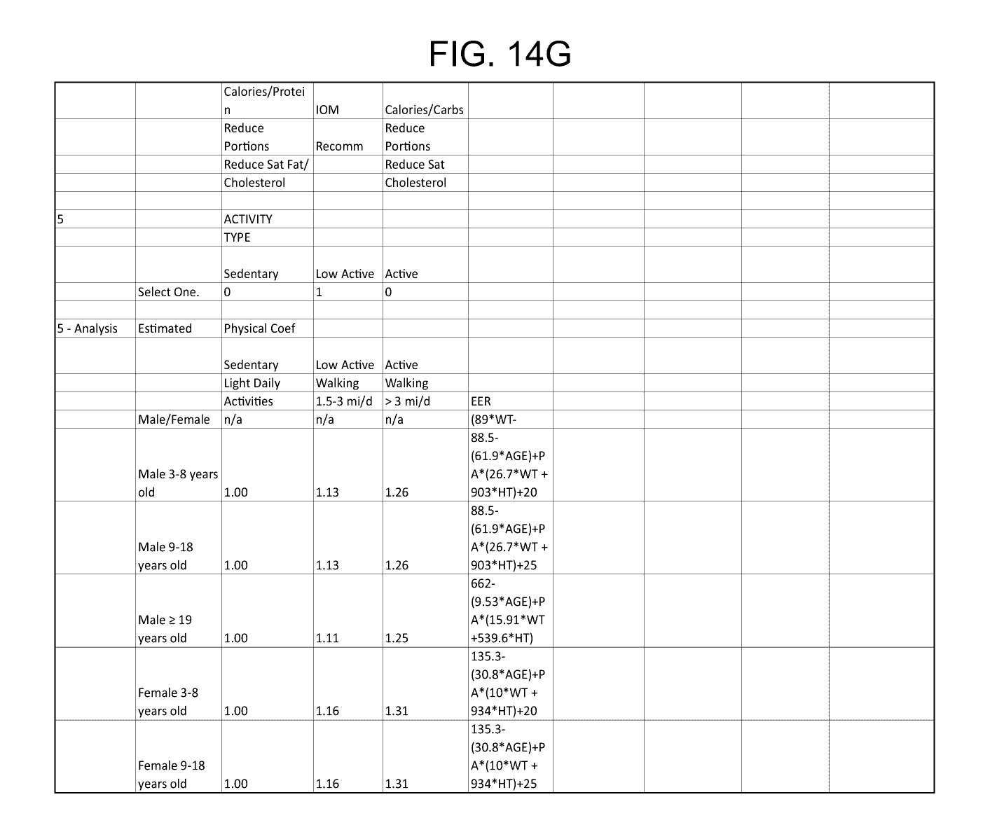

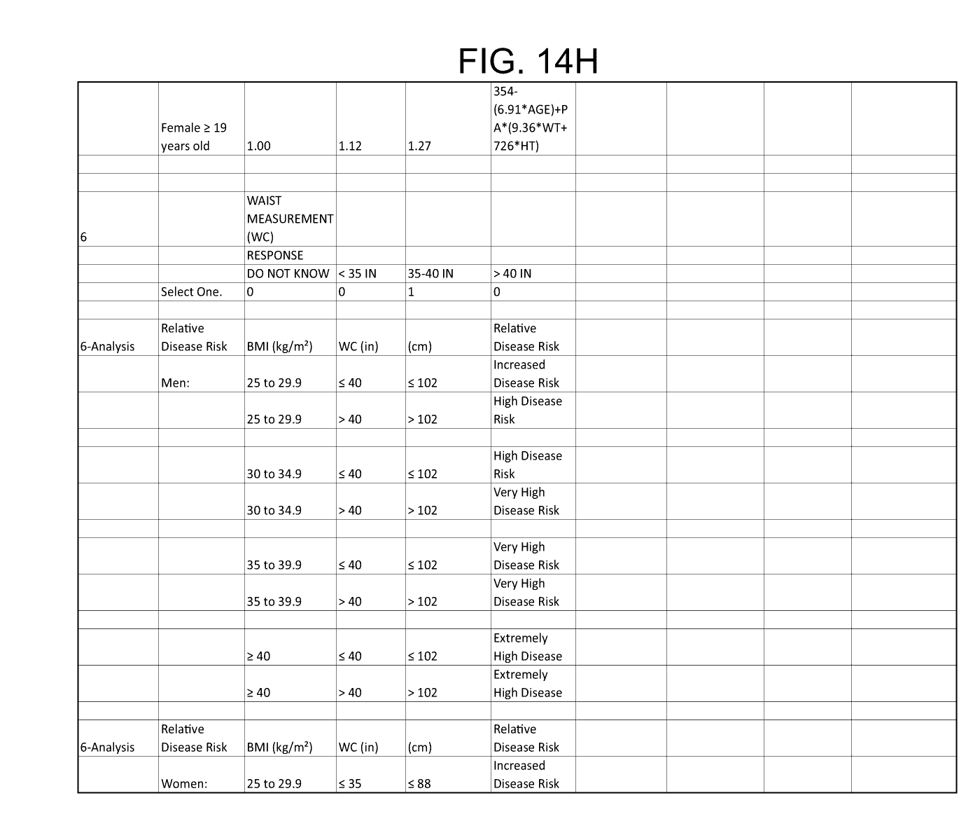

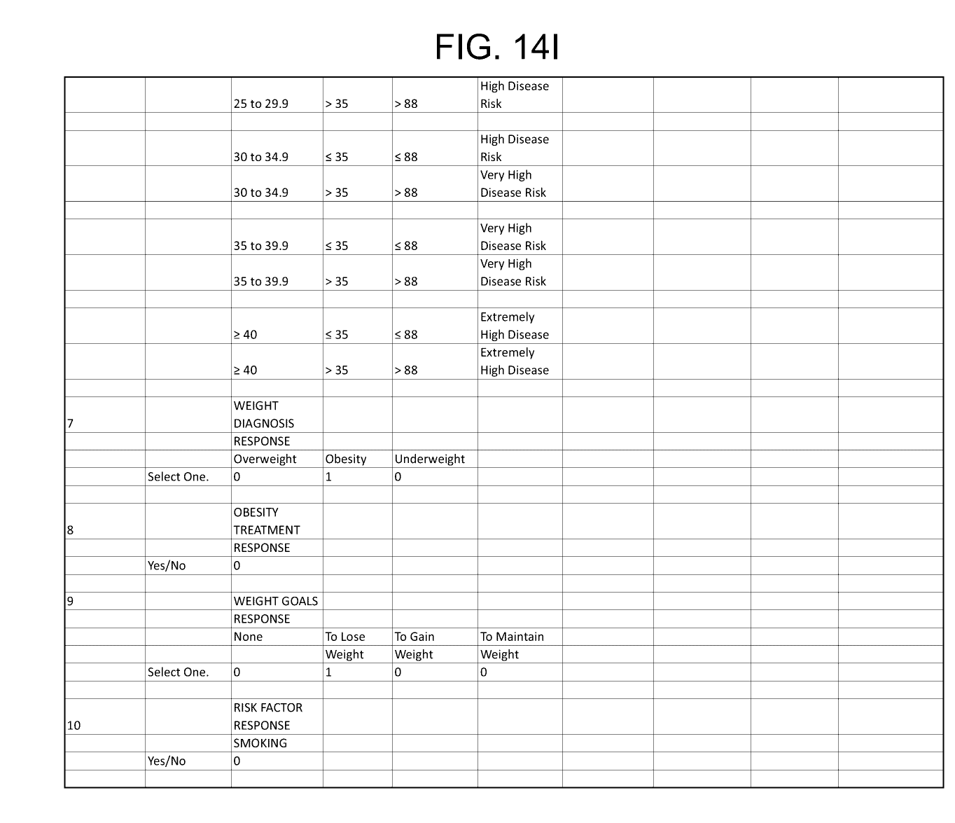

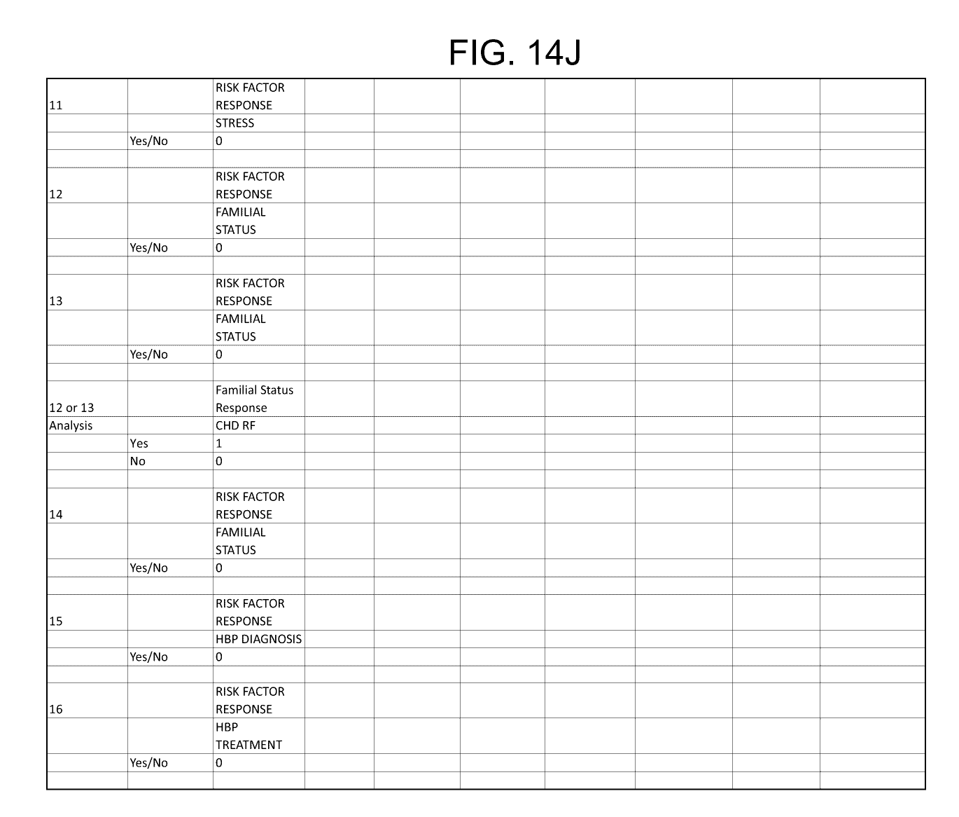

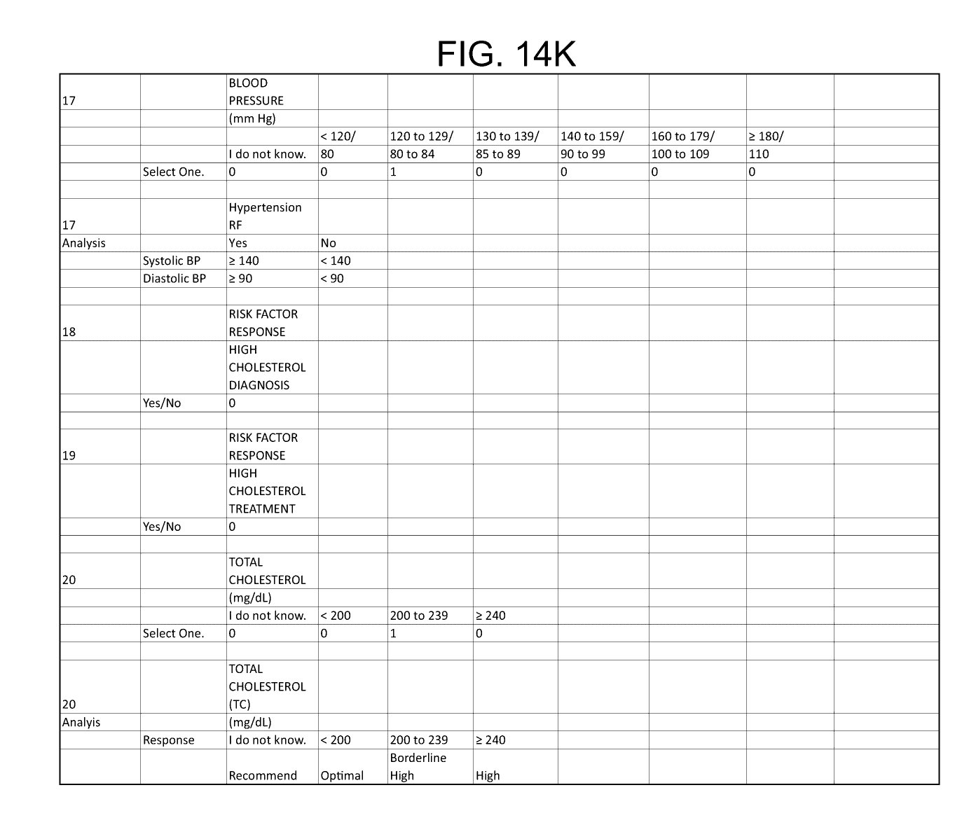

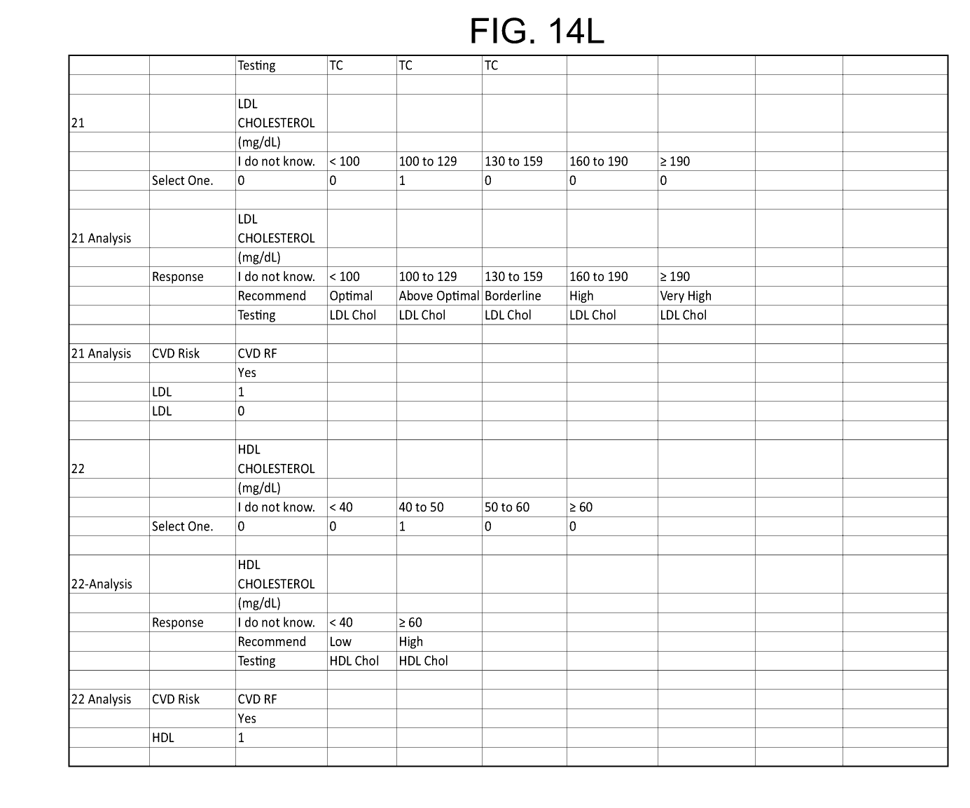

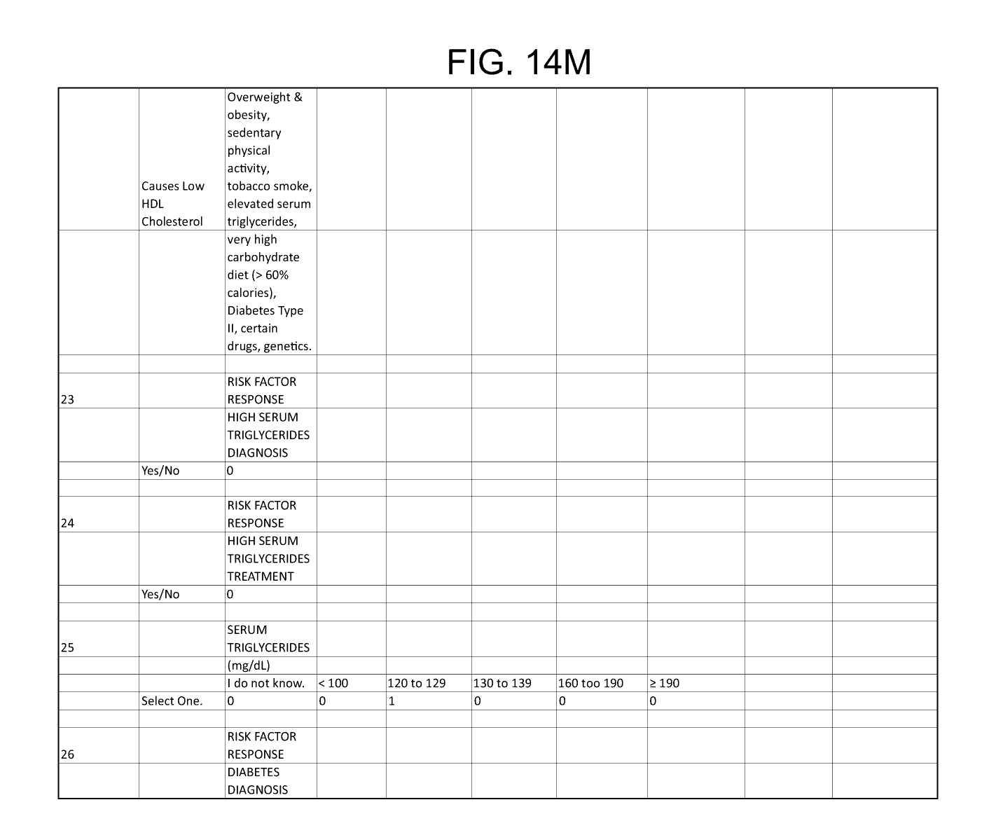

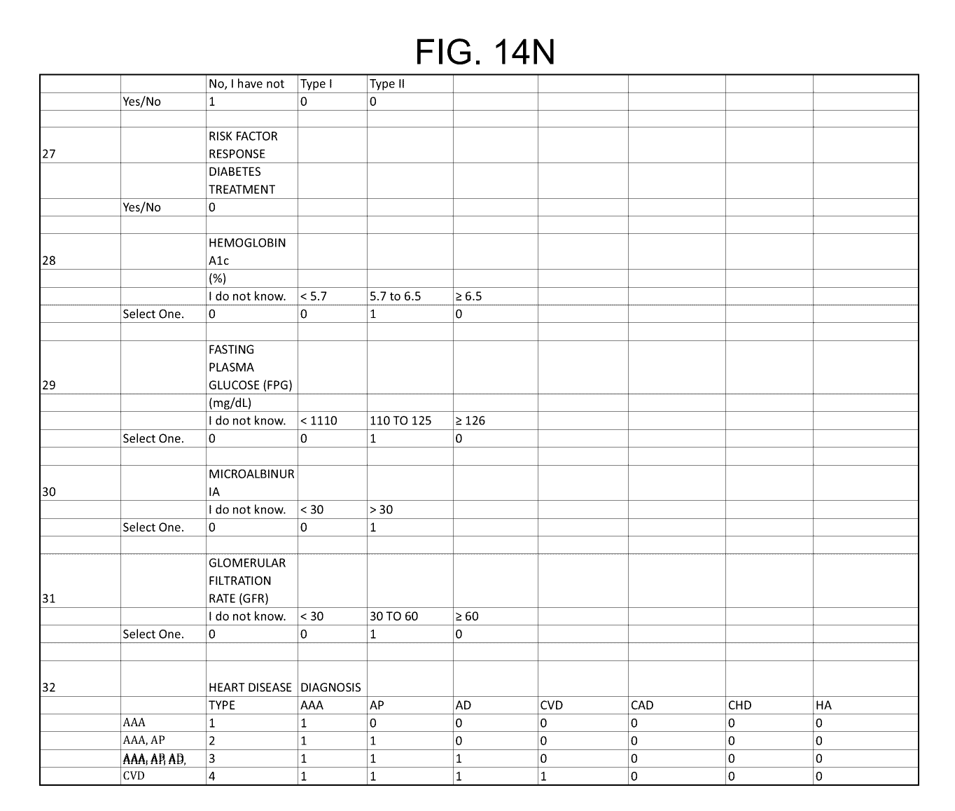

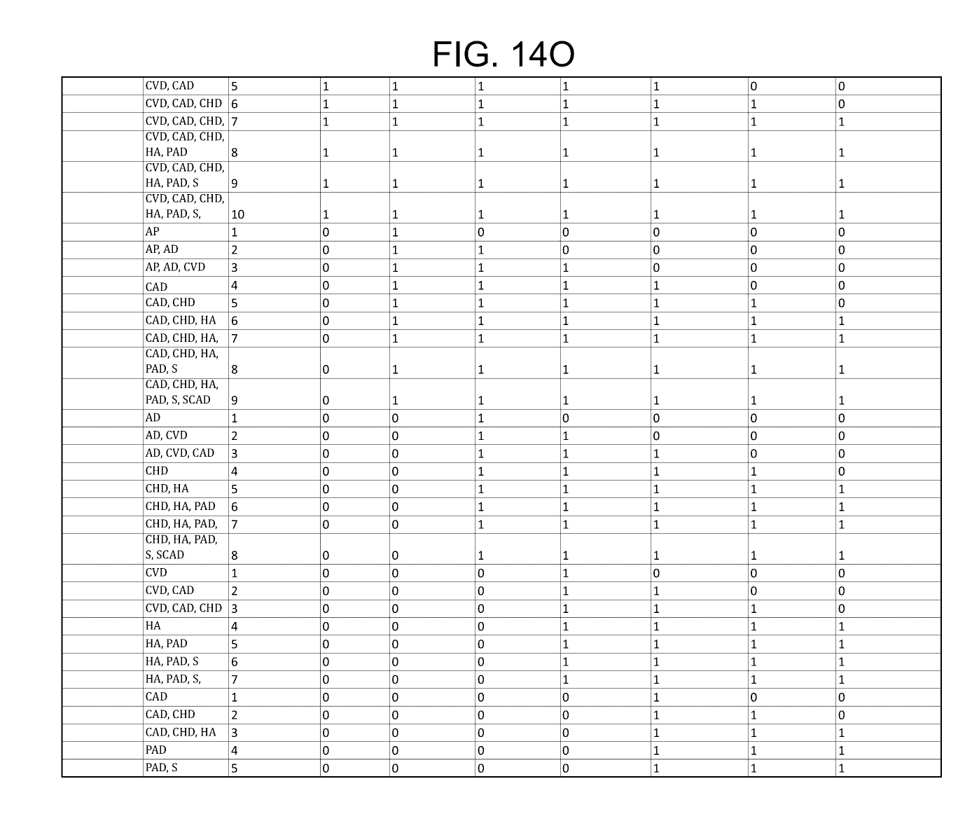

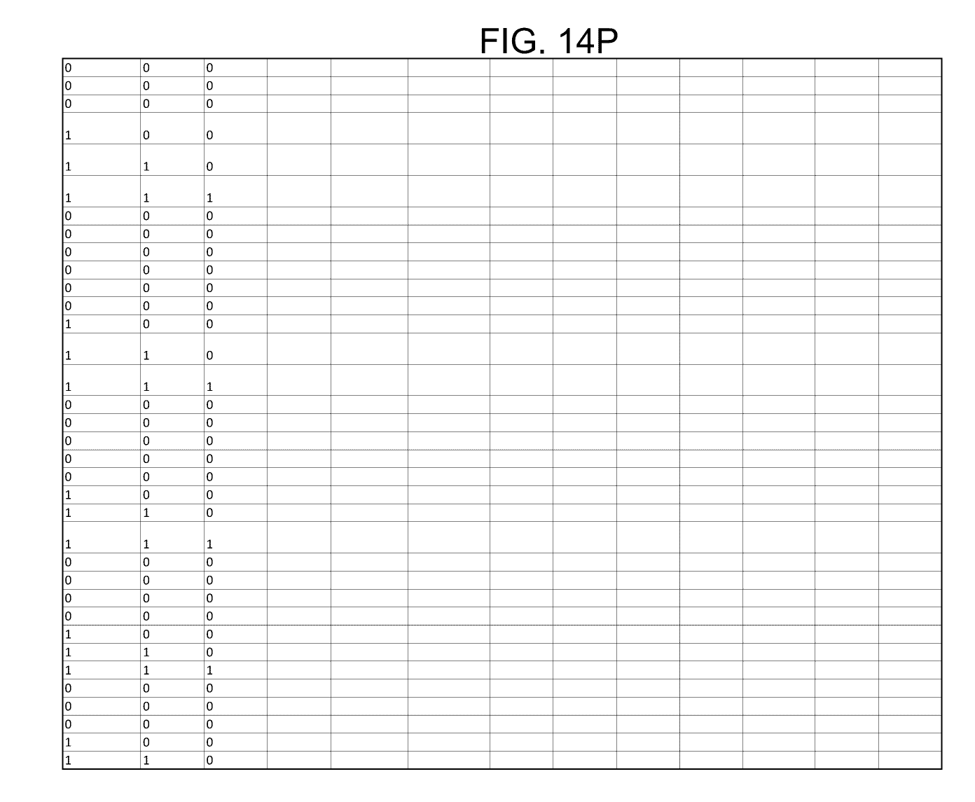

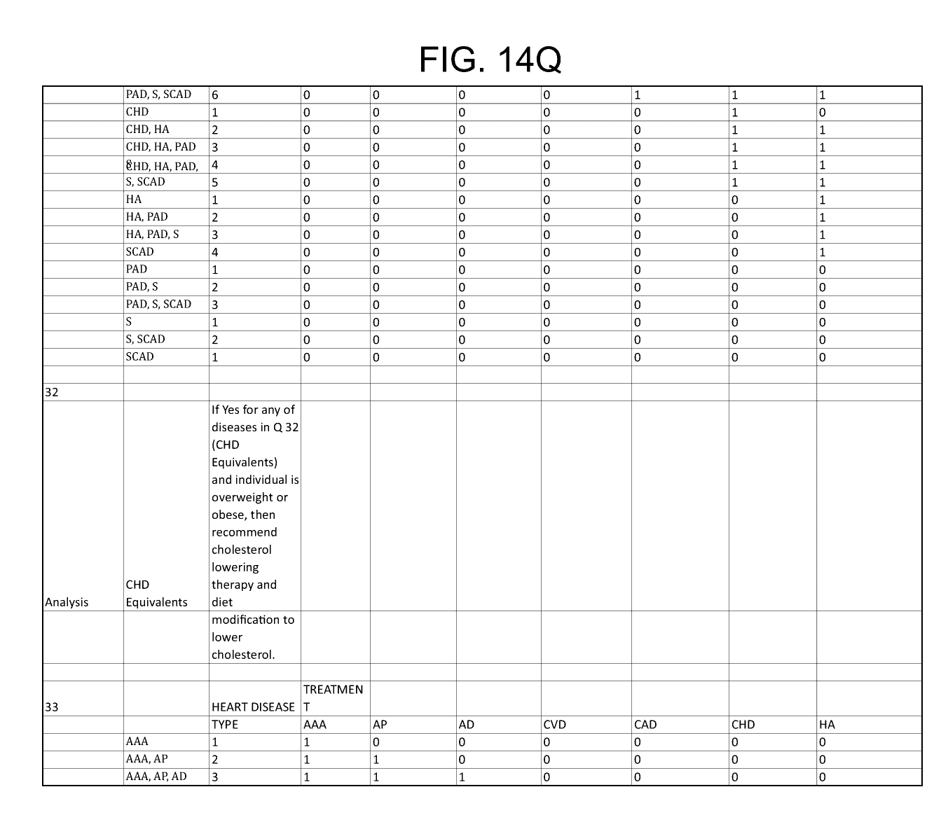

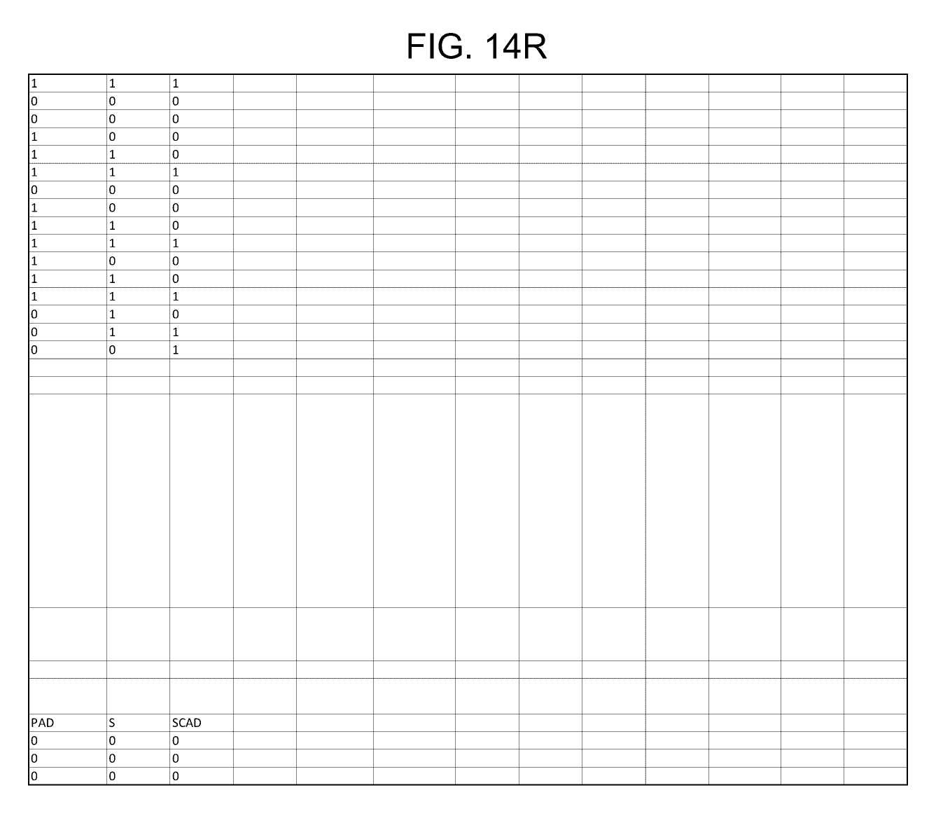

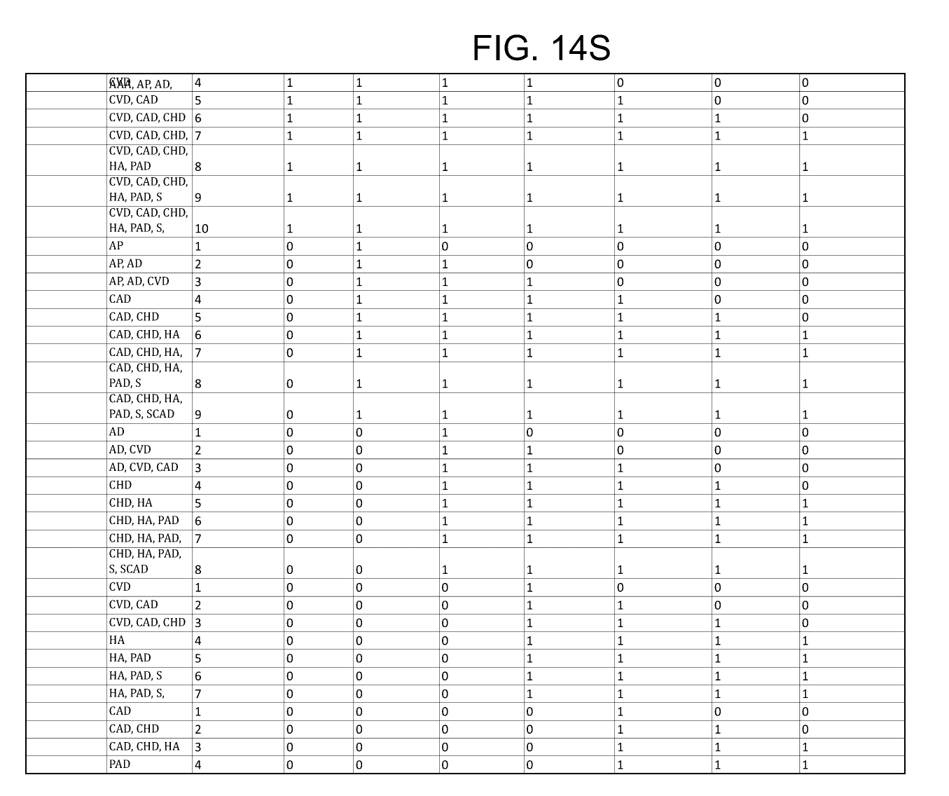

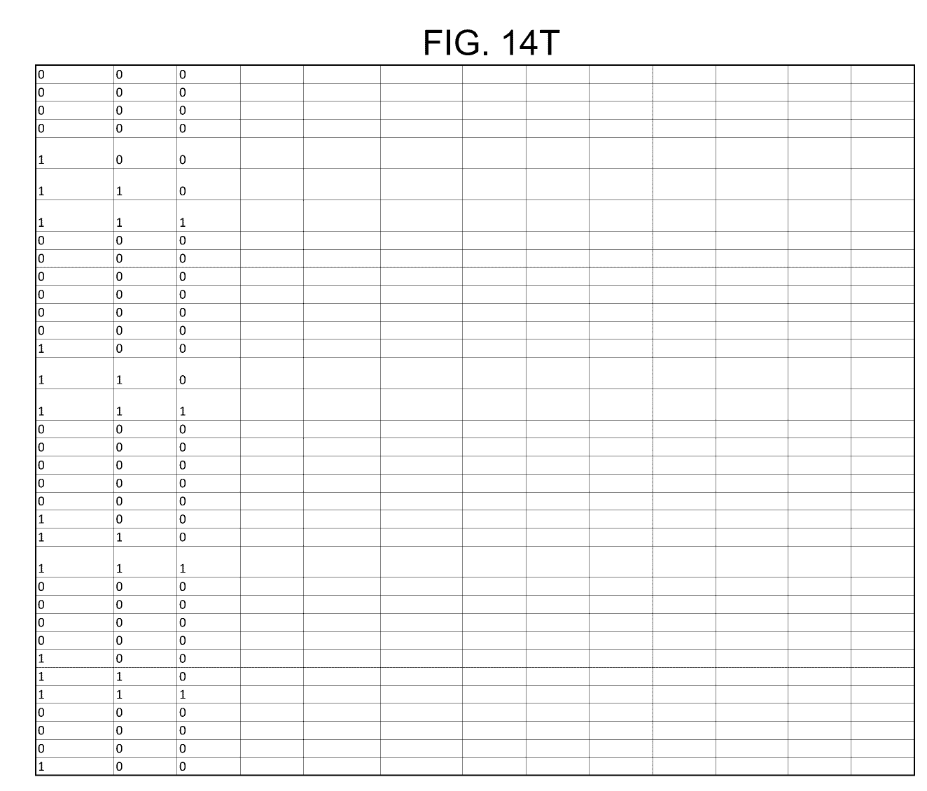

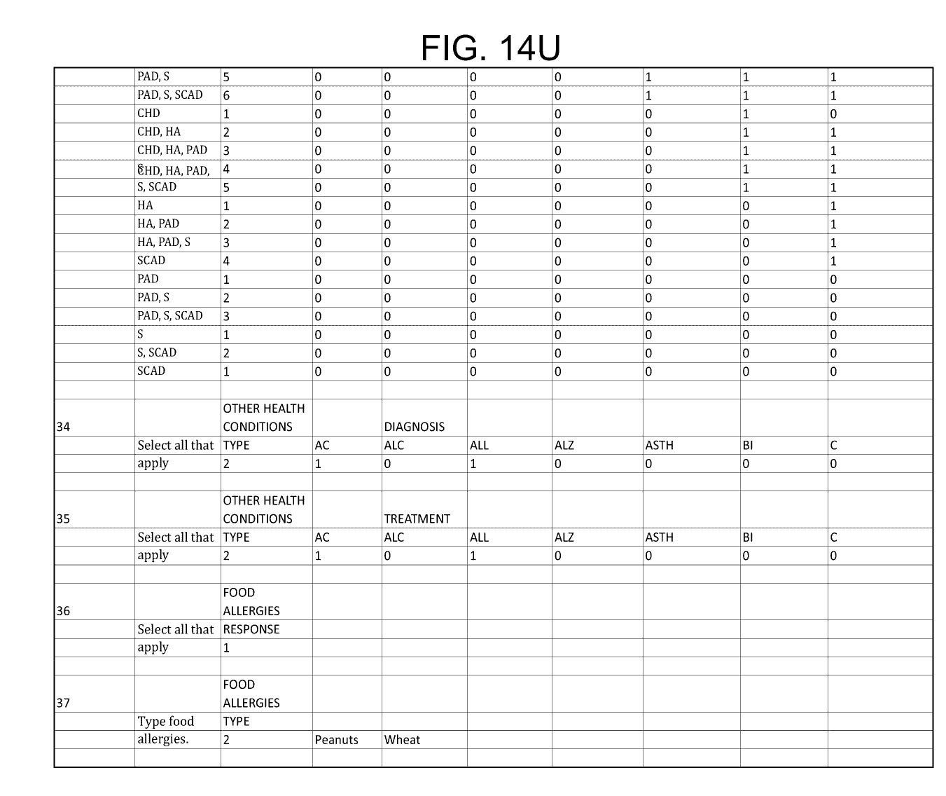

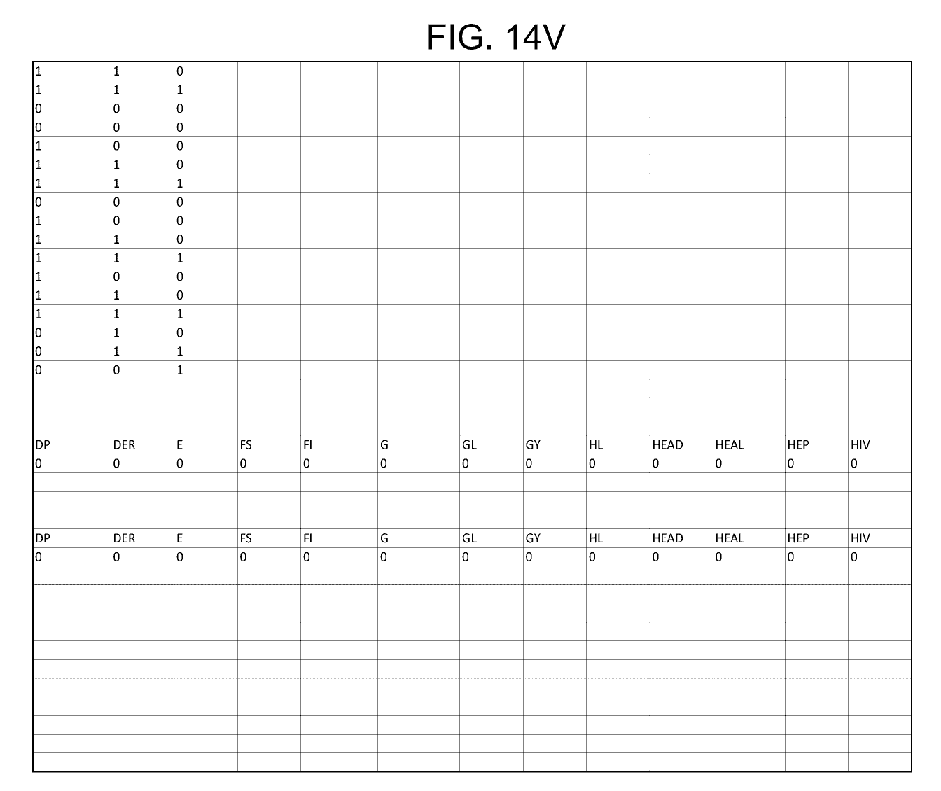

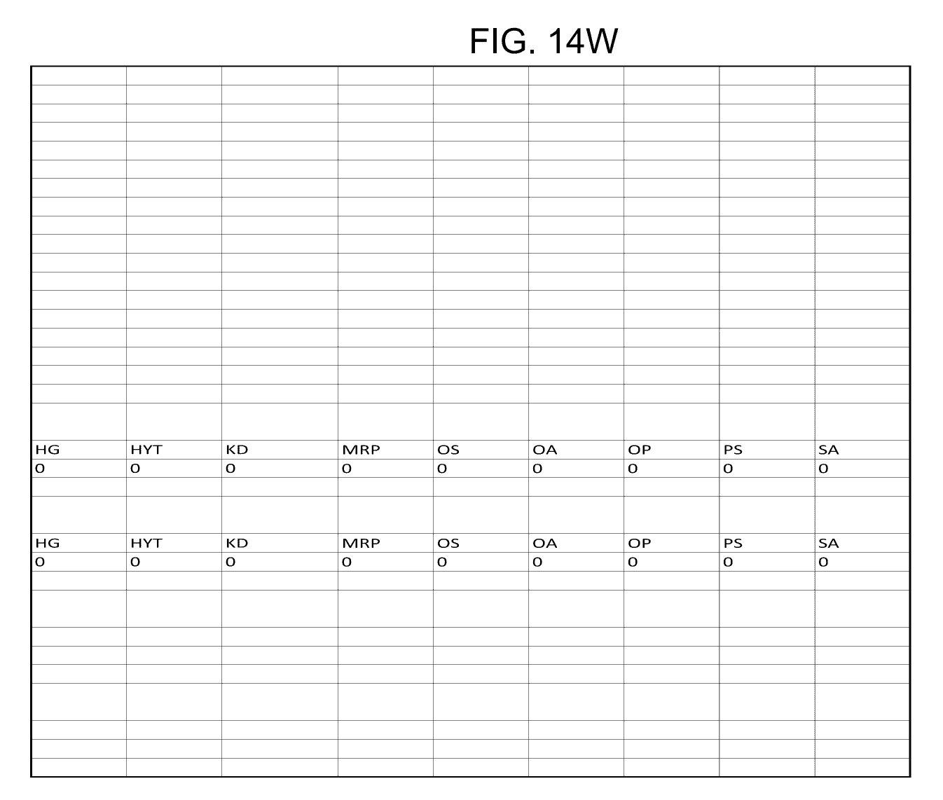

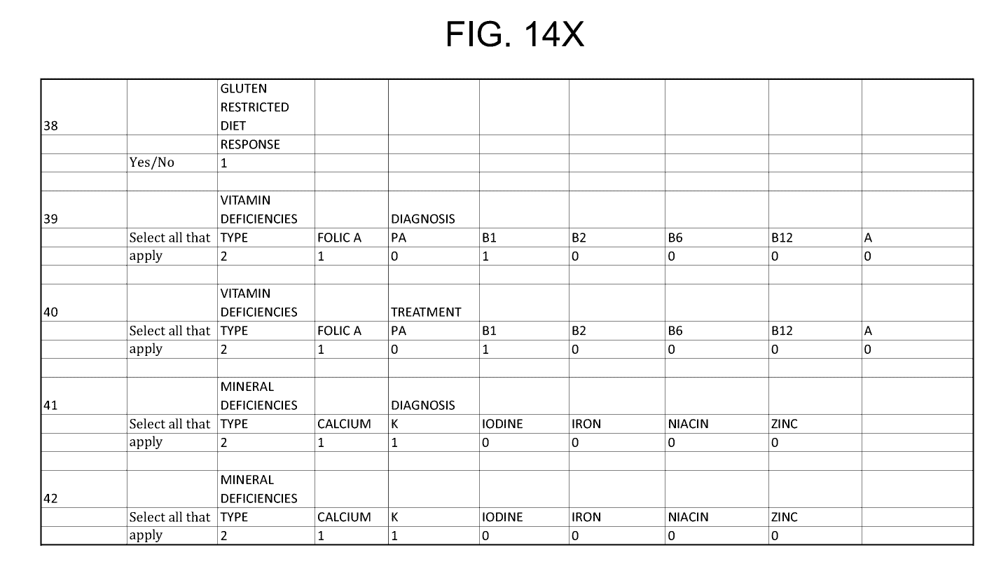

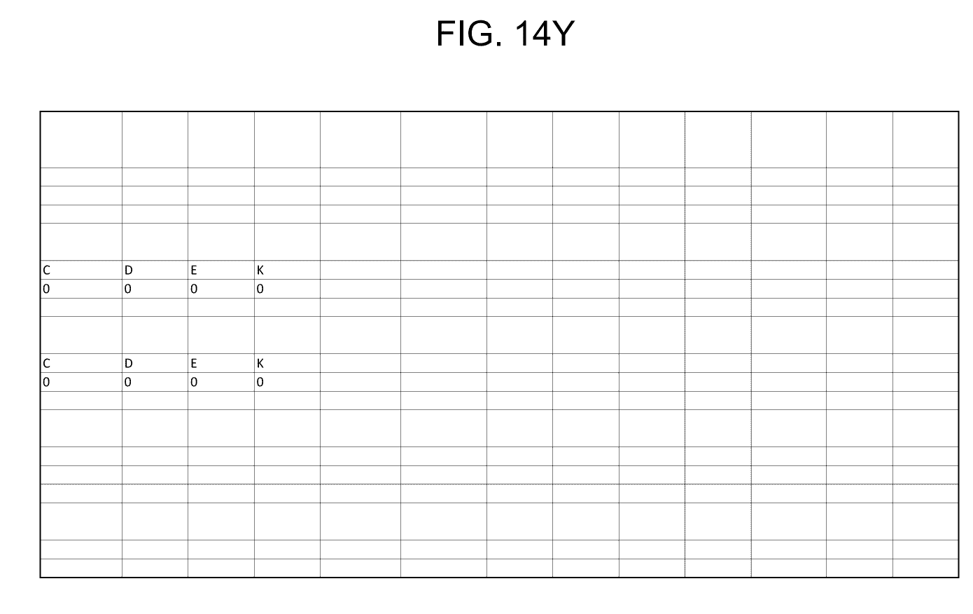

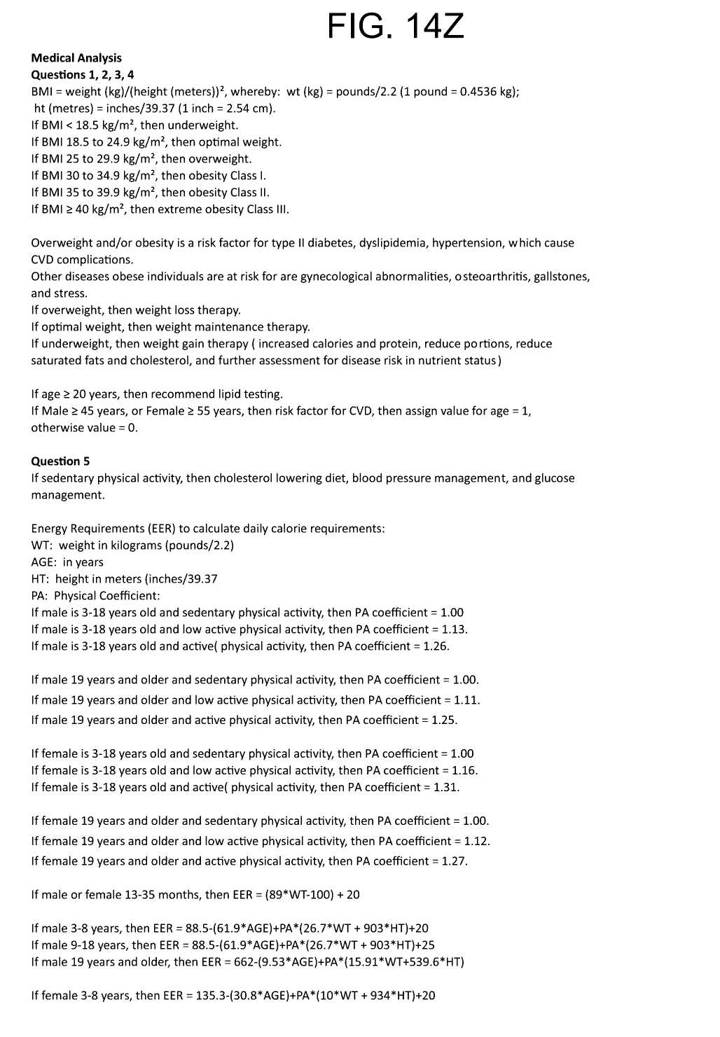

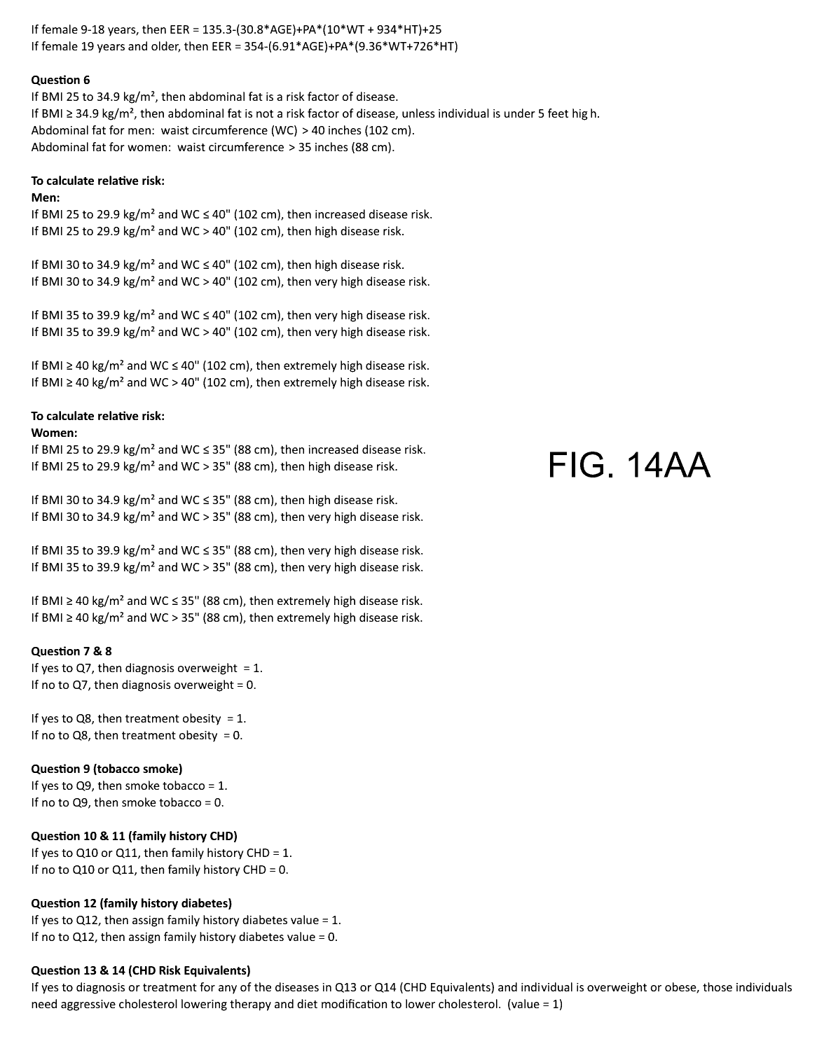

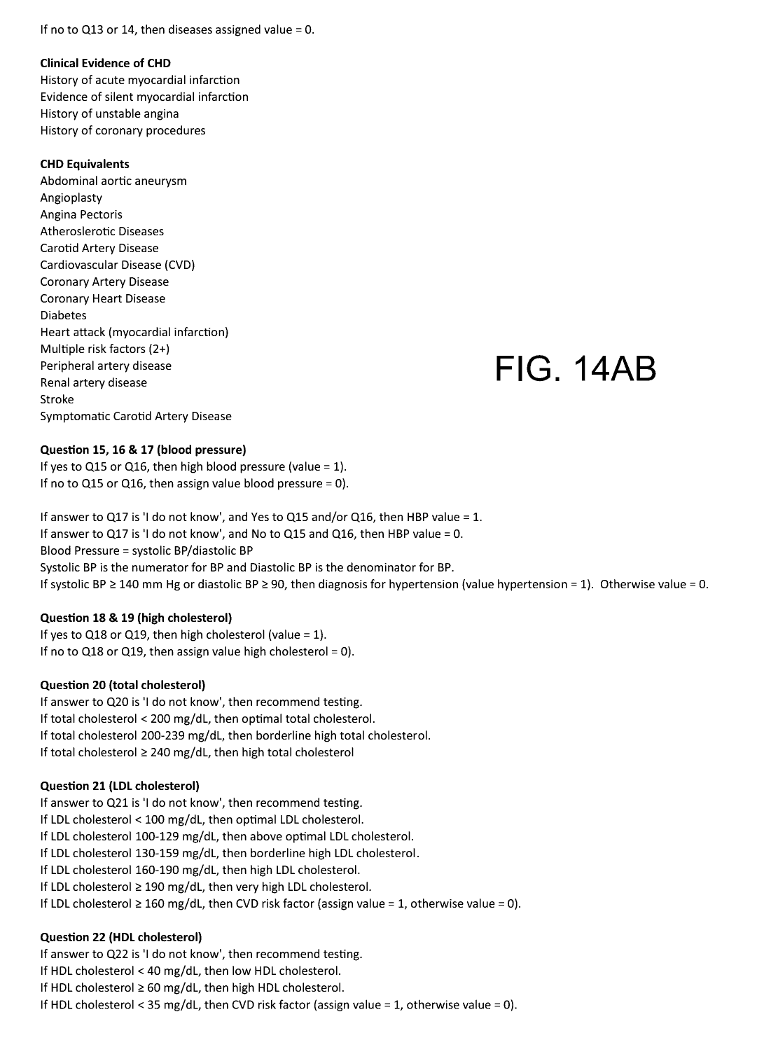

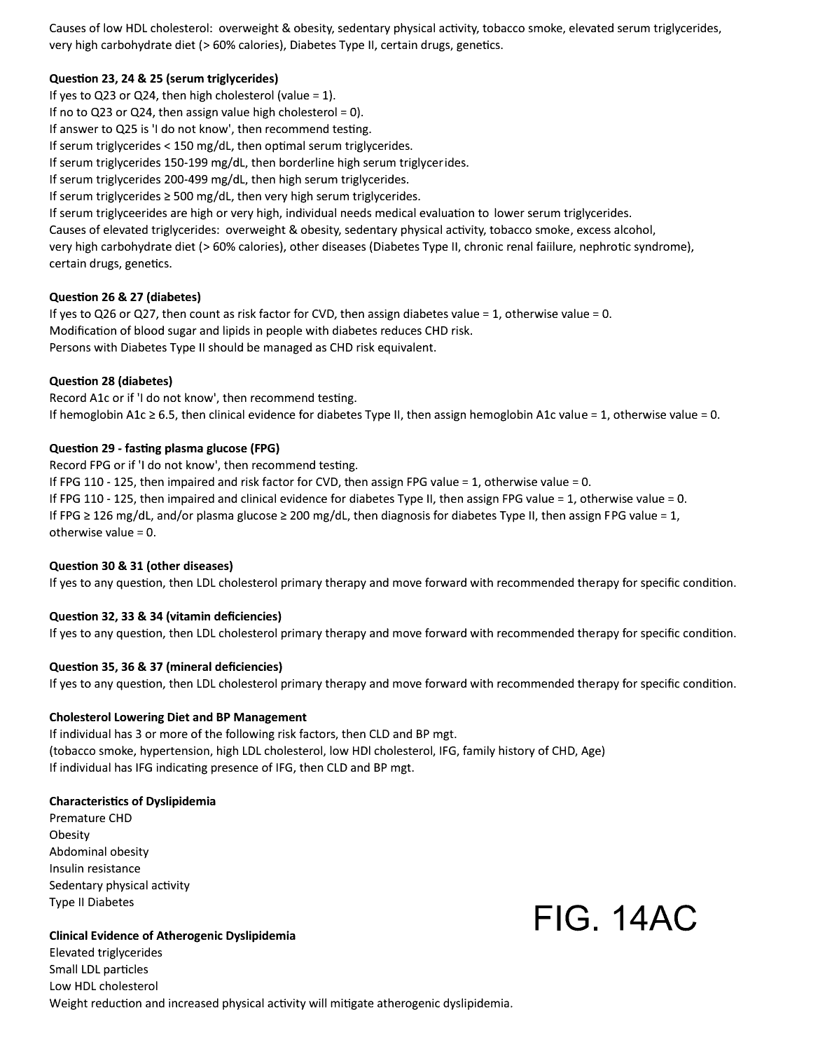

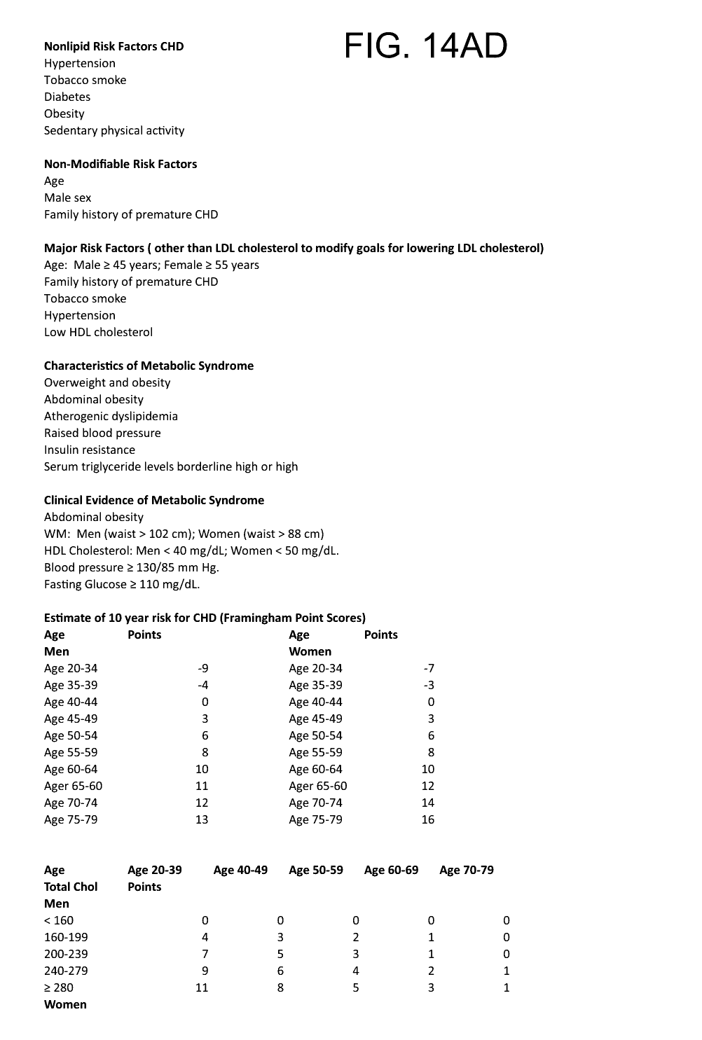

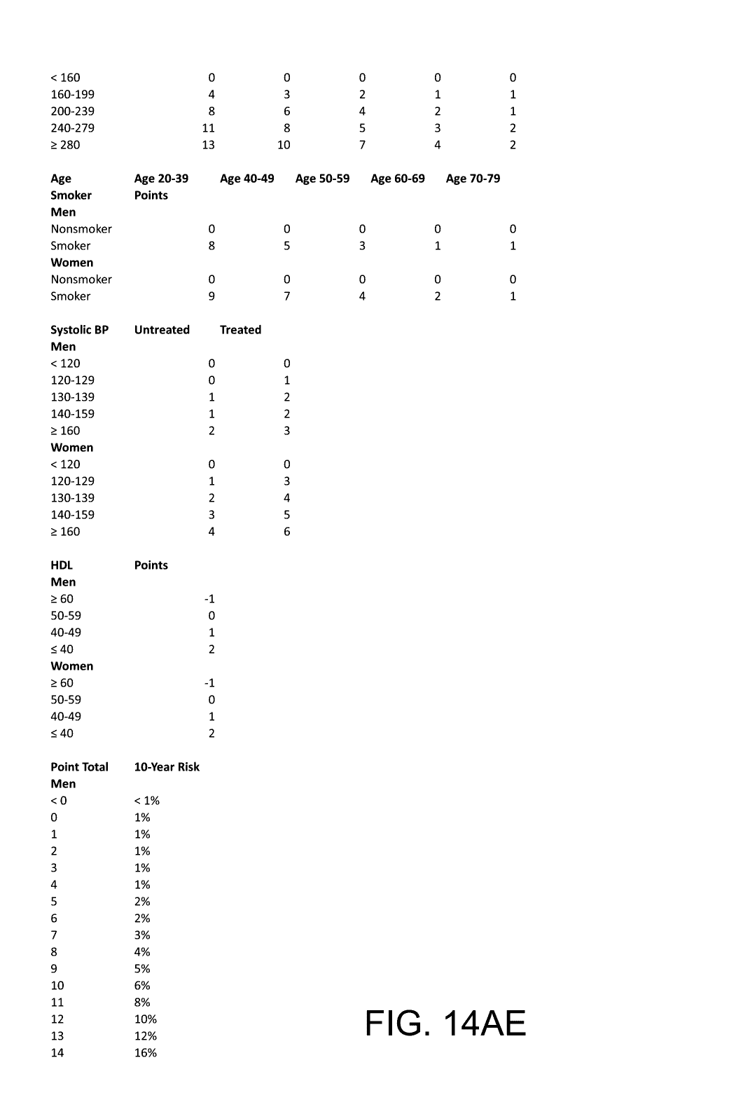

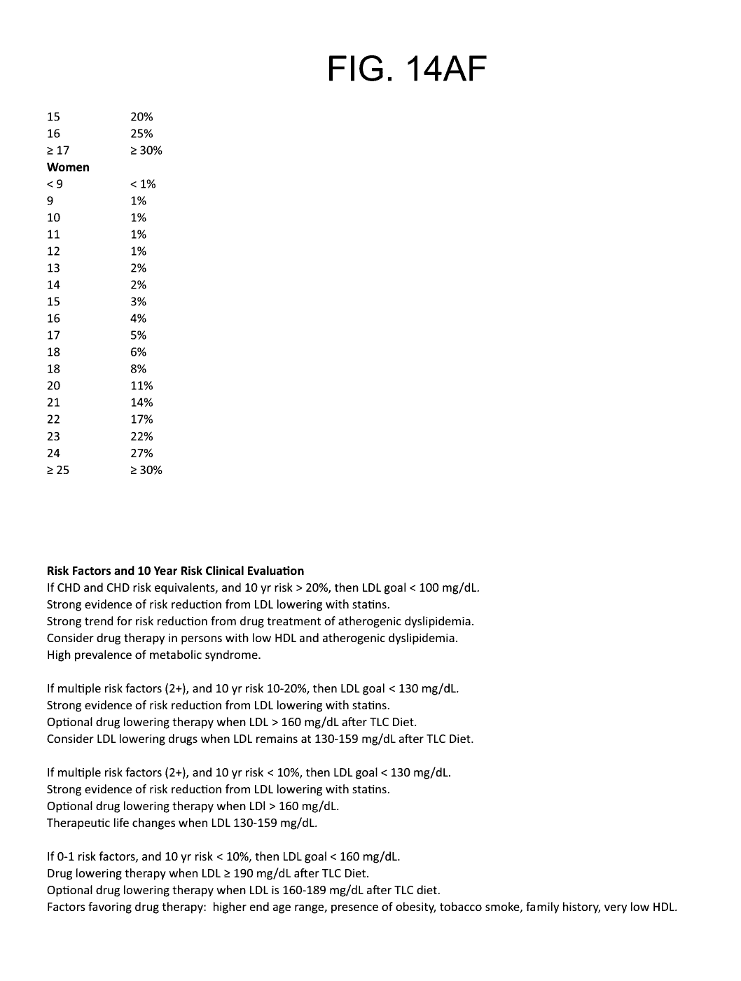

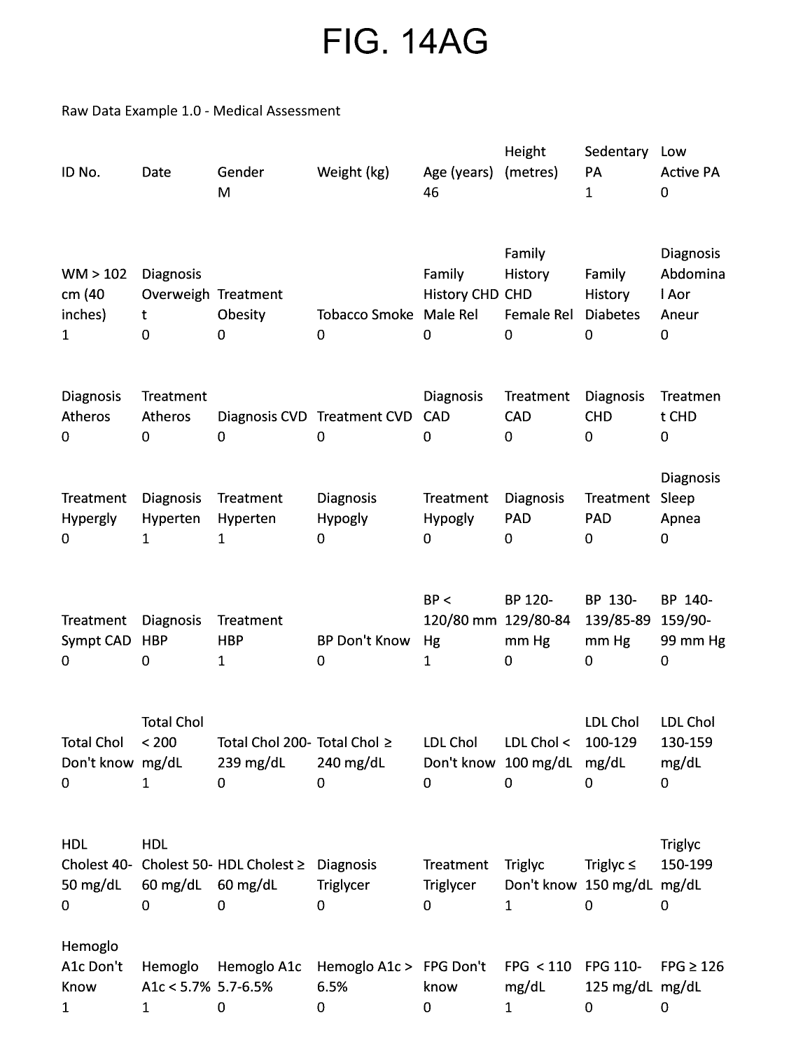

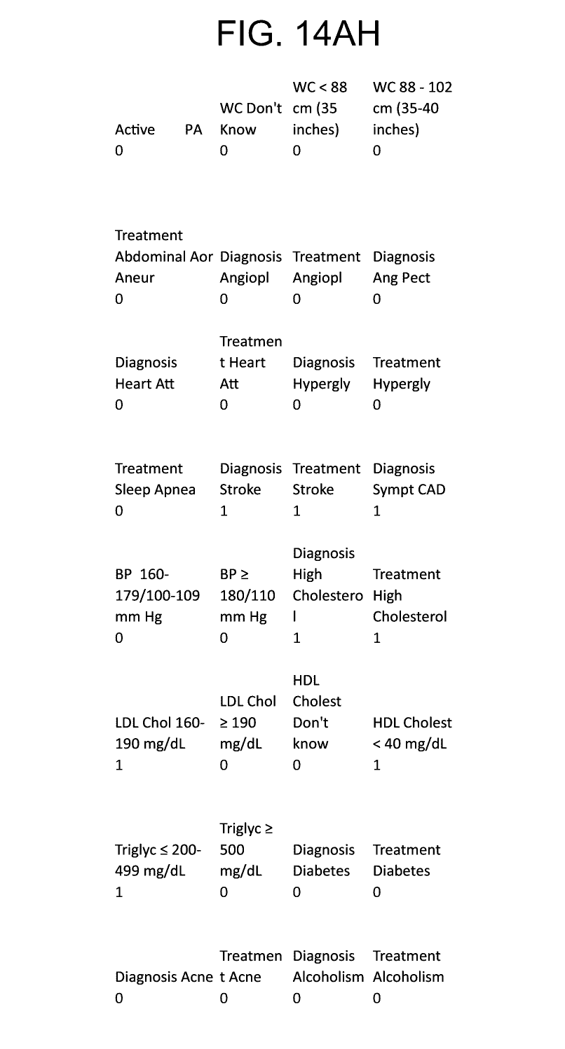

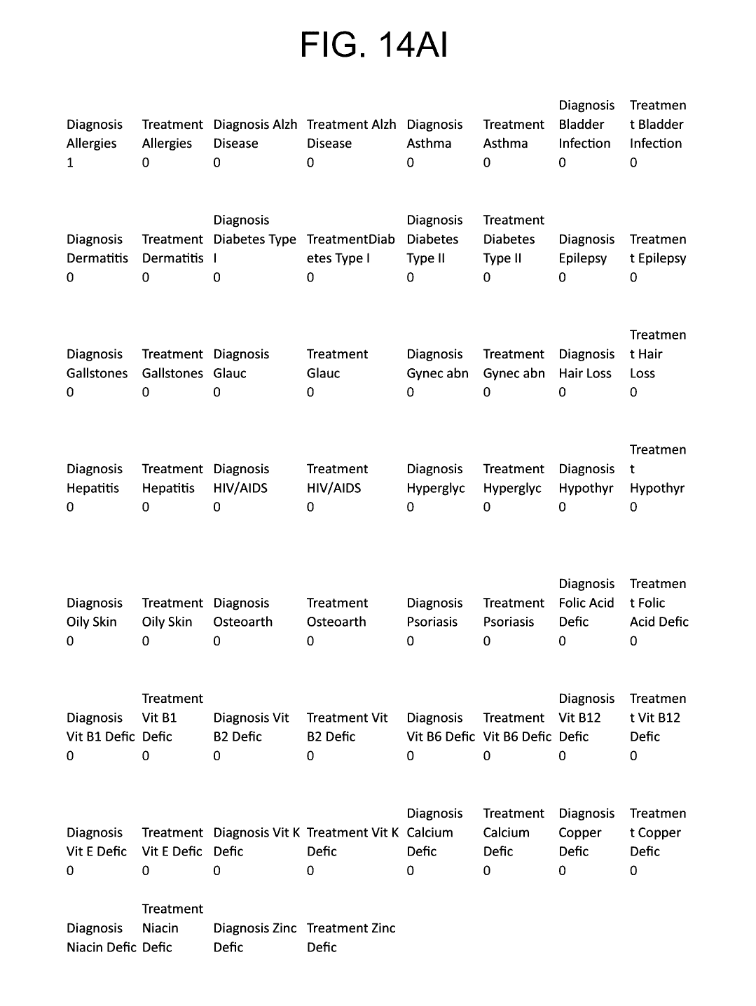

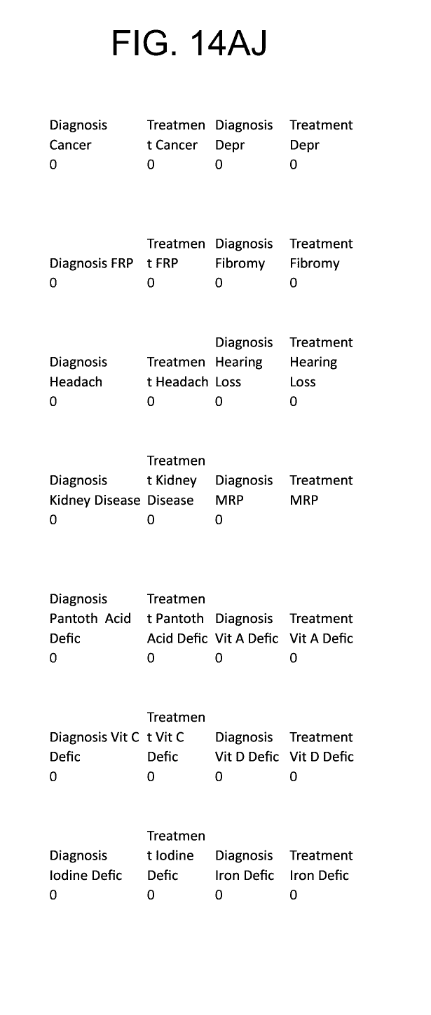

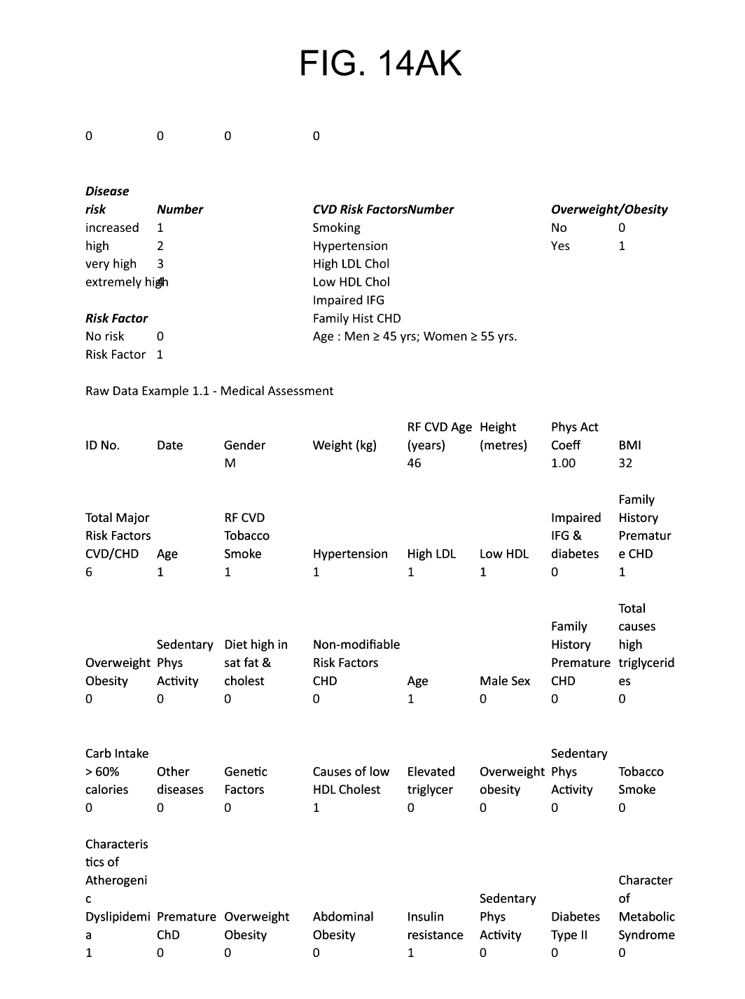

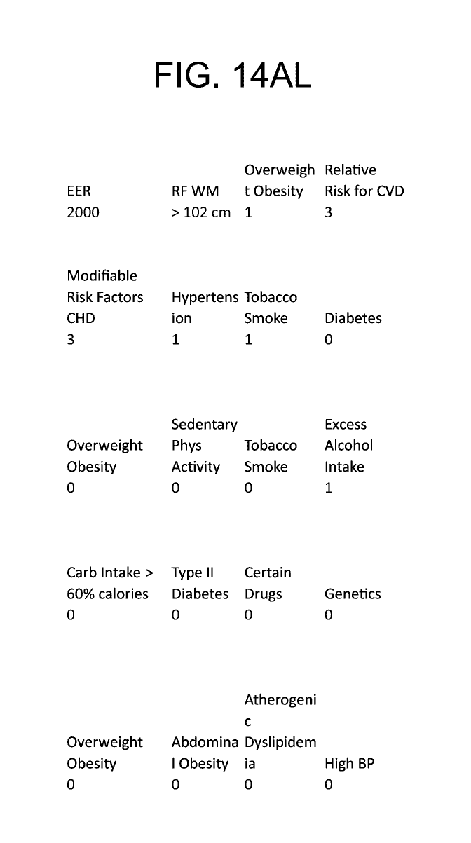

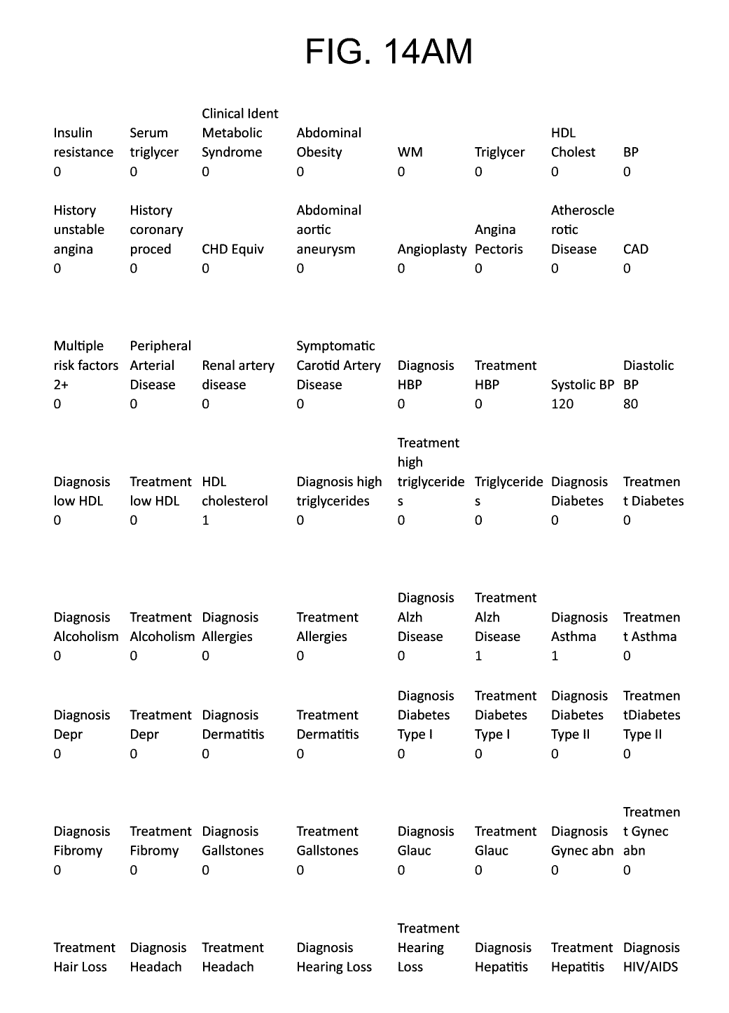

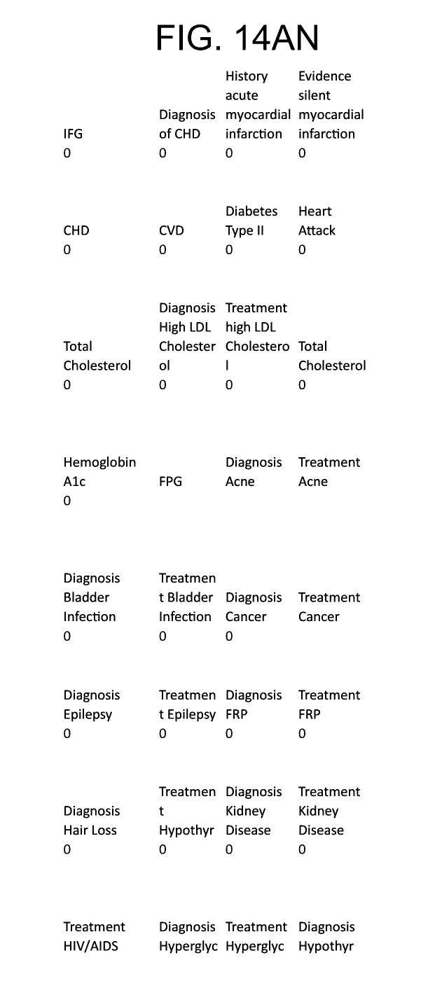

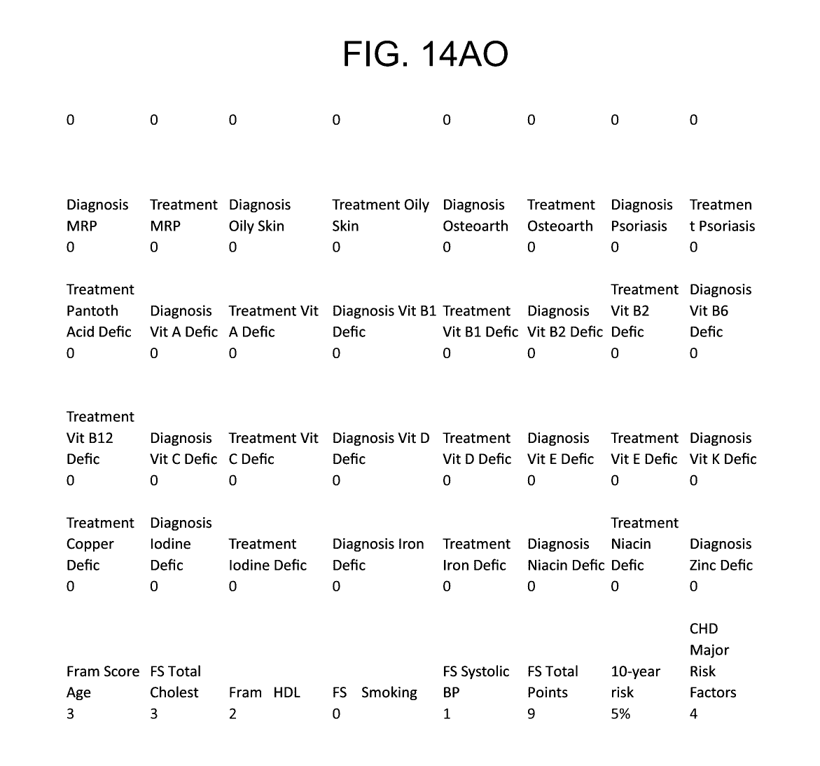

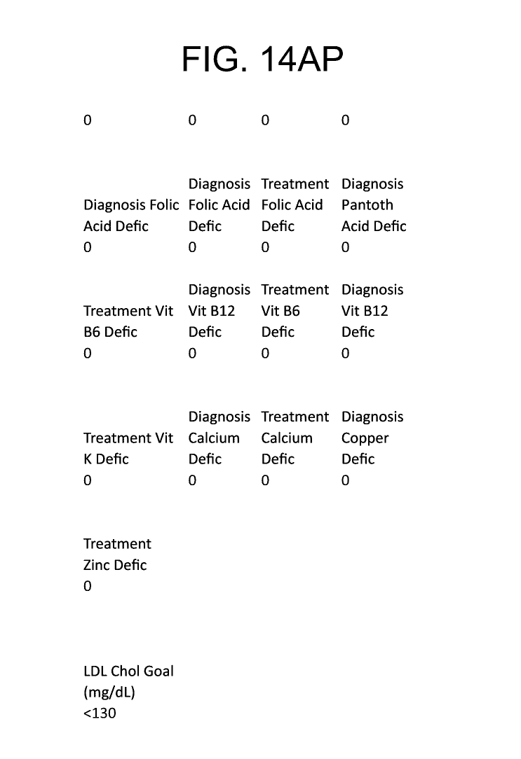

Reference is made to FIGS. 14A-14AP that include one input file, the Medical Questionnaire, and output files that include the Medial Responses, Data Analysis, and Medical Raw Data File. The Medical Questionnaire contains questions regarding the current health diagnoses of the subscriber, including their existing physical condition, previously identified, yet modifiable lifestyle risk factors, and documented family medical history. The Medical Questionnaire series of questions are purposely ordered so that each question builds upon the previous asked questions to answer more complex questions, so as to devolve a discrete individual subscriber profile, protected by a privacy agreement with each online subscriber.

### Physical Condition

In and embodiment, the physical condition section of the Medical Questionnaire screens online subscribers for previously diagnosed risk factors, e.g., hypertension, diabetes and cardiovascular disease (CVD), etc. The online subscriber's information will contain identification of gender, age and geographic location (zip/postal code). Such information obtained will be utilized to determine known risk factors for diseases such as CVD, and for documentation of existing individual baseline conditions relative to established clinical evidence of personal and/or regional disease risks.

Existing medical research and repeated clinical findings have determined that age is a non-modifiable risk factor for CVD and cardiovascular heart disease (CHD), if a male individual is 45 years or older, or if a female individual is 55 years of age or older. In the Medical Questionnaire, a subscriber's age is used in conjunction with the “Framingham scoring approach” in order to estimate 10-year risk for CHD. The “Framingham scoring approach” is widely accepted by both the scientific and medical research communities as a reliable assessment method. An individual's weight and height are used to determine overweight and obesity, a risk factor for many diseases including CHD, type II diabetes, dyslipidemia, and hypertension, which causes CVD complications. Body mass index (BMI) is also determined, which is a number and measure of body fat based on height and weight that applies to adult men and women. BMI is calculate as follows: weight (kilograms)/height (meters)2. Weight is converted to kilograms: pounds/2.2 and height is converted to meters: inches/39.37. A subscriber is evaluated and assigned a BMI number which falls into a range to determine whether or not they are potentially overweight or obese, and need weight-loss therapy. If their BMI is less than 18.5, the individual is considered underweight, and discrete weight gain is recommended in their individual health assessment report.

Such recommendations will include increasing calories and protein, and reducing saturated fats and cholesterol which are recorded for further assessment of disease risk in their individual nutrient intake profile. If the subscriber's BMI is 18.5 to 24.9, the individual is at an optimal weight, and a balanced dietary plan is recommended to maintain a healthy weight. If their BMI is 25 to 29.9, the individual is overweight, and if their BMI is 30 to 34.9, the individual is considered to be ‘obese class I,’ and in both cases, weight loss therapy includes a decrease of 500 calories per day, resulting in weight loss of ½ to 1 pound per week, and probable 10% weight loss from baseline weight in six months.

If the subscriber's BMI is greater than 35, a decrease of 500 to 1000 calories per day will be recommended, potentially resulting in weight loss of 1 to 2 pounds per week, and 10% weight loss from baseline weight within six months. If their BMI is 35 to 39.9, the individual is considered to be classified as obese class II, and if their BMI is greater or equal to 40, the individual is considered to be categorized as extreme obesity class III.

Physical inactivity has repeatedly proven to be an independent risk factor for obesity related medical conditions such as diabetes, elevated triglycerides, low HDL cholesterol, hypertension, CHD and other forms or CVD. Information obtained about the subscriber's physical inactivity is used to determine if this their potential risk factor. If they indicate through the questionnaires that they are predominately sedentary, then a cholesterol-lowering diet, blood pressure management, and glucose management will be recommended in their individual health report.

Physical activity questionnaire responses are also used to establish the subscribing individual's baseline energy requirements (EER/calorie intake) per day to maintain a healthy weight.

The recommendations for moderate physical activity are included in the individual subscriber's health report. BMI, waist circumference measurement (WC), and gender are used to determine relative risk and potential need to institute weight loss therapy. Abdominal obesity is defined for a male individual with WC greater than 40 inches (102 cm) and for a female individual with WC greater than 35 inches (88 cm). Abdominal obesity is a characteristic for dyslipidemia and metabolic syndrome, and an absolute risk factor in the presence of associated risk factors such as being overweight and trending toward obesity, and is clinically associated with increased risk for type II diabetes, dyslipidemia and hypertension, which causes CVD complications.

The presence of abdominal fat is a risk factor when BMI is markedly increased (25 to 34.9), or when an individual is under 5 feet high and BMI is greater than 34.9. If BMI is greater or equal to 34.9, waist circumference has little predictive power of disease risk beyond BMI. BMI ranges and WC calculations for relative risk, according to an embodiment, are included in the “Medical Assessment Formulae” section and program recommendations are addressed in the individual subscriber's health report.

Information provided by each subscriber answering accurately through the health assessment questionnaire about having been diagnosed or treated for obesity are critical to confirm the relative risk factor and the need for a weight loss therapeutic diet. Similarly, information obtained about the individual's weight-loss goals and overall health motivations are necessary for any individual weight loss dietary program to be successful. The individual subscriber has to be motivated to lose weight. If the individual does not want to lose weight, then the recommendations in the subscriber's health report will address at the least, maintaining weight and preventing further weight gain along while also addressing other individual risk factors.

### Modifiable Lifestyle Risk Factors

Smoking and having a family history of premature CHD are both cardiovascular disease risk factors. A family history of premature CHD is defined as myocardial infarction or sudden death of father, or other first male relative, at or before 55 years of age; or mother or other first female relative, at or before 65 years of age. If this is indicated, then family history presents evidence for a risk factor for CVD. Smoking is a modifiable risk factor for CHD, as are elevated triglycerides, low HDL cholesterol, and, in an embodiment, questions regarding these modifiable lifestyle risks are included in the individual health assessment questionnaire, and recommendations specific to responses appear in the health report of the lifestyle section. If the individual subscriber has a family history of diabetes, then lifestyle modifications are also recommended in the individual health report.

The lifestyle questions are coded as a recorded response: 0 for no, and 1 for yes.

Weight loss therapy should include reduction in saturated fat (to lower LDL cholesterol), total fats (30% or less of total calories) and reduction of carbohydrates. Physical activity should include at least 30 minutes walking or other moderate physical activity three times per week. After six months of weight-loss treatment, a weight maintenance program of dietary therapy, physical activity, and behavior therapy is recommended to prevent future weight gain.

Weight gain therapy should include reduction in saturated fat (to lower LDL cholesterol), total fats (30% or less of total calories) and reduction of carbohydrates and increase in protein and calories, then follow a healthy weight maintenance program prevent future weight loss.

Weight maintenance therapy should include dietary therapy—a reduction in saturated fat (to lower LDL cholesterol), total fats (30% or less of total calories) and reduction of carbohydrates physical activity, and behavior therapy is recommended to prevent future weight loss. Physical activity should include at least 30 minutes walking or other moderate physical activity three times per week.

### Medical Condition

In an embodiment, information obtained by the program about an individual subscriber's current medical condition is used to establish baselines to assist them in managing their health, and to identify individuals previously diagnosed with coronary heart disease (CHD), CHD equivalent, or are at risk because of multiple risk factors. Lipid and dietary goals vary depending on whether an individual has CHD or CHD equivalent medical conditions, or a number of risk factors, indicating risk for CHD. The 5 major risk factors for individuals without CHD or CHD risk equivalents are smoking, hypertension, low HDL cholesterol, family history of CHD and age. If an individual has three (3) or more of these risk factors, medical research indicates that the individual should follow a cholesterol lowering diet, and blood pressure management is also recommended.

In an embodiment, the program can assist Individual online subscribers that are overweight, including individuals who are overweight and have multiple health conditions to start with weight loss through a discrete dietary plan. Medical research indicates that Individuals that are overweight with multiple health conditions should start with weight loss. The subscriber should discuss with their primary physician utilization of the Therapeutic Lifestyle Change (TLC) diet specifying a ratio of 45%, 25%, 30% carbohydrates, proteins, and fats, respectively. If male 1200 to 1500 calories daily, and if female 1200 calories daily for a minimum of three months, then begin a discrete dietary management plan specific for their particular health condition. Exceptions to the utilizing the TLC diet model include incidence of arthritis, cancer, gallbladder disorders, gout, kidney disease, kidney stones with another dietary plan being more appropriate for the individual subscriber's health condition. The program's individual subscriber dietary plan can always be reviewed in consultation with their primary physician for further refinement. Reference is made in FIG. 10 to health conditions and associated macronutrient models for health management.

### Hypertension

Medical research has indicated that blood pressure is classified as optimal if 120 to 129/80 to 84 mmHg. If systolic blood pressure is greater or equal to 130 mmHg, or diastolic blood pressure is greater or equal to 85 mmHg, then individual has borderline high blood pressure (HBP) or prehypertension.

If systolic blood pressure is greater or equal to 140 mmHg, or diastolic blood pressure is greater or equal to 90 mmHg, then individual has HBP or hypertension. HBP 140 to 159/90 to 99 mmHg is classified as Hypertension Stage I and HBP 160 to 179/100 to 109 mmHg is classified as Hypertension Stage II.

Diagnosis and treatment of HBP are considered CHD equivalents. In an embodiment, if the user reports “yes” to being diagnosed or treated for HBP, or identified blood pressure is classified as pre-hypertension or hypertension, then the recorded response is 1 as CHD equivalent, and therapy is recommended which requires physician care. Since hypertension is an obesity related disorder, follow the TLC diet for 3 months, then follow a dietary model 55%, 20%, 25% ratio of carbohydrates, proteins, and fats, respectively.

Medical research has indicated that causes for developing hypertension may include excess body weight, excess sodium intake and inadequate potassium intake, reduced physical activity, and excess alcohol intake. Reduce sodium, increase potassium, increase physical activity and reduce alcohol intake is recommended.

Hypertension is a disease, and one of the risk factors for cardiovascular disease (CVD) complications such as heart attack, stroke, and kidney disease, and is commonly associated with diabetes and CVD associated with high levels of blood pressure (HBP). Medical research has indicated that modification of blood pressure and cholesterol in individuals with diabetes reduces CHD risk. Medical research has indicated that the cholesterol lowering goal for an individual with CHD and CHD equivalents is to lower LDL cholesterol to less than 100 mg/dL. Questions for (HBP) and high LDL cholesterol are essential to determine if an individual has hypertension, a major risk factor for CHD and whether to modify goals for lowering LDL cholesterol. Medical research has indicated that treating hypertension reduces the risk of myocardial infarction, stroke, heart failure, and death.

Medical research has further indicated that other non-lipid risk factors for CHD include obesity, physical inactivity, and a diet high in cholesterol and saturated fat. Other non-lipid non-modifiable risk factors include age, male sex, and family history. Reducing obesity and increasing physical activity are recommended as part of lifestyle modifications necessary to reduce risk of CHD beyond LDL cholesterol-lowering therapy. Men have a higher risk for CHD than do women at all ages, accept if 80 years old or older.

Both medical and nutritional research support dietary lifestyle changes for LDL lowering therapy in prevention of CHD in individuals at increased risk. An atherogenic diet low in saturated fat and cholesterol is recommended to achieve normal lipid goals.

### High LDL Cholesterol

Medical research has indicated that high LDL cholesterol is a risk factor for CHD/CVD. In an embodiment, information is obtained through the subscriber's responses to the Medical Questionnaire for high cholesterol and need for lipid therapy, and whether an individual has a LDL cholesterol risk factor. If LDL cholesterol is greater than or equal to 160 mg/dL, then CHD/CVD is a risk factor. LDL cholesterol is classified as ‘optimal’ if less than 100 mg/dL, ‘above optimal’ if 100 to 129 mg/dL, ‘borderline high’ if 130 to 159 mg/dL, ‘high’ if greater than or equal to 190 mg/dL. Medical research findings resulting from clinical trials indicate a strong causal relationship between elevated LDL cholesterol and CHD. Treatment for LDL cholesterol should follow ATP III recommendation for individuals with established CHD (optimal LDL cholesterol goal, increased physical activity, smoking cessation, and a lower carbohydrate intake). Since low HDL is an obesity related disorder, these findings recommend following the TLC diet for 3 months, then following a dietary model 55%, 20%, 25% ratio of carbohydrates, proteins, and fats, respectively.

### Low HDL Cholesterol

HDL cholesterol is classified as ‘low HDL cholesterol’ if less than 40 mg/dL, ‘high HDL cholesterol’ if greater than or equal to 60 mg/dL. Low HDL cholesterol is a risk factor for CHD/CVD and recorded as 1 in the raw data file. Medical research has indicated that causes of low HDL cholesterol are elevated serum triglycerides, overweight and obesity, physical inactivity, smoking, very high carbohydrate intake (greater than 60% of daily caloric intake), type II diabetes, certain drugs (beta blockers, anabolic steroids) and genetic factors. Clinical trials suggest that raising HDL cholesterol levels through increased physical activity, smoking cessation, and a lower carbohydrate intake will reduce CHD risk. Since low HDL is an obesity related disorder, follow TLC for 3 months, then follow a dietary model 55%, 20%, 25% ratio of carbohydrates, proteins, and fats, respectively.

### Total Cholesterol, High Serum Triglycerides and Related Diseases

In an embodiment, information about total cholesterol is obtained by the Medical Questionnaire for each online subscriber in order to collect data for non-HDL factors. Medical research indicates that clinical classification of total cholesterol is ‘desirable’ if less than 200 mg/dL, ‘borderline high’ if 200 to 239 mg/dL, ‘high’ if greater than or equal to 240 mg/dL.

Information about triglycerides is also obtained to identify elevated serum triglycerides associated with increased risk for CHD. Medical research indicates that clinical classification is ‘normal’ if less than or equal to 150 mg/dL, ‘borderline high’ if 150 to 199 mg/dL, ‘high’ if 200 to 499 mg/dL, ‘very high’ if greater or equal to 50 mg/dL. High serum triglycerides are usually accompanied by lower HDL cholesterol. Medical research indicates that causes of elevated serum triglycerides are overweight and obesity, physical activity, smoking, excess alcohol intake, very high carbohydrate diet (greater than 60% calories), other diseases (type II diabetes, chronic renal failure, certain drugs (corticosteroids, estrogens) and genetic factors. Individuals with high serum triglycerides are at increased risk for acute pancreatitis and must undergo immediate triglyceride lowering drug therapy. Medical research indicates that therapeutic lifestyle changes to lower triglycerides include weight loss management, increased physical activity and smoking cessation. These lifestyle changes will reduce the risk factors, characteristics of metabolic syndrome, reduce overall CVD risk, and reduce type II diabetes commonly associated with high cholesterol. Since high cholesterol is an obesity related disorder, follow TLC for 3 months, then follow a dietary model 55%, 20%, 25% ratio of carbohydrates, proteins, and fats, respectively.

### Metabolic Syndrome

Medical research indicates that metabolic syndrome is characterized by overweight and obesity, abdominal obesity, atherogenic dyslipidemia, raised blood pressure, insulin resistance, and serum triglyceride levels borderline high or high. Metabolic syndrome will likely increase in the next few years primarily because of increased prevalence of obesity. The prevalence of metabolic syndrome is age dependent. Recent medical research indicates that seven percent (7%) of adults 20 to 29 years of age are diagnosed with metabolic syndrome, which is predicted to rise to approximately 40% or more among adults over age 60 in the next decade.

Clinical identification of metabolic syndrome includes abdominal obesity (WC greater than 40 inches (102 cm) in men; WC greater than 35 inches (88 cm) in women, triglycerides borderline high or high, low HDL cholesterol (HDL cholesterol lower than 40 mg/dL in men; HDL cholesterol lower than 50 mg/dL in women), BP greater than or equal to 130/85 mmHg, and fasting glucose greater than or equal to 110.

Medical research indicates that emphasis should be placed on modifying the risk factors of metabolic syndrome (overweight/obesity and physical inactivity) and LDL lowering therapy. In addition, other non-lipid and lipid risk factors should be treated. Clinical management of metabolic syndrome includes treating overweight and obesity, increased physical activity, and treating pre-hypertension and hypertension with lifestyle modifications. Weight reduction and increased physical activity reduces insulin resistance in overweight and obese individuals and modifies metabolic risk factors. Lowering blood pressure also reduces metabolic risk. Since metabolic syndrome is an obesity related disorder, follow TLC for 3 months, or an extension of time by subscriber's physician, then follow a dietary model 50%, 20%, 30% ratio of carbohydrates, proteins, and fats, respectively.

### Atherogenic Dyslipidemia

Medical research indicates that atherogenic dyslipidemia is characterized by elevated serum triglycerides (greater than or equal to 150 mg/dL), small LDL particles, and low HDL cholesterol (less than or equal to 40 mg/dL). This condition commonly occurs in individuals with premature CHD. Causes of dyslipidemia are premature CHD, obesity, abdominal obesity, insulin resistance, physical inactivity, type II diabetes (many persons with type II diabetes have atherogenic dyslipidemia). If an individual has the above factors and elevated LDL cholesterol, then diagnosis is of secondary dyslipidemia. Causes of secondary dyslipidemia include diabetes, hypothyroidism, nephritic syndrome, liver disease, and certain drugs (anabolic steroids, etc.).

Medical research indicates that weight reduction and increased physical activity will mitigate atherogenic dyslipidemia and reduce risk for CHD. Since atherogenic dyslipidemia is an obesity related disorder, follow TLC for 3 months, or an extension of time by subscriber's physician, then follow a dietary model 50%, 20%, 30% ratio of carbohydrates, proteins, and fats, respectively.

### Diabetes

Medical research indicates that individuals with diabetes type II should be managed as CHD risk equivalent. Diabetes type II (diabetes) is diagnosed if fasting plasma (FPG) is greater than or equal to 126 mg/dL. If FPG is 110 to 125, individual should be tested regularly. Another test for diabetes type II is Hemoglobin A1c (A1c). Diabetes is diagnosed if A1c is greater than or equal to 6.5% and pre-diabetes is diagnosed if A1c is 5.7 to 6.5%. Lowering A1c to below 6.5% has been shown in clinical studies to reduce microvascular and neuropathic complications of diabetes.

Medical research indicates that testing for diabetes and assessing risk for future diabetes should be considered in adults of any age who are overweight or obese. Individuals with diabetes or pre-diabetes and overweight or obese are associated with insulin resistance. Modest weight loss has been shown to reduce risk factors for diabetes and reduce insulin resistance. Since diabetes or pre-diabetes is an obesity related disorder, follow the TLC diet for 3 months, or an extension of time prescribed by the subscriber's physician, or until weight loss of 7% of body weight, then follow a dietary model 50%, 20%, 30% ratio of carbohydrates, proteins, and fats, respectively. Medical research provides recommendations for individuals to increase physical activity to at least 150 minutes per week of moderate activity such as walking, and to talk with their physician to monitor lipid profiles, renal function, and protein intake and adjust hypoglycemic therapy as needed.

### Kidney Disease

Medical research indicates that chronic kidney disease (CKD), also known as chronic renal disease, is a progressive loss of renal function over a period of months or years. CKD is defined as either reduced excretory function with a glomerular filtration rate (GFR) less than 60, or the presence of albuminuria greater than 300 mg/d. Microalbuminuria 30 to 300 is associated with CVD risk in diabetics. Systolic BP correlates with renal disease progression in diabetics. The Seventh Report of the Joint National Committee (JNC) on Prevention, Detection, Evaluation, and Treatment of High Blood Pressure (2014), recommends that BP in diabetics be controlled to levels of 130/80 or lower. The joint recommendation of the American Society of Nephrology and the National Kidney Foundation recommends goal for BP for all CKD patients of less than 130/80 mmHg.

In an embodiment, the program recommends that individual online subscribers discuss all such health risks with their primary physician if necessary in order to properly monitor BP profiles, renal function, and protein intake and adjust calories and macronutrient model as needed.

### Vitamin and Mineral Deficiencies

In and embodiment, vitamin and mineral deficiencies are identified through the program assessment questionnaires and provides recommendations in order to increase those nutrients in the online subscriber's dietary intake.

### Other Diseases

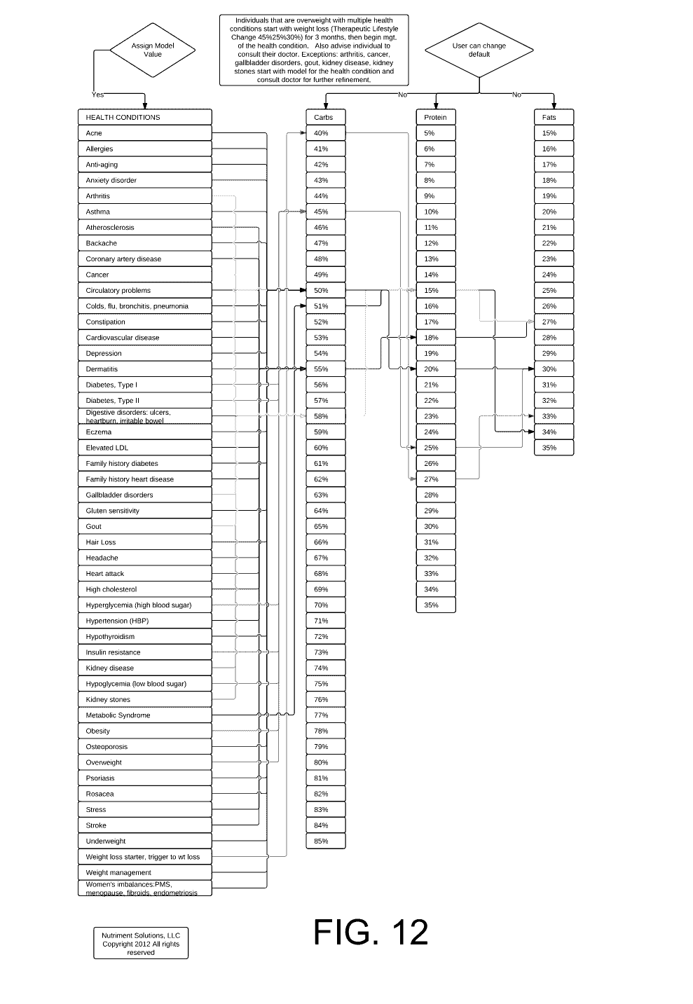

Reference is made in FIG. 12 to health conditions and associated macronutrient models.

### Medical Raw Data File

Reference is made to the Medical Raw Data File in FIG. 9d. In and embodiment, the Medical Raw Data File 1.0 includes ID number, date, gender, weight, age, height, physical activity, and waist circumference (WC) measurement, and goes through all the individual online subscriber's answers to all assessment questions. Every online subscriber answer is coded as a recorded response, 0 for no, and 1 for yes.

In an embodiment, Medical Raw Data File 1.1 analyzes the data recorded in raw date file 1.0. Line 1 of the raw date file 1.1 includes ID number, date, gender, weight, CVD and CHD reference age, height, physical activity coefficient, BMI, EER, abdominal obesity factor and relative risk for CVD (recorded response: increased risk is 1; high risk is 2; very high risk is 3; and extremely high risk is 4). Line 2 of the program raw date file 1.1 gathers information about major risk factors for CVD and CHD. Major risk factors for CVD and CHD (age, smoking, hypertension, high LDL, low HDL, impaired fasting glucose (IFG) and diabetes, family history of premature CHD) are coded as 0 for no, and 1 for yes. Total number of major risk factors contributing to development of CVD/CHD are also recorded.

Next, modifiable risk factors for CHD (hypertension, smoking, diabetes, overweight/obesity, physical inactivity, diet high in saturated fat, cholesterol) identified through the subscriber assessment answers are coded as 0 for no, and 1 for yes. Total number of modifiable risk factors CVD are also recorded.

Next, non-modifiable risk factors for CHD (age, male sex, family history CHD) are coded as 0 for no, and 1 for yes. Total number of non-modifiable risk factors CHD/CVD are also recorded.

Line 3 of the raw data file 1.1 gathers information about known causes of high serum triglycerides. Known causes of high serum triglycerides (overweight/obesity, sedentary selectivity, smoking, excess alcohol intake, high carbohydrate intake greater than 60% calories, other diseases, genetic factors) are coded as 0 for no, and 1 for yes.

Line 4 of the raw data file 1.1 gathers information about known causes of low HDL cholesterol. Causes of low HDL cholesterol (elevated triglycerides, overweight/obesity, sedentary physical activity, smoking, high carbohydrate intake greater than 60% calories, type II diabetes, certain drugs, genetic factors) are coded as 0 for no, 1 for yes.

Line 5 of the program gathers information about atherogenic dyslipidemia. Known characteristics of atherogenic dyslipidemia (premature CHD, overweight and obesity, abdominal obesity, insulin resistance, sedentary physical activity, diabetes type II) are coded as 0 for no, 1 for yes. Line 5 also gathers information about metabolic syndrome. Known characteristics of metabolic syndrome (overweight obesity, abdominal obesity, atherogenic dyslipidemia, high blood pressure, insulin resistance, high serum triglycerides) are coded as 0 for no, 1 for yes.

Line 6 of the program gathers information about known clinical markers for metabolic syndrome. Clinical markers (abdominal obesity, WC, high triglycerides, low HDL cholesterol, blood pressure, IFG) are coded as 0 for no, 1 for yes. Line 6 also gathers information for known CHD diagnostic markers. Subscriber assessment answers to questions regarding such clinical markers for diagnosis of CHD (history of acute myocardial infarction, evidence of silent myocardial infarction, history of unstable angina, history of coronary procedures, and the existence of CHD equivalents) are coded as 0 for no, 1 for yes.

Line 7 of the subscriber assessment gathers information about CHD equivalents (clinical atherosclerotic diseases, peripheral artery disease, abdominal aortic disease, carotid artery disease, diabetes type II, and multiple risk factors 2+).

Line 8 of the subscriber assessment gathers information about their existing diagnosis and/or treatment for CHD equivalent diseases. The remainder sections gather information about their existing diagnosis and treatment of other diseases, and their existing diagnosis and treatment of vitamin and mineral deficiencies.

### Referenced Clinical Approach to Lifestyle Modification

Reference is made to FIG. 9b and FIG. 9c (Data Analysis) that includes the FRAMINGHAM assessment tool included in the ATP III report to estimate the subscriber's 10-year risk for developing CHD. Points are assigned to certain health markers for men and women evidenced for an increased CHD risk, then added together to obtain a total score, for men ≧15 and for women ≧23 means that individual subscriber's 10-year CHD risk is 20% or higher, therefore the program will recommend that this particular subscriber follow a “Therapeutic Lifestyle Change (TLC)” (saturated fat <7% calories, total fat <30% calories, and cholesterol ≦200 mg per day), and make therapeutic lifestyle changes (weight reduction and increased physical activity). The numerical index indicating that such changes need to be made for men is 12-15, and for women 20-22, which means that those particular subscriber's 10-year CHD risk is 10-20% above average, and the program will recommend that the affected subscriber follow a “Heart-Healthy Diet” (saturated fat <10% calories, total fat <30% calories, and cholesterol ≦300 mg per day), and make therapeutic lifestyle changes (weight reduction and increased physical activity). A numerical index for men <12, and for women <20, means that the particular subscriber's 10-year CHD risk is less than 10% above average, and the program will recommend that the affected subscriber make therapeutic lifestyle changes (weight reduction and increased physical activity). These specific recorded subscriber responses are coded in the raw data file.

If a program subscriber currently has CHD risk equivalents, then the LDL cholesterol goal is <100 mg/dL. If a subscriber has previously been medically diagnosed with metabolic syndrome, then TLC needs to be implemented. If a program subscriber has a 0-1 CHD risk factors, then the LDL cholesterol goal is <160 mg/dL, and TLC needs to be implemented.

If a program subscriber currently has two or more CHD risk factors and 10-year CHD risk is greater than 20%, then the LDL cholesterol goal is <100 mg/dL. If a subscriber currently has two or more CHD risk factors, 10-year CHD risk is greater than 20%, and LDL cholesterol is >100 mg/dL, then TLC needs to be implemented.

If a program subscriber has two or more CHD risk factors and 10-year CHD risk is 10 to 20%, then the LDL cholesterol goal is <130 mg/dL. If a subscriber has two or more CHD risk factors, 10-year CHD risk is 10 to 20%, and LDL cholesterol >130 mg/dL, then TLC needs to be implemented.

If a program subscriber has two or more CHD risk factors and 10-year CHD risk is less than 10%, then the LDL cholesterol goal is <130 mg/dL. Ifs subscriber has two or more CHD risk factors, 10-year CHD risk is less than 10%, and LDL cholesterol is >130 mg/dL, then TLC needs to be implemented.

### Subscriber Medical Report

In an embodiment, the program subscriber medical report is divided into four categories: medical fields, current status, subscriber medical goals, and recommendations. For example, the medical fields include physical condition markers such as weight, WC, BMI, family medical history, known personal medical markers such as BP, cholesterol, CHD equivalent status, CHD diagnosis and treatment, CHD risk factors and 10-year risk, other medically diagnosed conditions, and known nutrient deficiencies and treatment. The program subscriber's current medical status and prescribed medical goals are continuously updated by the subscriber in their individual program profile and ongoing health report. The program will provide discrete recommendations for each individual subscriber to increase, decrease or maintain various medical condition markers, indicate reductions for identified risk factors, and document interactive physician care and prescriptive therapies.

### Summary

The systems and methods of the present invention are able to maintain a specific level of macronutrient intake while simultaneously maintaining a discrete daily caloric intake level. The systems and methods are able to maintain different ratios of macronutrients at pre-selected caloric levels, while still allowing an individual user to choose any food while simultaneously maintaining such a pre-selected ratio of macronutrients. The systems and methods are able to accomplish this in spite of the fact that total caloric level and/or total contribution of a specific macronutrient change by selection of food types (which then correspondingly change other macronutrients, as well as macronutrient ratios).

### Dietary Assessment Formulae

In an embodiment, by using the foregoing Dietary Questionnaire responses, for the fruit (f) food group, the formula for daily fruit carbohydrate intake is:

Aw=(DEF*Chf)*PSF.

Where Aw=total fruit carbohydrates in grams, DEF=0.57, Chf=17, and PSF=2. The formula for the daily fruit protein intake is:

As=(DEF*Prof)*PSF.

Where As=total protein in grams, DEF=0.57, and Prof=1, and PSF=2. The formula for the fat component is:

Au=(DEF*Tfm)*PSF.

Where Au=total fat in grams, DEF=0.57, Tff=0.21, and PSF=2. The formula for the daily fruit calories is:

kcalf=Aw*kcalch+As*kcalpro+Au*kcaltf.

Where Aw=daily fruit carbohydrate intake in grams, As=daily fruit protein intake in grams, Au=daily fruit fat intake in grams, kcalch=4, kcalpro=4, and kcaltf=9.

In an embodiment, the values of the program formula constants represent the total calories per gram of carbohydrates, proteins, and fats, respectively. Variations of the formulae employed were devolved as appropriate for other food groups and food subgroups.

For the vegetable food group, the formula for daily vegetable carbohydrate intake in grams is:

Awveg=((DEFdg*Chdg)*PSF)+((DEFo*Cho)*PSF)+((DEFov*ChOV)*PSF);

### Where Chdg=4, Cho=7, Chov=4, DEFdg=0.57 (4/7), DEFo=0.29 (2/7), DEFov=0.57 (4/7), and PSF=2.

The formula for the daily fruit protein intake in grams is:

Asveg=((DEFdg*Prodg)*PSF)+((DEFo*Proo)*PSF)+((DEFov*ProOV)*PSF);

### Where As=Prodg=4, Proo=7, Proov=4, DEFdg=0.57 (4/7), DEFo=0.29 (2/7), DEFov=0.57 (4/7), and PSF=2.

The formula for the daily fruit fat intake in grams is:

Auveg=((DEFdg*Tfdg)*PSF)+((DEFo*Tfo)*PSF)+((DEFdg*TfOV)*PSF);

### Where Au=Tfdg=4, Tfo=7, Tfov=4, DEFdg=0.57 (4/7), DEFo=0.29 (2/7), DEFov=0.57 (4/7), and PSF=2.

The formula for the daily vegetable calories is:

kcalveg=Awveg*kcalch+Asveg*kcalpro+Auveg*kcaltf

Where Aw=daily vegetable carbohydrate intake in grams, As=daily vegetable protein intake in grams, Au=daily vegetable fat intake in grams, kcalch=4, kcalpro=4, and kcaltf=9.

For the starch food group, the formula for daily starch carbohydrate intake is:

Aws=((DEFbns*Chs)*PSFbns)+((DEFs*Chs)*PSFs)+((DEFbrd*Chs)*PSFbrd)+((DEFcrl*Chs)*PSFcrl)+((DEFpa*Chs)*PSFpa)+((DEFsv*Chs)*PSFsv)+((DEFsna*Chs)*PSFsna);

Where Chs=16, Beans DEFbns=0.14 (1/7), Grains DEFs=0.29 (2/7), Bread DEFbrd=0.57 (4/7), Cereal DEFcrl=0.57 (4/7), Pasta DEFpa=0.14 (1/7), Starchy Vegetable DEFsv=0.29 (2/7), Snacks DEFsna=0.57 (4/7), Beans PSFbns=1.00, Grains PSFs=1.00, Bread PSFbrd=1.00, Cereal PSFcrl=1.00, Pasta PSFpa=1.00, Starchy Vegetable PSFsv=1.00, Crackers PSFsna=1.00.

The formula for the daily starch protein intake is:

Ass=((DEFbns*Pros)*PSFbns)+((DEFs*Pros)*PSFs)+((DEFbrd*Pros)*PSFbrd)+((DEFcrl*Pros)*PSFcrl)+((DEFpa*Pros)*PSFpa)+((DEFsv*Pros)*PSFsv)+((DEFsna*Pros)*PSFsna);

Where Pros=2, Beans DEFbns=0.14 (1/7), Grains DEFs=0.29 (2/7), Bread DEFbrd=0.57 (4/7), Cereal DEFcrl=0.57 (4/7), Pasta DEFpa=0.14 (1/7), Starchy Vegetable DEFsv=0.29 (2/7), Snacks DEFsna=0.57 (4/7), Beans PSFbns=1.00, Grains PSFs=1.00, Bread PSFbrd=1.00, Cereal PSFcrl=1.00, Pasta PSFpa=1.00, Starchy Vegetable PSFsv=1.00, Crackers PSFsna=1.00.

The formula for the daily starch fats intake is:

Aus=((DEFbns*Tfs)*PSFbns)+((DEFs*Tfs)*PSFs)+((DEFbrd*Tfs)*PSFbrd)+((DEFcrl*Tfs)*PSFcrl)+((DEFpa*Tfs)*PSFpa)+((DEFsv*Tfs)*PSF)+((DEFsna*Tfs)*PSF);

Where Tfs=1, Beans DEFbns=0.14 (1/7), Grains DEFs=0.29 (2/7), Bread DEFbrd=0.57 (4/7), Cereal DEFcrl=0.57 (4/7), Pasta DEFpa=0.14 (1/7), Starchy Vegetable DEFsv=0.29 (2/7), Snacks DEFsna=0.57 (4/7), Beans PSFbns=1.00, Grains PSFs=1.00, Bread PSFbrd=1.00, Cereal PSFcrl=1.00, Pasta PSFpa=1.00, Starchy Vegetable PSFsv=1.00, Crackers PSFsna=1.00.

The formula for the daily starch calories is:

kcals=Aws*kcalch+Ass*kcalpro+Aus*kcaltf

Where Aws=daily starch carbohydrate intake in grams, Ass=daily starch protein intake in grams, Aus=daily starch fat intake in grams, kcalch=4, kcalpro=4, and kcaltf=9.

For the meat and meat substitutes food group, the formula for daily meat and meat substitutes carbohydrate intake is:

Awm=((DEFrm*Chm)*PSFrm)+((DEFpou*Chm)*PSFpou)+((DEFpk*Chm)*PSFpk)+((DEFsea*Chm)*PSFsea)+((DEFeg*Chm)*PSFeg)+((DEFvp*Chvp)*PSFvp);

Where Chmm=0, Chvp=3, Red Meat DEFrm=0.57 (4/7), Poultry DEFpou=0.29 (2/7), Pork DEFpk=0.57 (4/7), Seafood DEFsea=0.57 (4/7), Eggs DEFeg=0.14 (1/7), Vegetable Protein DEFvp=0.29 (2/7), Red Meat PSFrm=1.00, Poultry PSFpou=1.00, Pork PSFpk=1.00, Seafood PSFsea=1.00, Eggs PSFeg=1.00, Vegetable PSFvp=1.00.

The formula for the daily meat and meat substitute's protein intake is:

Asm=((DEFrm*Prom)*PSFrm)+((DEFpou*Prom)*PSFpou)+((DEFpk*Prom)*PSFpk)+((DEFsea*Prom)*PSFsea)+((DEFeg*Prom)*PSFeg)+((DEFvp*Provp)*PSFvp);

Where Promm=8, Provp=8, Red Meat DEFrm=0.57 (4/7), Poultry DEFpou=0.29 (2/7), Pork DEFpk=0.57 (4/7), Seafood DEFsea=0.57 (4/7), Eggs DEFeg=0.14 (1/7), Vegetable Protein DEFvp=0.29 (2/7), Red Meat PSFrm=1.00, Poultry PSFpou=1.00, Pork PSFpk=1.00, Seafood PSFsea=1.00, Eggs PSFeg=1.00, Vegetable PSFvp=1.00.

The formula for the daily meat and meat substitute's fat intake is:

Aum=((DEFrm*Tfm)*PSFrm)+((DEFpou*Tfm)*PSFpou)+((DEFpk*Tfm)*PSFpk)+((DEFsea*Tfm)*PSFsea)+((DEFeg*Tfm)*PSFeg)+((DEFvp*Tfvp)*PSFvp);

Where Tfm=2.7, Tfvp=2.7, Red Meat DEFrm=0.57 (4/7), Poultry DEFpou=0.29 (2/7), Pork DEFpk=0.57 (4/7), Seafood DEFsea=0.57 (4/7), Eggs DEFeg=0.14 (1/7), Vegetable Protein DEFvp=0.29 (2/7), Red Meat PSFrm=1.00, Poultry PSFpou=1.00, Pork PSFpk=1.00, Seafood PSFsea=1.00, Eggs PSFeg=1.00, Vegetable PSFvp=1.00.

The formula for the daily meat, and meat substitute food calories is:

Kcalm+vp=Awm*kcalch+Asm*kcalpro+Aum*kcaltf

Where Awm=daily meat and meat substitutes carbohydrate intake in grams, Asm=daily meat and meat substitutes protein intake in grams, Aum=daily meat and meat substitutes fat intake in grams, kcalch=4, kcalpro=4, and kcaltf=9.

For the dairy food group, the formula for daily dairy carbohydrate intake is:

Awd=((DEFmlk*Chd)*PSFmlk)+((DEFy*Chd)*PSFy)+((DEFchee*Chd)*PSFchee);

### Where Chd=12, Milk DEFmlk=0.14 (1/7), Yogurt DEFy=0.29 (2/7), Cheese DEFchee=0.57 (4/7), Milk PSFmlk=1.00, Yogurt PSFmlk=1.00, Cheese PSFchee=1.00.

The formula for the daily dairy protein intake is:

Asd=((DEFmlk*Prod)*PSFmlk)+((DEFy*Prod)*PSFy)+((DEFchee*Prod)*PSFchee);

### Where Prod=8, Milk DEFmlk=0.14 (1/7), Yogurt DEFy=0.29 (2/7), Cheese DEFchee=0.57 (4/7), Milk PSFmlk=1.00, Yogurt PSFmlk=1.00, Cheese PSFchee=1.00.

The formula for the daily dairy fats intake is:

Aud=((DEFmlk*Tfd)*PSFmlk)+((DEFy*Tfd)*PSFy)+((DEFchee*Tfd)*PSFchee);

### Where Tfd=0.2, Milk DEFmlk=0.14 (1/7), Yogurt DEFy=0.29 (2/7), Cheese DEFchee=0.57 (4/7), Milk PSFmlk=1.00, Yogurt PSFmlk=1.00, Cheese PSFchee=1.00.

The formula for the daily dairy calories is:

kcals=Awd*kcalch+Asd*kcalpro+Aud*kcaltf

Where Awd=daily starch carbohydrate intake in grams, Asd=daily starch protein intake in grams, Aud=daily starch fat intake in grams, kcalch=4, kcalpro=4, and kcaltf=9.

For the table fats food group, the formula for daily carbohydrate intake is:

Awfa=(DEFfa*Chfa)*PSFsd

Where Chfa=0, Table fats DEFfa=1.00 (7/7), Salad dressing PSFsd=1.00.

The formula for the daily table fats protein intake is:

Asfa=(DEFfa*Profa)*PSFsd

Where Profa=0, Table fats DEFfa=1.00 (7/7), Salad dressing PSFsd=1.00.

The formula for the daily table fats fat intake is:

Aufa=(DEFfa*Tffa)*PSFsd

Where Tffa=4.5, Table fats DEFfa=1.00 (7/7), Salad dressing PSFsd=1.00.

The formula for the daily table fats calories is:

kcalfa=Awfa*kcalch+Asfa*kcalpro+Aufa*kcaltf

Where Awfa=daily table fats carbohydrate intake in grams, Asfa=daily table fats protein intake in grams, Aufa=daily table fats fat intake in grams, kcalch=4, kcalpro=4, and kcaltf=9.

For the baked foods group, the formula for daily carbohydrate intake is:

Awbf=(DEFbf*Chs)*PSFbf

### Where Chs=16, DEFbf=1.00 (7/7), PSFbf=1.00.

The formula for the daily baked foods protein intake is:

Asbf=(DEFbf*Pros)*PSFbf

### Where Pros=2, DEFbf=1.00 (7/7), PSFbf=1.00.

The formula for the daily baked foods fat intake is:

Aubf=(DEFbf*Tfs)*PSFbf

### Where Tfs=1, DEFbf=1.00 (7/7), PSFbf=1.00.

The formula for the daily baked foods calories is:

kcalbf=Awbf*kcalch+Asbf*kcalpro+Aubf*kcaltf

Where Awbf=daily baked foods carbohydrate intake in grams, Asbf=daily baked foods protein intake in grams, Aubf=daily baked foods fat intake in grams, kcalch=4, kcalpro=4, and kcaltf=9.

For the convenience foods group, the formula for daily carbohydrate intake is:

Awcf=(DEFcf*Chs)*PSFcf

### Where Chs=16, DEFcf=1.00 (7/7), PSFcf=1.00.

The formula for the daily convenience foods protein intake is:

Ascf=(DEFcf*Pros)*PSFcf

### Where Profa=2, DEFcf=1.00 (7/7), PSFcf=1.00.

The formula for the daily convenience foods fat intake is:

Aucf=(DEFcf*Tfs)*PSFcf

### Where Tfs=1, DEFcf=1.00 (7/7), PSFcf=1.00.

The formula for the daily convenience foods calories is:

kcalcf=Awcf*kcalch+Ascf*kcalpro+Aucf*kcaltf

Where Awcf=daily convenience food carbohydrate intake in grams, Ascf=daily convenience food protein intake in grams, Aucf=daily convenience food fat intake in grams, kcalch=4, kcalpro=4, and kcaltf=9.

For the sweets food group, the formula for daily carbohydrate intake is:

Awsw=(DEFsw*Chs)*PSFsw

### Where Chs=16, DEFsw=1.00 (7/7), PSFsw=1.00.

The formula for the daily sweets food protein intake is:

Assw=(DEFsw*Pros)*PSFsw

### Where Pros=2, DEFsw=1.00 (7/7), PSFsw=1.00.

The formula for the daily sweets food fat intake is:

Ausw=(DEFsw*Tfs)*PSFsw

### Where Tfs=1, DEFsw=1.00 (7/7), PSFsw=1.00.

The formula for the daily sweets food calories is:

kcalsw=Awsw*kcalch+Assw*kcalpro+Ausw*kcaltf

Where Awsw=daily sweets carbohydrate intake in grams, Assw=daily sweets protein intake in grams, Ausw=daily sweets fat intake in grams, kcalch=4, kcalpro=4, and kcaltf=9.

### Medical Assessment Formulae

In an embodiment, weight (kilograms), age (years), height (meters), and physical coefficients are used to calculate daily calorie requirements:

1. If male or female 13-35 months, then EER=(89*WT−100)+20.

2. If male 3-8 years, then EER=88.5−(61.9*AGE)+PA*(26.7*WT+903*HT)+20.

3. If male 9-18 years, then EER=88.5−(61.9*AGE)+PA*(26.7*WT+903*HT)+25.

4. If male 19 years and older, then EER=662−(9.53*AGE)+PA*(15.91*WT+539.6*HT)

5. If female 3-8 years, then EER=135.3−(30.8*AGE)+PA*(10*WT+934*HT)+20

6. If female 9-18 years, then EER=135.3−(30.8*AGE)+PA*(10*WT+934*HT)+25

7. If female 19 years and older, then EER=354−(6.91*AGE)+PA*(9.36*WT+726*HT)

Age, gender, and physical activity are used to calculate the following physical coefficients:

1. If male is 3-18 years old and sedentary physical activity, then PA coefficient=1.00

2. If male is 3-18 years old and low active physical activity, then PA coefficient=1.13.

3. If male is 3-18 years old and active (physical activity, then PA coefficient=1.26.

4. If male 19 years and older and sedentary physical activity, then PA coefficient=1.00.

5. If male 19 years and older and low active physical activity, then PA coefficient=1.11.

6. If male 19 years and older and active physical activity, then PA coefficient=1.25.

7. If female is 3-18 years old and sedentary physical activity, then PA coefficient=1.00

8. If female is 3-18 years old and low active physical activity, then PA coefficient=1.16.

9. If female is 3-18 years old and active (physical activity, then PA coefficient=1.31.

10. If female 19 years and older and sedentary physical activity, then PA coefficient=1.00.

11. If female 19 years and older and low active physical activity, then PA coefficient=1.12.

12. If female 19 years and older and active physical activity, then PA coefficient=1.27.

BMI ranges and WC calculations for relative risk, according to an embodiment, are included below and program recommendations are addressed in the individual subscriber's health report.

1. If male and BMI 25 to 29.9 kg/m² and WC ≦40″ (102 cm), then increased disease risk.

2. If male and BMI 25 to 29.9 kg/m² and WC >40″ (102 cm), then high disease risk.

3. If male and BMI 30 to 34.9 kg/m² and WC ≦40″ (102 cm), then high disease risk.

4. If male and BMI 30 to 34.9 kg/m² and WC >40″ (102 cm), then very high disease risk.

5. If male and BMI 35 to 39.9 kg/m² and WC ≦40″ (102 cm), then very high disease risk.

6. If male and BMI 35 to 39.9 kg/m² and WC >40″ (102 cm), then very high disease risk.

7. If male and BMI ≧40 kg/m² and WC ≦40″ (102 cm), then extremely high disease risk.

8. If male and BMI ≧40 kg/m² and WC >40″ (102 cm), then extremely high disease risk.

9. If female and BMI 25 to 29.9 kg/m² and WC ≦35″ (88 cm), then increased disease risk.

10. If female and BMI 25 to 29.9 kg/m² and WC >35″ (88 cm), then high disease risk.

11. If female and BMI 30 to 34.9 kg/m² and WC ≦35″ (88 cm), then high disease risk.

12. If female and BMI 30 to 34.9 kg/m² and WC >35″ (88 cm), then very high disease risk.

13. If female and BMI 35 to 39.9 kg/m² and WC ≦35″ (88 cm), then very high disease risk.

14. If female and BMI 35 to 39.9 kg/m² and WC >35″ (88 cm), then very high disease risk.

15. If female and BMI ≧40 kg/m² and WC ≦35″ (88 cm), then extremely high disease risk.

16. If female and BMI ≧40 kg/m² and WC >35″ (88 cm), then extremely high disease risk.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A system for improved nutrient intake, the system comprising:
a. a computer server having a database containing data defining a nutrient reference information;
b. a user computing device remote from the computer server, which computer server is coupled to the user computing device and programmed to:
i. receive from a network interface of the user computing device a signal indicating information of nutritional goals of a user;
ii. automatically identify user nutrients associated with the user nutritional goals;
iii. in response to identification of the user nutrients, automatically retrieve the stored data corresponding to the user nutrients;
iv. using the data retrieved, automatically generate and transmit to the network interface on the user computing device a screen that displays individual food items that correlate with user nutrients, and selection fields corresponding to the individual food items, wherein the selection fields allow the user to select the individual food items to develop a meal plan;
v. receiving from the network interface of the user computing device a signal indicating selected individual food items;
vi. automatically identify a user selected meal plan with the selected individual food items; and
vii. in response to identification of the user selected meal plan, automatically generate and transmit to the network interface on the user computing device a screen that displays the user selected meal plan.

2. The system of claim 1, wherein the computer server is programmed to automatically identify the user selected meal plan with the selected individual food items further comprises automatically identify a user selected daily meal plan with the selected individual food items.

3. The system of claim 1, wherein the computer server is programmed to automatically identify the user selected meal plan with the selected individual food items further comprises automatically identify a user selected weekly meal plan with the selected individual food items.

4. The system of claim 1, wherein the nutrient reference information comprises a USDA Nutritional Database.

5. The system of claim 1, wherein the user nutrients comprises a discrete nutrient profile that contains a predefined amount of each macronutrient identified by the computer server, wherein the macronutrients include a protein component, a fat component, a carbohydrate component, and calories.

6. The system of claim 5, wherein the computer server is programmed to automatically determine if the predefined amount of each macronutrient is met in response to receiving from the network interface of the user computing device the signal indicating selected individual food items.

7. The system of claim 6, wherein the computer server is programmed to automatically generate and transmit for display on the network interface of the user computing device a screen recommending individual food items to ensure the predefined amount of each macronutrient is met in response.

8. A system for improved nutrient intake, the system comprising:
a. a computer server having a database containing data defining a nutrient reference information;
b. a user computing device remote from the computer server, which computer server is coupled to the user computing device and programmed to:
i. receive from a network interface of the user computing device a signal indicating information of nutritional goals of a user;
ii. automatically identify user nutrients associated with the user nutritional goals;
iii. in response to identification of the user nutrients, automatically retrieve the stored data corresponding to the user nutrients;
iv. using the data retrieved, automatically generate and transmit to the network interface on the user computing device a screen that displays a plurality of complete meals that correlate with user nutrients, and selection fields corresponding to entrees of select foods coordinated for breakfast, lunch, dinner and snacks, wherein the selection fields allow the user to select the individual entrees to develop a meal plan;
v. receiving from the network interface of the user computing device a signal indicating selected entrees;
vi. automatically identifying a user selected meal plan with the selected entrees; and
vii. in response to identification of the user selected meal plan, automatically generate and transmit to the network interface on the user computing device a screen that displays the user selected meal plan.

9. The system of claim 8, wherein the computer server is programmed to automatically identify the user selected meal plan with the selected individual food items further comprises automatically identify a user selected daily meal plan with the selected entrees.

10. The system of claim 8, wherein the computer server is programmed to automatically identify the user selected meal plan with the selected individual food items further comprises automatically identify a user selected weekly meal plan with the selected entrees.

11. The system of claim 8, wherein the nutrient reference information comprises a USDA Nutritional Database.

12. The system of claim 8, wherein the user nutrients comprises a discrete nutrient profile that contains a predefined amount of each macronutrient identified by the computer server, wherein the macronutrients include a protein component, a fat component, a carbohydrate component, and calories.

13. The system of claim 12, wherein the computer server is programmed to automatically determine if the predefined amount of each macronutrient is met in response to receiving from the network interface of the user computing device the signal indicating selected entrees.

14. The system of claim 6, wherein the computer server is programmed to automatically generate and transmit for display on the network interface of the user computing device a screen recommending individual food items to ensure the predefined amount of each macronutrient is met in response.

15. A system for improved nutrient intake, the system comprising:
a. a computer server having a database containing data defining a nutrient reference information;
b. a user computing device remote from the computer server, which computer server is coupled to the user computing device and programmed to:
i. receive from a network interface of the user computing device a signal indicating information of nutritional goals of a user;
ii. automatically identify user nutrients associated with the user nutritional goals;
iii. in response to identification of the user nutrients, automatically retrieve the stored data corresponding to the user nutrients;
iv. using the data retrieved, automatically generate and transmit to the network interface on the user computing device a screen that displays individual food items that correlate with user nutrients, and selection fields corresponding to the individual food items, wherein the selection fields allow the user to select the individual food items to develop a meal plan;
v. receiving from the network interface of the user computing device a signal indicating selected individual food items;
vi. automatically identifying a user discrete macronutrients and micronutrients and automatically identifying exchangeable individual foods that correlate with the selected individual food items; and
vii. in response to identification of the user discrete macronutrients and micronutrients and the exchangeable individual foods, automatically generate and transmit to the network interface on the user computing device a screen that displays the exchangeable individual foods.

16. The system of claim 15, wherein the nutrient reference information comprises a USDA Nutritional Database.

17. The system of claim 15, wherein the user nutrients comprises a discrete nutrient profile that contains a predefined amount of each macronutrient identified by the computer server, wherein the macronutrients include a protein component, a fat component, a carbohydrate component, and calories.

18. The system of claim 17, wherein the computer server is programmed to automatically determine if the predefined amount of each macronutrient is met in response to receiving from the network interface of the user computing device the signal indicating selected individual food items.

19. The system of claim 18, wherein the computer server is programmed to automatically generate and transmit for display on the network interface of the user computing device a screen recommending individual food items to ensure the predefined amount of each macronutrient is met in response.

20. The system of claim 19, wherein the recommended individual food items include exchangeable individual foods.
